(19) United States
(12) Patent Application Publication
(10) Pub. No.: US 2007/0107176 A1
(43) Pub. Date: May 17, 2007

(54) APPARATUS FOR FABRICATING VENETIAN BLINDS WITH TUBULAR FABRIC SLATS

(75) Inventors: Wendell B. Colson, Weston, MA (US); Daniel M. Fogarty, Framingham, MA (US); David M. Hartman, Framingham, MA (US); Todd B. Jaramillo, Broomfield, CO (US); Christopher G. White, Thornton, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 11/550,584

(22) Filed: Oct. 18, 2006

Related U.S. Application Data
(60) Provisional application No. 60/728,606, filed on Oct. 20, 2005.

(51) Int. Cl. B23P 19/04

(52) U.S. Cl. 29/24.5

(57) ABSTRACT

An apparatus for forming a panel of interconnected tubular vanes and cord ladders for use in a Venetian blind includes a vane-forming system where a strip of vane material is supplied, folded, and pressed into a desired configuration prior to being cut to a predetermined length. The length is determined by the width of the panel to be formed and is effected by a vane-sizing system including a template for positioning a plurality of cord ladder assemblies at predetermined locations for connection to tubular slats formed upstream from the assemblies. The tubular vane material has inert adhesive along a flap on one edge which is heated to activate the adhesive and after having been folded along a generally longitudinal centerline, the flap is folded over the corresponding upper edge of the vane and secured thereto in a sliding compressor. Within a panel-assembly system, a desired number of cord ladders are processed by spreading the cord ladders to permit the insertion of previously formed tubular vanes which are connected to the rungs of the cord ladders by pairs of adhesive application devices which place a spot of adhesive on a rung in overlying relationship with the tubular vane to secure the rung to the vane. The spots of adhesive are dried with gas dryers as the vanes are sequentially lifted after having been inserted into the cord ladders and secured thereto.

### CROSS-REFERENCE TO RELATED APPLICATION

The present application claims the benefit under 35 U.S.C. §119(e) to U.S. Provisional Patent Application No. 60/728,606 (“the '606 application”), which was filed on Oct. 20, 2005 and entitled “Apparatus For Fabricating Venetian Blinds With Tubular Fabric Slats.” The '606 application is incorporated by reference into the present application in its entirety.

### BACKGROUND OF THE INVENTION

1. Field of the Invention

The present invention relates generally to Venetian blind type coverings for architectural openings such as windows, doors, archways, and the like, and more particularly to an apparatus for fabricating a panel for use in a Venetian blind utilizing tubular fabric slats.

2. Description of the Relevant Art

Coverings for architectural openings such as windows, doors, archways, and the like, have taken numerous forms for many years. Illustrative of such coverings are draperies, curtains, retractable shades including continuous roll-up shades or cellular shades, and retractable blinds such as Venetian blinds and vertical blinds. Of these coverings, Venetian blinds are a very popular product and are typically made with a plurality of horizontally extending slats that may be aluminum or wood which are supported on tape or cord ladders for movement between extended and retracted positions relative to the architectural opening. In the retracted position, the slats are accumulated in a stack adjacent the top edge of the opening and in an extended position are evenly distributed vertically across the opening. Lift cords extend through the slats and are connected to a bottom rail at their lower end and a retracting mechanism in a headrail at their upper end so that by shortening the effective length of the lift cords, the slats are progressively accumulated until fully retracted in a neat stack at the top of the opening. The tape or cord ladders have front and rear vertical runners that are interconnected at spaced locations along their length by horizontal rungs which support the slats at horizontally spaced locations along the length of the horizontally extending slats. By shifting the front and rear vertical rungs in opposite vertical directions, the rungs are caused to tilt from their neutral horizontal orientation thereby tilting the slats supported thereon so as to move the slats between open and closed positions. In the open position, the slats are horizontally deployed with spaces therebetween through which light and vision can pass while in the closed position, the slats are substantially vertically oriented and overlap slightly to block vision and light through the covering.

Such Venetian blinds are made in numerous ways but typically with separate machines with one machine forming the slats either of a flat wood product or from aluminum, in which case the slats are provided with an arcuate transverse cross section, and the other machine inserting the slats into a plurality of tape or cord ladders by positioning each slat between the front and rear vertical runners and on top of a rung. The tape or cord ladders with the slats incorporated therein are subsequently incorporated into the operating mechanism in the headrail for the blind for opening and closing the blind in a conventional manner. Integrated apparatus for making an aluminum slatted Venetian blind are also known in the art such as for example shown in U.S. Pat. No. 5,349,730.

As will be appreciated from the above, prior art Venetian blind products have limited aesthetic appeal in that the primary component consists of wooden or metal slats and, accordingly, slats of a more attractive nature would likely enhance the aesthetics of the product. Further, it would be desirable to have an automated system for making Venetian blind type products of varying widths and with enhanced aesthetics in an in-line uninterrupted apparatus.

### SUMMARY OF THE INVENTION

The present invention is an apparatus and method for fabricating panels for Venetian blind products or subassemblies and more specifically the retractable panel component of a Venetian blind. The apparatus provides for a continuous in-line process with the final panel including a plurality of tubular fabric vanes operatively positioned within and secured to cord ladders. The apparatus includes a vane-forming system, a vane-sizing system, and a panel fabrication system. In the apparatus, a strip of fabric material is progressively folded into a tubular product so that one longitudinal edge of the strip can be secured to the opposite longitudinal edge to enclose the tubular product, the product is cut to a length determined by the desired width of the covering through the use of templates of various lengths and finally the cut tubular vanes are inserted longitudinally and horizontally into vertically suspended cord ladders immediately beneath associated rungs of the cord ladders. The slats are subsequently secured to the rungs. The covering is assembled in a rising fashion by lifting the cord ladders in stepped unison as additional slats are incorporated into the cord ladders.

Other aspects, features, and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric of the apparatus of the present invention.

FIG. 2A is a fragmentary isometric showing the panel assembly system of the apparatus of FIG. 1.

FIG. 2B is a fragmentary isometric showing the vane-sizing system and part of the vane-forming system of the apparatus of FIG. 1.

FIG. 2C is a fragmentary isometric showing a portion of the vane-forming system of the apparatus of FIG. 1.

FIG. 3A is a fragmentary isometric similar to FIG. 2A showing completed vanes incorporated into cord ladders in the apparatus.

FIG. 3B is a fragmentary isometric similar to FIG. 2B showing transfer belts transferring the vane through the apparatus.

FIG. 3C is a fragmentary isometric similar to FIG. 2C with vane-strip material incorporated into the apparatus.

FIG. 4A is a diagrammatic plan view of the apparatus of FIG. 1.

FIG. 4B is a diagrammatic plan view similar to FIG. 4A with belts incorporated into the apparatus.

FIG. 4C is a diagrammatic plan view similar to FIG. 4B with the vane material incorporated into the apparatus.

FIG. 4D is a diagrammatic plan view similar to FIG. 4C with the apparatus utilizing five cord ladder systems instead of three.

FIG. 4E is a diagrammatic plan view similar to FIG. 4D with the apparatus utilizing four cord ladder systems instead of five.

FIG. 4F is a diagrammatic plan view similar to FIG. 4E with the apparatus utilizing two cord assemblies instead of four.

FIG. 4G is a diagrammatic plan view similar to FIG. 4F with the two utilized cord systems being positioned more closely together.

FIG. 4H is a diagrammatic top plan view of the apparatus.

FIG. 4J is a diagrammatic side elevation of the apparatus as shown in FIG. 4H.

FIG. 5 is a fragmentary isometric illustrating a portion of the vane-forming system.

FIG. 6 is an enlarged section taken along line 6-6 of FIG. 5.

FIG. 7 is an enlarged fragmentary section taken along line 7-7 of FIG. 3C.

FIG. 8 is a section similar to FIG. 7 with the vane material having been removed.

FIG. 9 is an enlarged vertical section taken along line 9-9 of FIG. 7.

FIG. 10 is an enlarged vertical section taken along line 10-10 of FIG. 7.

FIG. 11 is an enlarged vertical section taken along line 11-11 of FIG. 7.

FIG. 12 is an enlarged vertical section taken along line 12-12 of FIG. 7.

FIG. 13 is an enlarged fragmentary section taken along line 13-13 of FIG. 3C.

FIG. 14 is an enlarged fragmentary section taken along line 14-14 of FIG. 3C.

FIG. 15 is an enlarged fragmentary section taken along line 15-15 of FIG. 3C.

FIG. 16 is an enlarged fragmentary section taken along line 16-16 of FIG. 7.

FIG. 17 is an enlarged section taken along line 17-17 of FIG. 3C.

FIG. 18 is an enlarged fragmentary section taken along line 18-18 of FIG. 3B.

FIG. 19 is an enlarged fragmentary section taken along line 19-19 of FIG. 18.

FIG. 20 is an enlarged fragmentary section taken along line 20-20 of FIG. 3B.

FIG. 21 is a fragmentary isometric looking from the rear of the apparatus at the heating system of the vane-forming system.

FIG. 22 is a fragmentary isometric similar to FIG. 21 with the belts and vane material removed.

FIG. 23 is a fragmentary isometric taken generally along line 23-23 of FIG. 3B.

FIG. 24 is an isometric looking upwardly at the bottom of the upper component of the first vane compression block.

FIG. 25 is an isometric looking downwardly on the bottom portion of the first vane compression block.

FIG. 26 is an isometric of the vane material being completed in the compression block of FIGS. 24 and 25 with the lower component being shown in full line and the upper component in dashed lines.

FIG. 27 is an enlarged fragmentary section taken along line 27-27 of FIG. 26.

FIG. 28 is an enlarged fragmentary section taken along line 28-28 of FIG. 26.

FIG. 29 is an enlarged fragmentary section taken along line 29-29 of FIG. 26.

FIG. 30 is a fragmentary isometric of the end of the vane-forming system and the beginning of the panel assembly system showing driven and idler rollers associated with various belts used in the apparatus.

FIG. 31 is a fragmentary isometric of the same general area illustrated in FIG. 30 with components removed for clarity and viewed from the back side of the apparatus.

FIG. 32 is a fragmentary section similar to FIG. 31 with the strip of vane material included and showing portions of the vane-sizing system.

FIG. 33 is a fragmentary isometric similar to FIG. 32 with the drive belts included in the view.

FIG. 34 is an enlarged fragmentary section taken along line 34-34 of FIG. 33.

FIG. 35 is an isometric looking downwardly on a cord ladder assembly.

FIG. 36 is a fragmentary front elevation of the cord ladder assembly shown in FIG. 35.

FIG. 37 is a fragmentary rear elevation of the cord ladder assembly of FIG. 36.

FIG. 38 is an isometric of the various vane templates used in the apparatus of the invention for setting vane lengths.

FIG. 39 is a fragmentary elevation of the length-setting device used in the vane-sizing system of the invention with the device in a retracted position.

FIG. 40 is a fragmentary elevation similar to FIG. 39 with the device in a locking or extended position.

FIG. 41 is a fragmentary isometric of the downstream end of the apparatus showing the length-setting device in cooperation with a vane template and portions of the cable system used in the vane-sizing system.

FIG. 42 is a fragmentary isometric similar to FIG. 41 with the cables removed.

FIG. 43 is a vertical section through the cord ladder assembly of FIG. 35.

FIG. 43A is a vertical section similar to FIG. 43 with the vane material and cord ladder material removed.

FIG. 44 is an enlarged fragmentary section taken along line 44-44 of FIG. 43.

FIG. 45 is a fragmentary section similar to FIG. 44 with the locking bumper in a locking position.

FIG. 46 is a fragmentary section taken along line 46-46 of FIG. 44.

FIG. 47 is a fragmentary section taken along line 47-47 of FIG. 45.

FIG. 48 is an enlarged horizontal section similar to FIG. 47 showing a vane in end engagement with the bumper.

FIG. 49 is a horizontal section similar to FIG. 48 with a vane having been rebounded by the bumper.

FIG. 50 is a fragmentary isometric showing the bumper in the position of FIG. 49.

FIG. 51 is a fragmentary isometric similar to FIG. 50 with a vane shown in dashed lines initially engaging the bumper.

FIG. 52 is a fragmentary vertical section similar to FIG. 43 with the bumper in a retracted position so that the cord ladder assembly illustrated is an intermediate assembly and not the terminal assembly shown in FIG. 43.

FIG. 53 is a fragmentary section taken along line 53-53 of FIG. 52.

FIG. 54 is a fragmentary section taken along line 54-54 of FIG. 52.

FIG. 55 is a horizontal section taken along line 55-55 of FIG. 57 showing the cord ladder spreader.

FIG. 56 is a section taken along line 56-56 of FIG. 57.

FIG. 57 is a fragmentary isometric showing a portion of the lift tower of the cord ladder assembly of FIG. 35.

FIG. 58 is an isometric of a lift belt used in the lift tower of FIG. 57.

FIG. 59 is an enlarged fragmentary isometric of a portion of the lift belt shown in FIG. 58.

FIG. 60 is an isometric of a cord ladder vertical riser guide.

FIG. 61 is an isometric of a vane detector for detecting the receipt of a vane in the panel assembly system.

FIG. 62 is an isometric of a belt spreader used in the panel assembly system.

FIG. 63 is a fragmentary isometric showing a cord ladder extending through the lift tower.

FIG. 64 is an enlarged fragmentary isometric at a location immediately above that shown in FIG. 63.

FIG. 65 is a fragmentary isometric at a location immediately above that shown in FIG. 64.

FIGS. 65A-65F are diagrammatic views illustrating the insertion of tubular slats into cord ladders and the repositioning of the cord ladders to engage the slat with a corresponding rung.

FIG. 66 is an isometric of the adhesive application device used to secure the slats to rungs of cord ladders.

FIG. 67 is an enlarged top plan view of the device shown in FIG. 66.

FIG. 68 is an enlarged bottom plan view of the device shown in FIG. 66.

FIG. 69A is a fragmentary vertical section taken along line 69A-69A of FIG. 67.

FIG. 69B is a fragmentary isometric of the device as shown in FIG. 69A.

FIG. 70A is a fragmentary section similar to FIG. 69A with the adhesive application device in an advanced position in alignment with vanes in the vane assembly system.

FIG. 70B is an isometric of the adhesive application device as shown in FIG. 70A.

FIG. 71A is a fragmentary vertical section similar to FIG. 70A with the application device components in an active position.

FIG. 71B is a fragmentary isometric of the adhesive application device in the position of FIG. 71A.

FIG. 72 is an enlarged fragmentary vertical section taken along line 72-72 of FIG. 71A.

FIG. 73 is an enlarged fragmentary vertical section taken along line 73-73 of FIG. 71A.

FIG. 73A is a section similar to FIG. 73 with the gas-controlling plunger in an extended closing position.

FIG. 74 is an enlarged fragmentary vertical section taken along line 74-74 of FIG. 71A.

FIG. 75 is a fragmentary isometric similar to FIG. 70B from the opposite side of the apparatus.

### DESCRIPTION OF THE PREFERRED EMBODIMENT

The apparatus 80 of the present invention for fabricating panels of material used as subassemblies in Venetian blinds is an automatic in-line system. The apparatus is designed to fabricate a panel comprised of a plurality of conventional cord ladders interconnected with tubular fabric vanes. The panel can then be incorporated into a Venetian blind by securing the panel along its lower edge to a conventional bottom rail (not shown) and along its top edge to a conventional headrail (not shown) that incorporates an operating system for extending and retracting the panel across an architectural opening and for pivoting the tubular slats or vanes about their longitudinal axes which extend horizontally across the architectural opening. For purposes of the present disclosure, the bottom rail, the headrail, and the operating system will not be described as the present invention is directed solely to the fabrication of the panel or subassembly described above that forms part of a completed Venetian blind.

It is also to be understood that the description of the apparatus that follows will reference various motors and a control system but the specifics will not be described. The control system for operating the apparatus is felt to be within the skill of one in the art and is preferably a pneumatic system controlled by a computer which controls the various motors and other pneumatic components utilized in the apparatus in accordance with the operation described in detail hereafter.

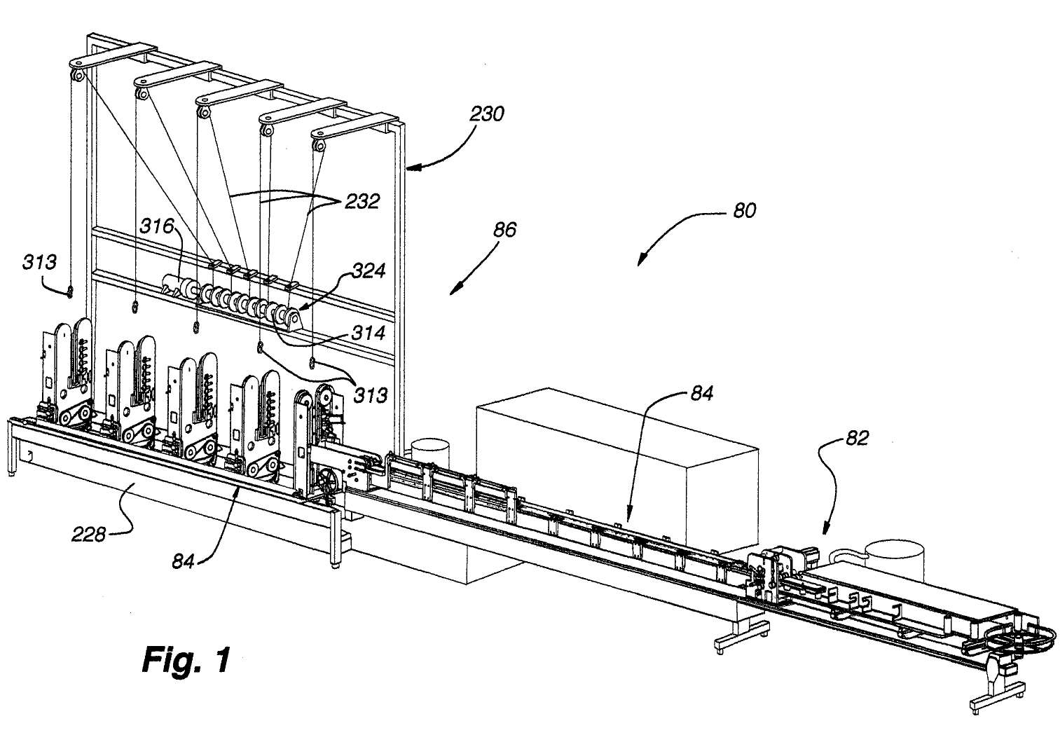

With reference to FIG. 1, the apparatus 80 of the invention includes a vane-forming system 82 at the upstream end of the apparatus shown to the right in FIG. 1, a vane-sizing system 84, and a panel-assembly system 86 at the downstream end of the apparatus shown on the left in FIG. 1. The vane-sizing system extends between and overlaps the panel-assembly system and the vane-forming system as will be explained in more detail later.

The illustration of the apparatus 80 in FIG. 1 does not include the cord ladder materials used in the panel fabricated with the apparatus nor does it include the fabric strip material from which the vanes for the panel are formed. These materials will be shown and described hereafter.

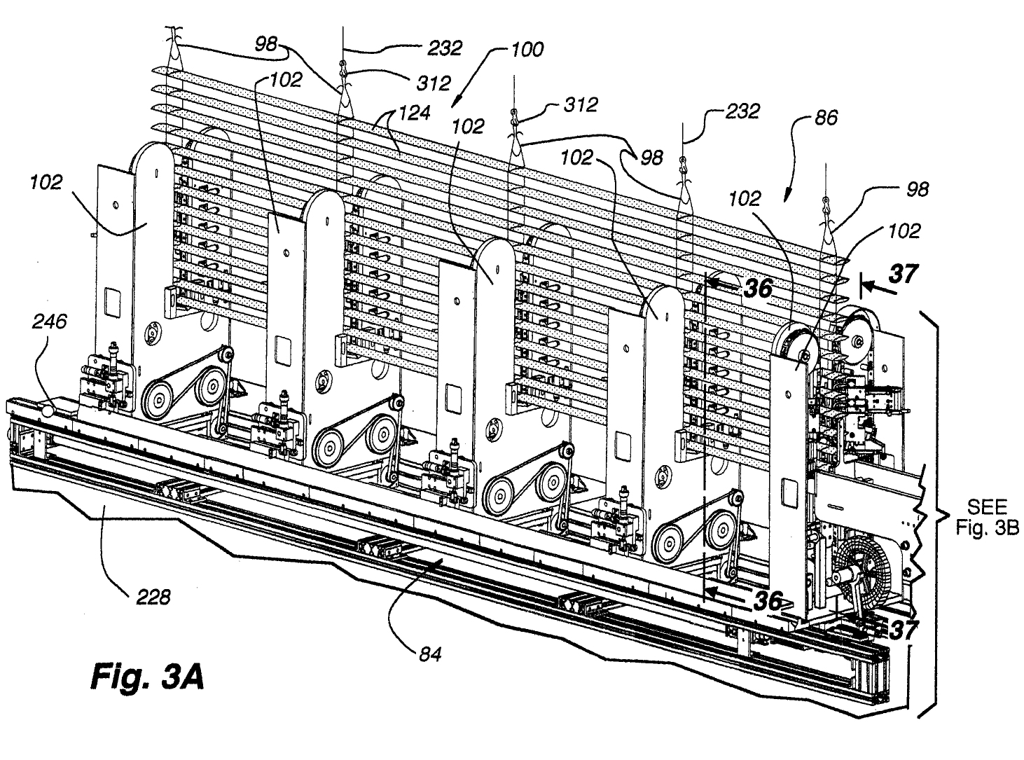

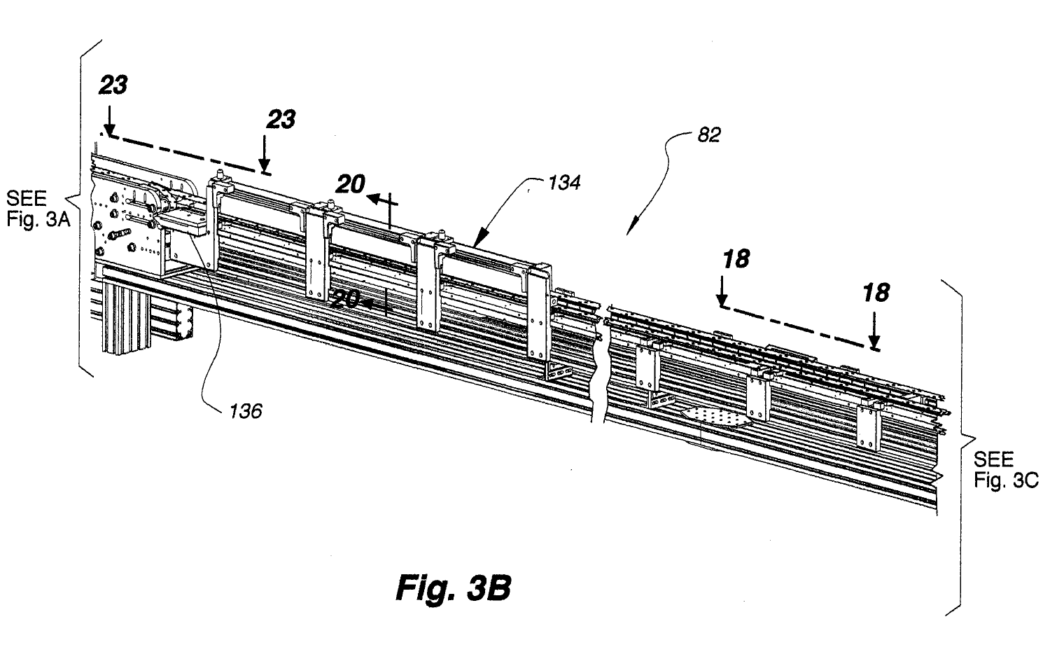

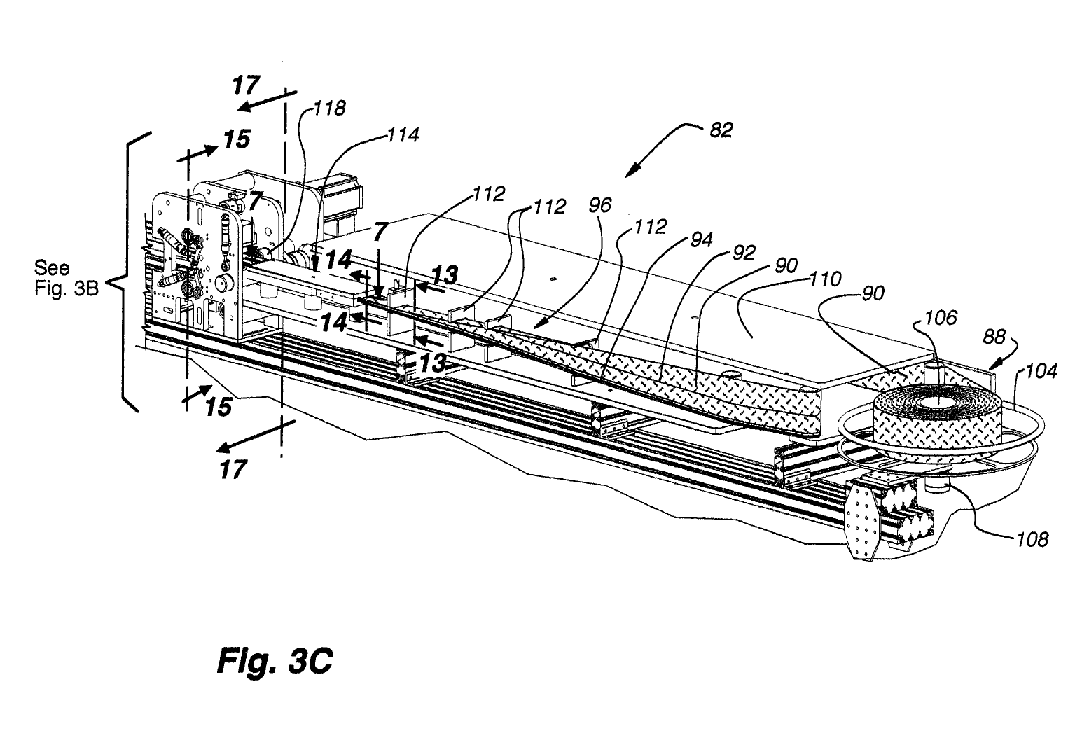

In the vane-forming system 82 (FIG. 3C), a supply roll 88 of fabric strip material 90 is provided that might be resin impregnated fiberglass having a crease 92 approximately along its longitudinal centerline and an elongated bead of inert (non-sticky) adhesive 94 along one edge and on one face of the strip material. The strip material is fed through a forming station 96 where it is folded along the longitudinal crease 92, the inert adhesive 94 along the edge of the strip is heated for activation (making it tacky) and that edge of the strip material is folded over and secured to the adjacent opposite edge to form a relatively flat tubular vane. During the forming process, a cutter cuts the strip material into predetermined lengths corresponding to the predetermined width of the panel to be formed in the apparatus. Each cut strip, which is ultimately completed into a tubular vane, is advanced into a predetermined number of cord ladders 98 (FIG. 3A) positioned for receipt of the vanes in the panel-forming system and sequentially secured to the cord ladders until a predetermined number of vanes have been secured thereto dependent upon the height of the panel 100 (FIG. 3A) to be formed. The apparatus includes a plurality of cord ladder assemblies 102 (FIG. 1) associated with individual rolls (FIG. 3A) of cord ladder material and two or more of the cord ladder assemblies are utilized in the fabrication of a panel depending upon the width of the panel being formed. In other words, the longer the panel 100 being formed, the more cord ladders 98 desired for the panel and the more cord ladder assemblies 102 put into operation. It will also be appreciated from the description that follows that the entire apparatus is mounted on a suitable frame that will not be described in detail other than the pertinent parts thereof necessary for an understanding of the mechanics and operation of the apparatus.

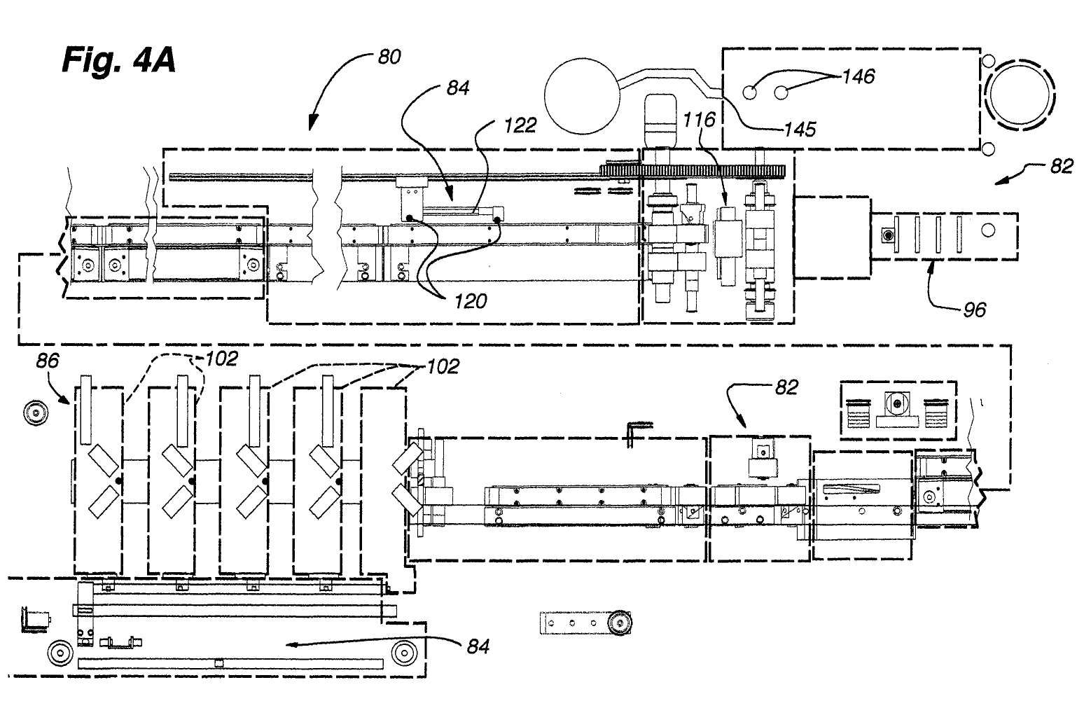

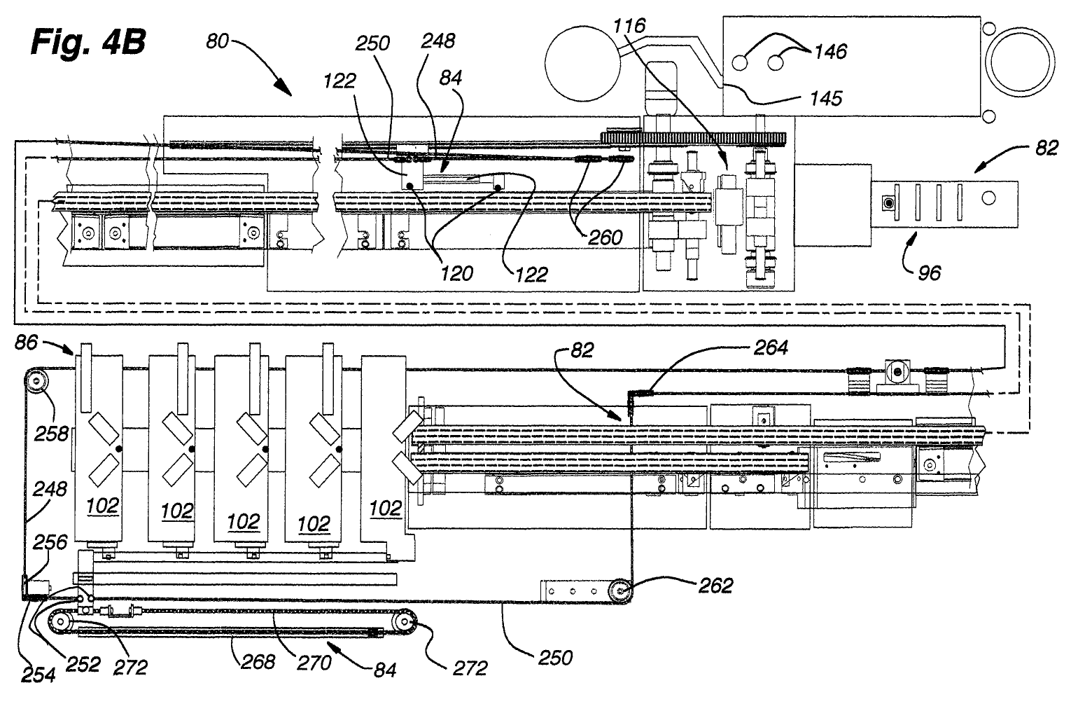

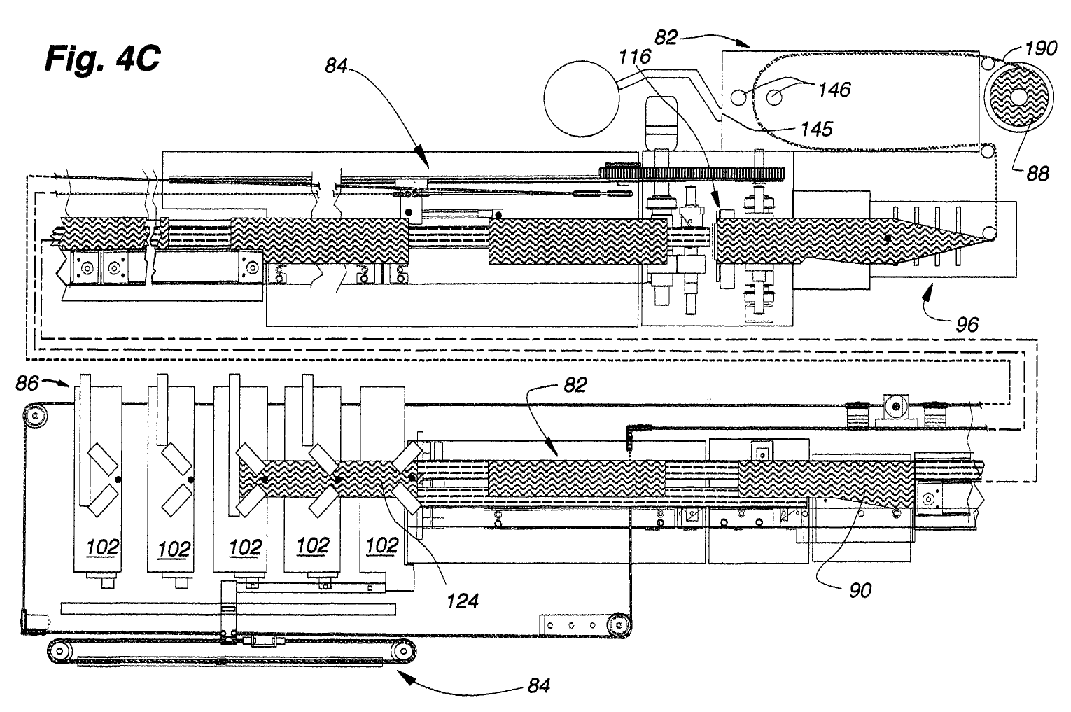

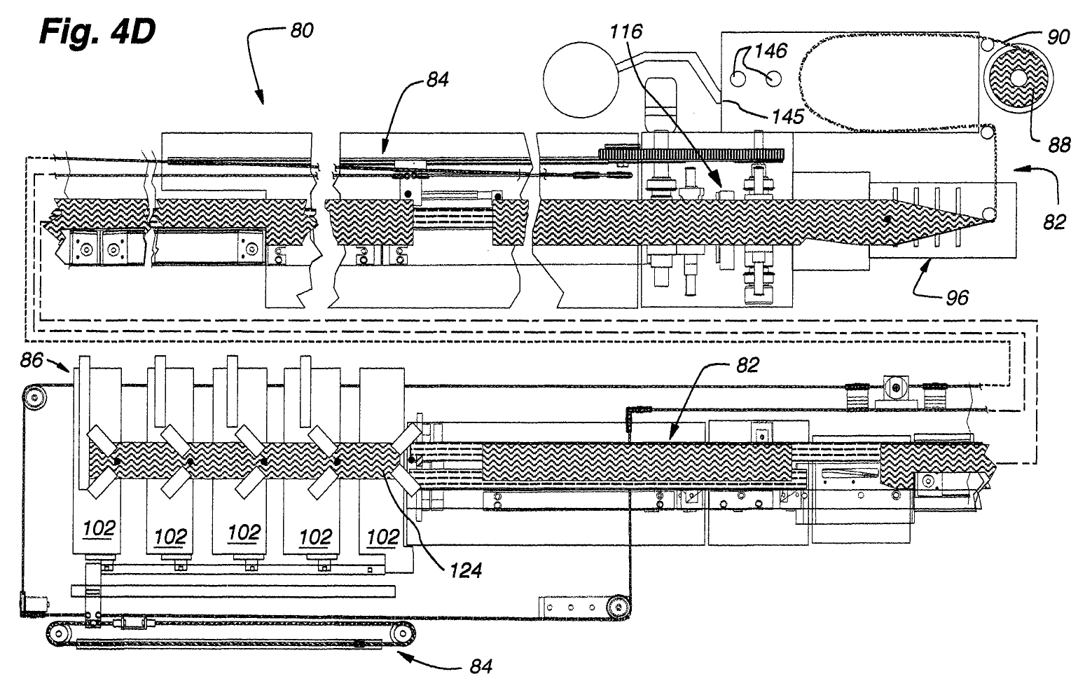

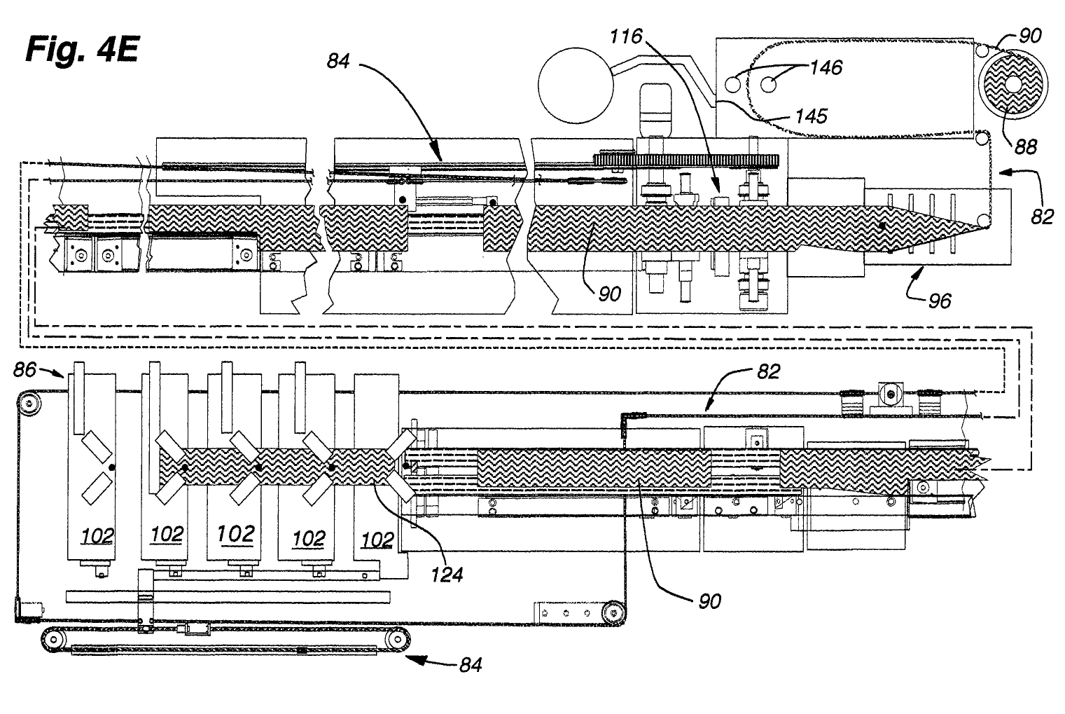

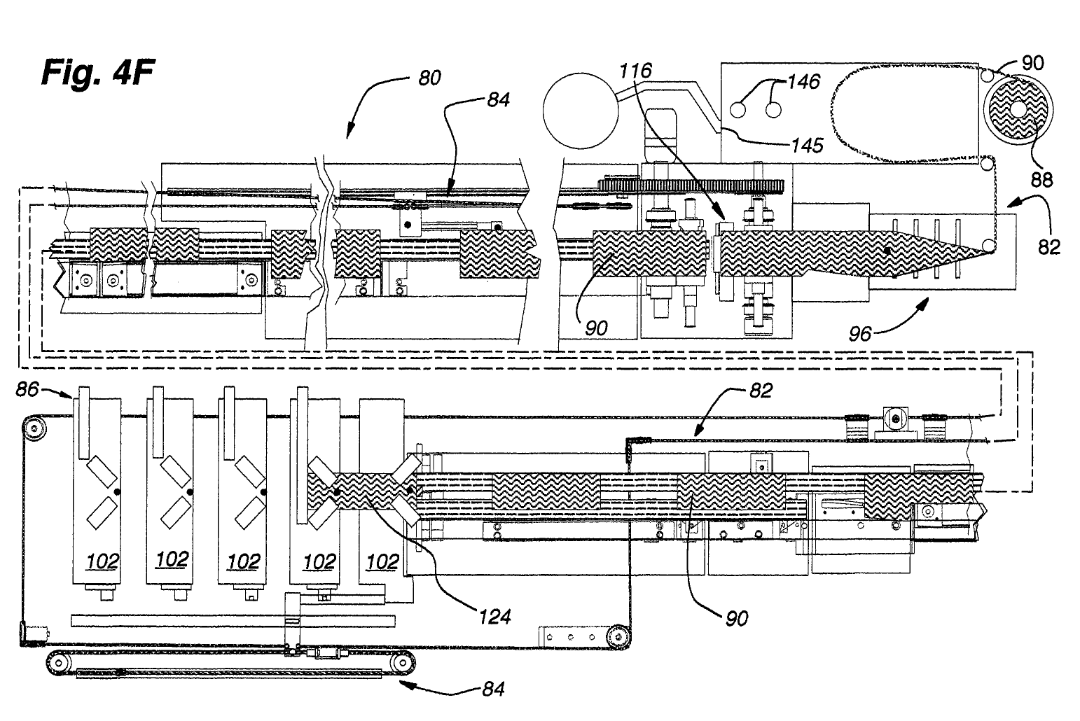

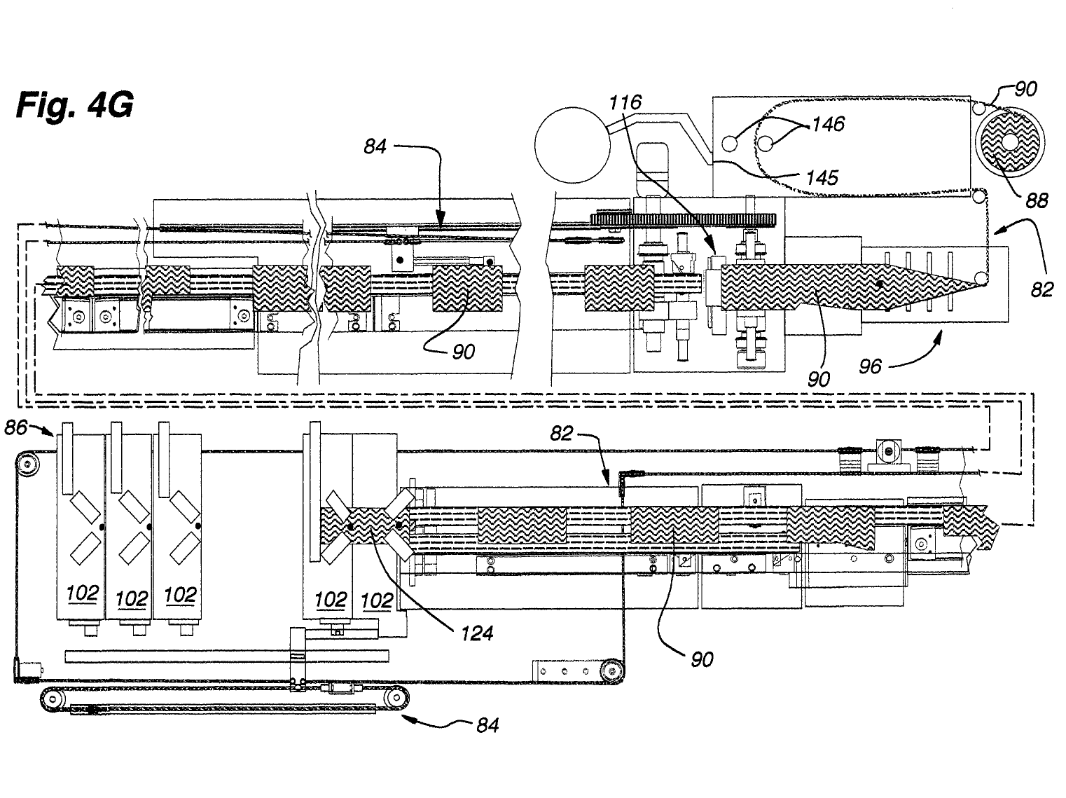

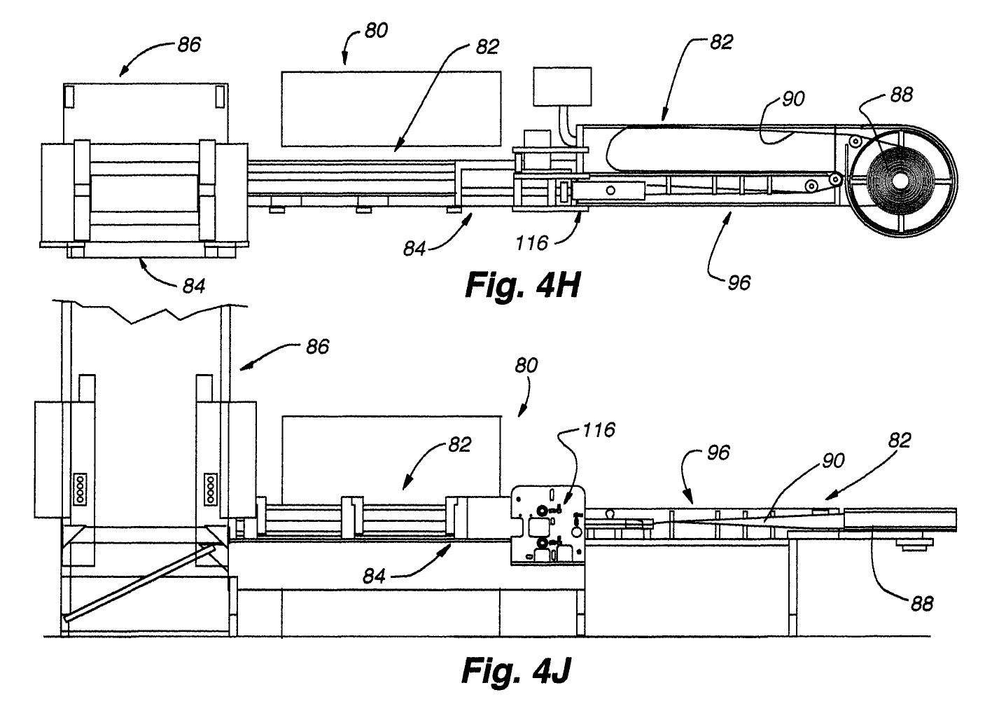

FIGS. 4A-4J are diagrammatic top plan views of the apparatus 80 which are felt to be helpful in an understanding of the description of the apparatus that follows. FIG. 4A is such a diagrammatic plan view with the belts, cables and materials used in fabricating the panel having been removed. FIG. 4B is a view similar to FIG. 4A wherein belts, cables, and the like have been added but wherein none of the supply material used in fabricating the panel are included. FIG. 4C is a view similar to FIG. 4B with the vane strip material 90 having been added and wherein the apparatus is arranged for utilizing three cord ladder assemblies 102 in the assembly of a panel 100. FIG. 4D is a plan view similar to FIG. 4C wherein the apparatus is set up for fabricating a panel 100 with five cord ladders 98. FIG. 4E is a similar view to FIG. 4D but wherein the apparatus is set up for forming a panel with four cord ladders, and FIG. 4F is a similar view wherein the apparatus is set up for assembling a panel with only two cord ladders. FIG. 4G is a view similar to FIG. 4F but wherein the three cord ladder assemblies 102 not being utilized in the fabrication of a panel have been stacked in a non-operative position at the downstream end of the apparatus. FIG. 4H is a top plan view of the apparatus with the vane strip material 90 positioned for initially operating the apparatus, i.e. with the vane strip material having been fed through the upstream portion of the vane-forming system 82 up to the cutter. FIG. 4J is a side elevation of the apparatus as shown in FIG. 4H.

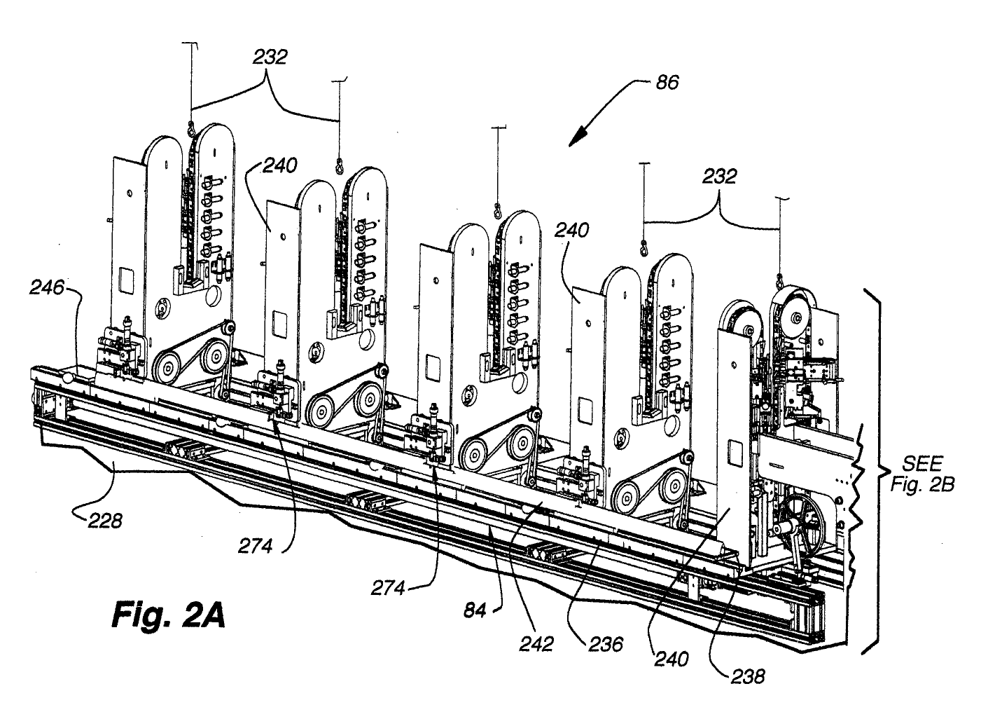

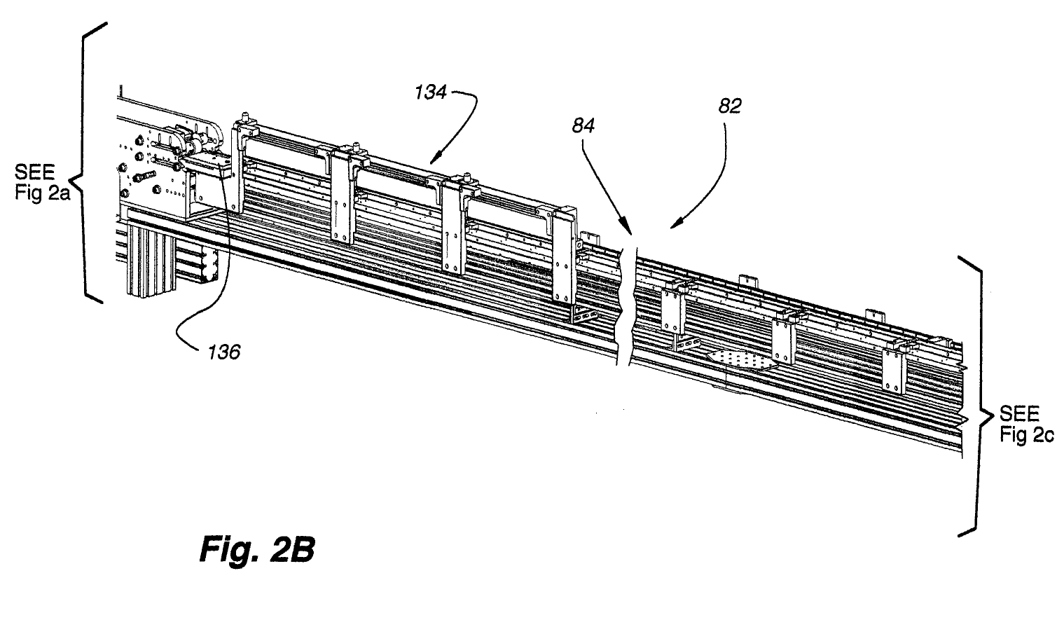

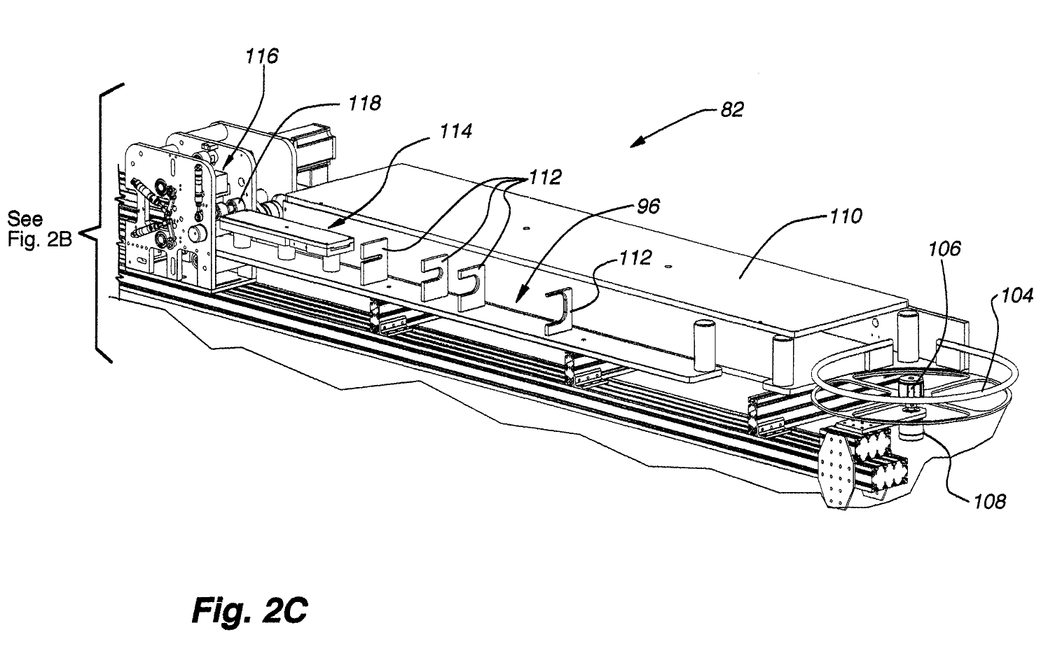

FIG. 2A is an isometric of the panel assembly system 86 with FIGS. 2B and 2C showing the vane-forming system 82 and portions of the vane-sizing system 84. FIGS. 3A, 3B, and 3C complement FIGS. 2A, 2B, and 2C by incorporating the component supply materials needed to fabricate a panel for a Venetian blind, namely the cord ladder material 98 and the vane strip material 90. Looking first at FIGS. 2C and 3C, the vane-forming system 82 at the extreme upstream end of the apparatus can be seen to include a fixed circular supply tray 104 having a freely rotatable spindle 106 at its center rotatable about a vertical axis and aligned with a brake 108 therebeneath, an accumulator box 110, a plurality of staged and stepped folding blocks 112, a first folding and aligning housing 114 and a cutter 116 for cutting a folded strip of vane material 90 into predetermined lengths.

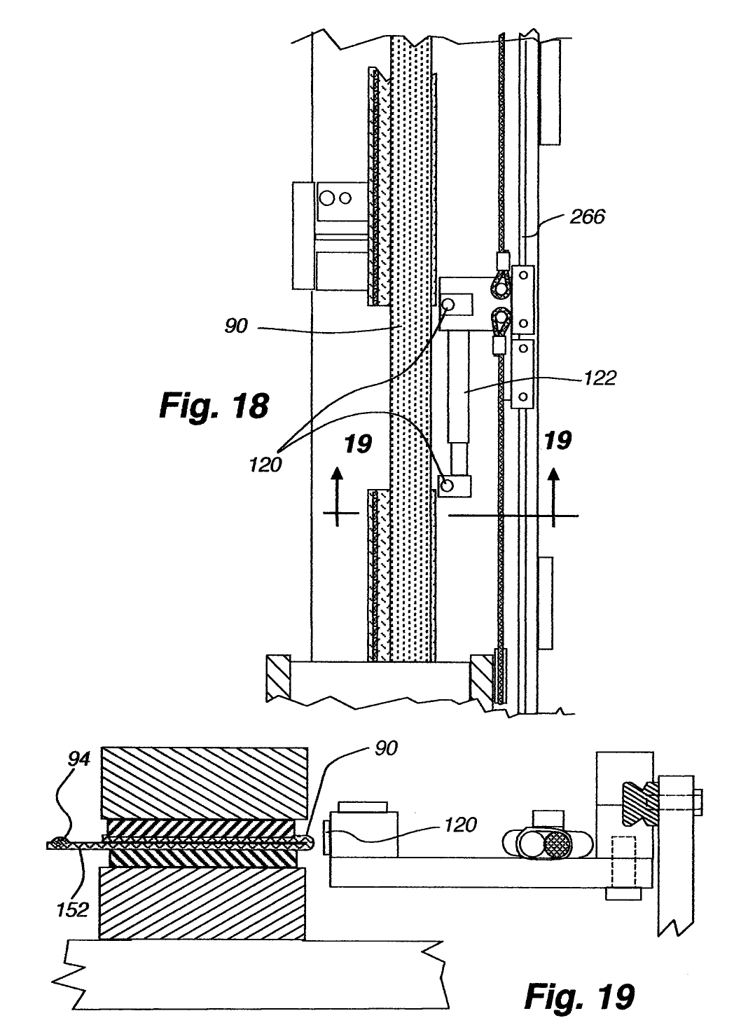

By reference to FIG. 3C, the supply roll 88 of vane strip material 90 is shown mounted on the spindle 106 with the strip material being a flexible flat material with the flat dimension extending vertically and having been fed through the accumulator 110 and subsequently the folding blocks 112 and the first folding and aligning housing 114 into the cutter 116. Between the first folding and aligning housing and the cutter are pairs of driven rollers 118 having a friction surface for gripping the strip material. The rollers 118 are intermittently activated to pull vane strip material from the accumulator, through the folding blocks, and the first folding and aligning housing and feed it downstream past the cutter to a first set of upper and lower drive belts 130 and 132 and to a pair of photoelectric sensors 120 possibly seen best in FIGS. 4B and 18. There are two photoelectric sensors mounted on a common block 122 so that one sensor is upstream from the other. The sensors are adapted to sense the leading or downstream cut edge of a strip of the vane material 90 and position that edge at a predetermined distance from the cutter with that distance correlating to the length of the vane 124 (FIG. 3A) desired for a panel 100 being fabricated with the apparatus. The photoelectric sensors are part of the vane-sizing system 84 to be described in more detail hereafter. The block 122 on which the sensors are mounted is movable between fixed predetermined positions spaced from the cutter a distance depending upon the width of the panel being fabricated.

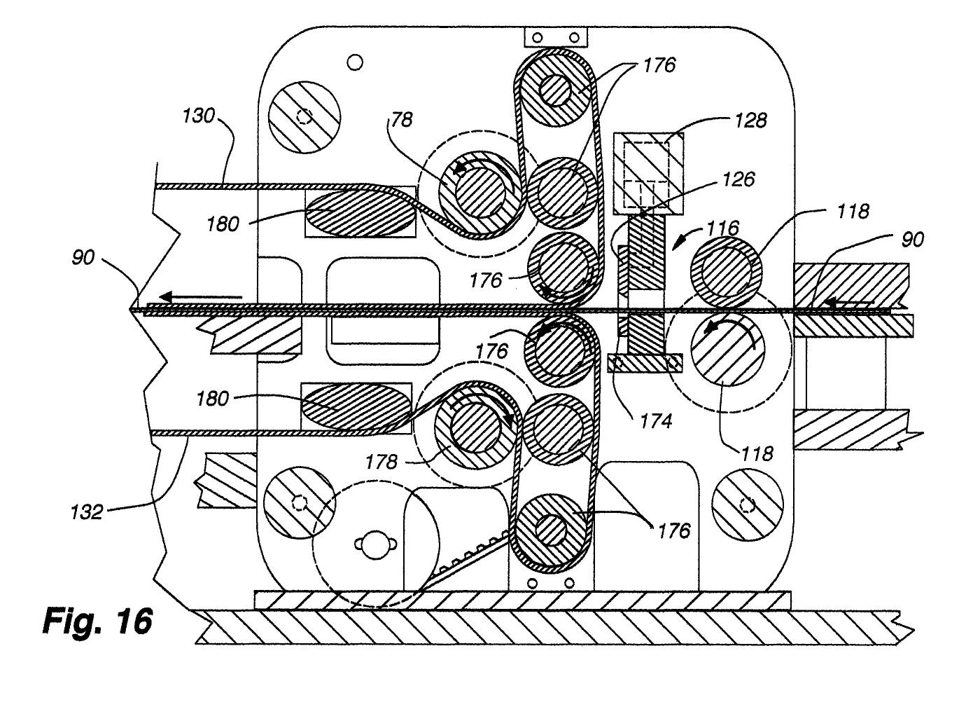

As will be explained in more detail hereafter, when the sensors 120 are desirably positioned for dictating a predetermined length of strip of material 90 to be cut into a vane, the pairs of driven rollers 118 are activated to advance the folded strip of vane material to the first set of drive belts 130 and 132 that in turn advance the vane material downstream at a high speed until the first edge of the vane is detected by the upstream sensor at which time the speed of the drive belts is decreased radically until the leading edge of the vane strip material is sensed by the downstream sensor at which time the rotation of the drive belts is stopped. The cutter 116 can then be activated to cut the vane strip material to the predetermined length corresponding to the spacing between the downstream most sensor and the cutter blade 126 (FIG. 16).

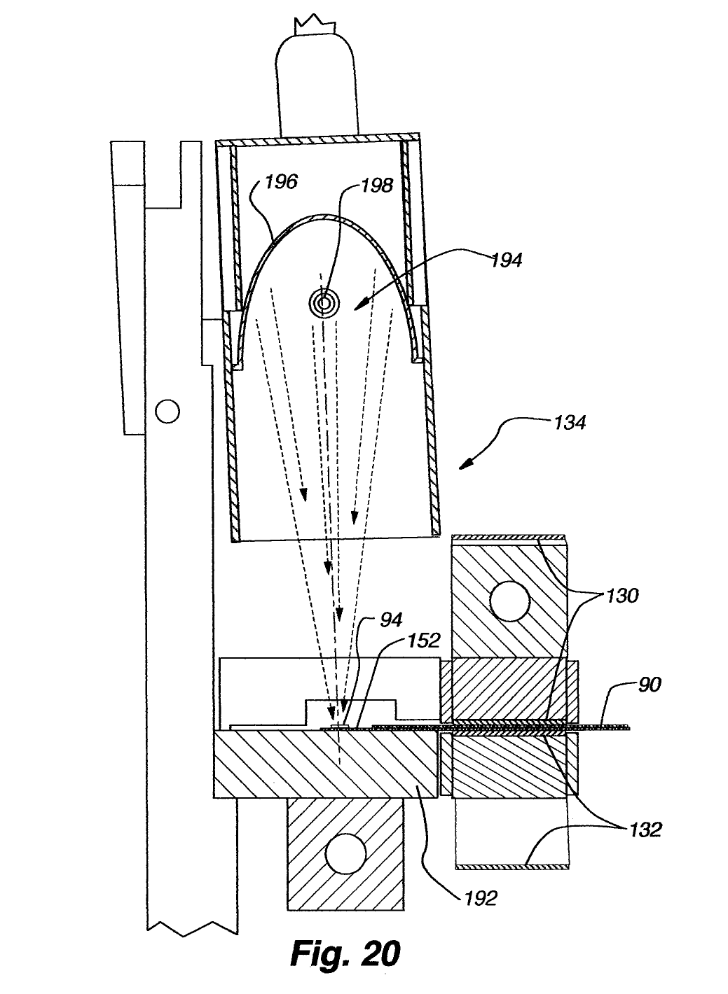

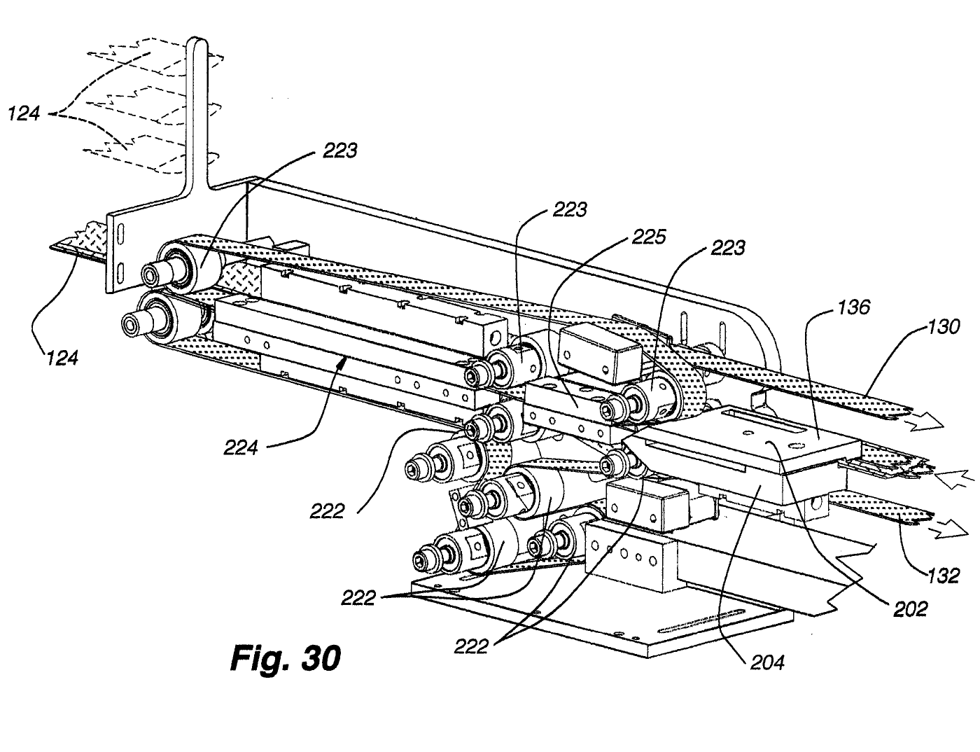

The cutter 116 is a conventional guillotine type cutter probably best seen in FIG. 16 having a pneumatic cylinder 128 for advancing the cutter blade 126 through the vane strip material 90 and retracting the knife blade in a very short period of time. After a folded strip of vane strip material has been cut to the predetermined length, it is advanced further downstream by the upper and lower conveyor drive belts 130 and 132 respectively (FIG. 16) between which it is confined through a heating and adhesive activation station 134 (FIG. 20), a second folding housing 136 (FIG. 30) and finally into the panel-assembly system 86 as will be described in more detail hereafter.

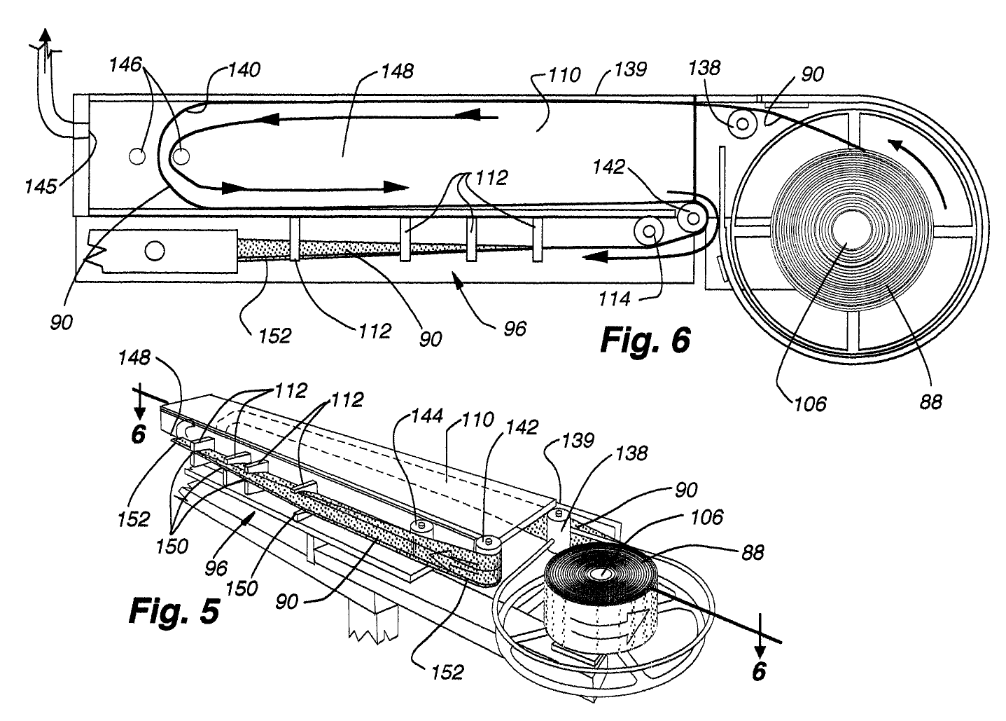

With reference to FIGS. 5 and 6, the upstream end of the apparatus is illustrated with a roll 88 of vane strip material 90 mounted on the spindle 106 and the leading edge of the material fed through the vane-forming system 82 up to the friction rollers 118. As will be appreciated, the roll of vane strip material is positioned on the spindle so that the strip material is vertically oriented and fed off the roll in a counterclockwise direction. The material passes around a first cylindrical guide block 138 which confines the material between a rear wall 139 of the accumulator 110 and the first cylindrical guide block 138. Material then passes through a large loop 140 within the accumulator and is subsequently brought back toward the supply roll where it passes around a second cylindrical guide block 142 where its direction is reversed so that it passes across a third cylindrical guide block 144 before being fed through the folding blocks 112. Within the accumulator, at the downstream end thereof is a vacuum port 145 in an end wall of the accumulator and a pair of vent ports 146 opening through the bottom wall 148 of the accumulator. The vacuum port is connected to a vacuum source (not shown. When vane material is pulled out of the accumulator by the friction rollers 118 and fed downstream, the accumulated strip material within the accumulator is drawn down so that the loop is smaller than illustrated in FIG. 6. Once the friction rollers are stopped, however, the vacuum source draws additional material off the supply roll. To prevent the strip material from being drawn over the vacuum port and held in that position by the vacuum, the vents are opened to reduce the vacuum in the downstream end of the accumulator. Depending on the porosity and permeability of the strip material, it is sometimes desirable to further reduce the vacuum so a third vent port is provided at the downstream end of the accumulator with a selectively operable gate to open or close the third vent port. The pull on the strip material by the friction rollers 118 overcomes the vacuum draw on the material until the rollers stop rotating.

As seen in FIGS. 5 and 6, as the strip material leaves the accumulator 110, it is fed in its vertical orientation to the folding blocks 112 where it passes sequentially through the folding blocks which have generally C-shaped notches 150 formed in a front edge thereof. The notches become decreasingly shallow from top to bottom from the upstream-most block to the downstream-most block so that the strip material leaving the downstream block is folded substantially in half along the longitudinal crease 92 but with a slight extension along the lower layer on its free edge that defines a flap 152 having the inert bead of adhesive 94 thereon which is subsequently folded over onto the top layer to secure the strip material into a tubular form as will be described later. The folded strip of material is also horizontally oriented upon leaving the folding blocks.

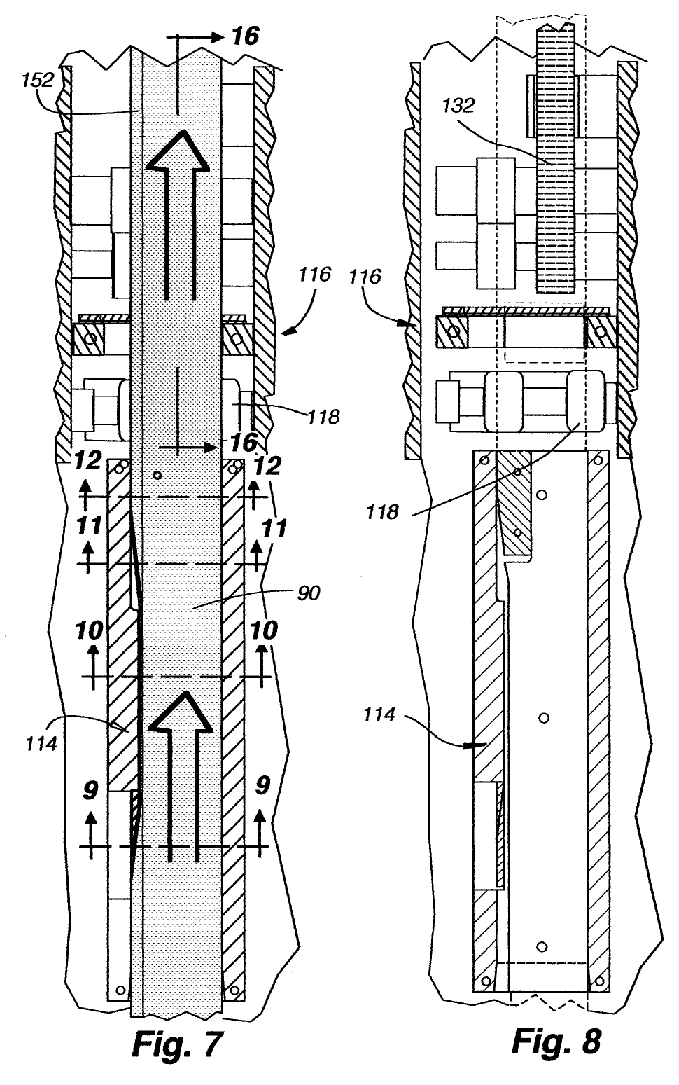

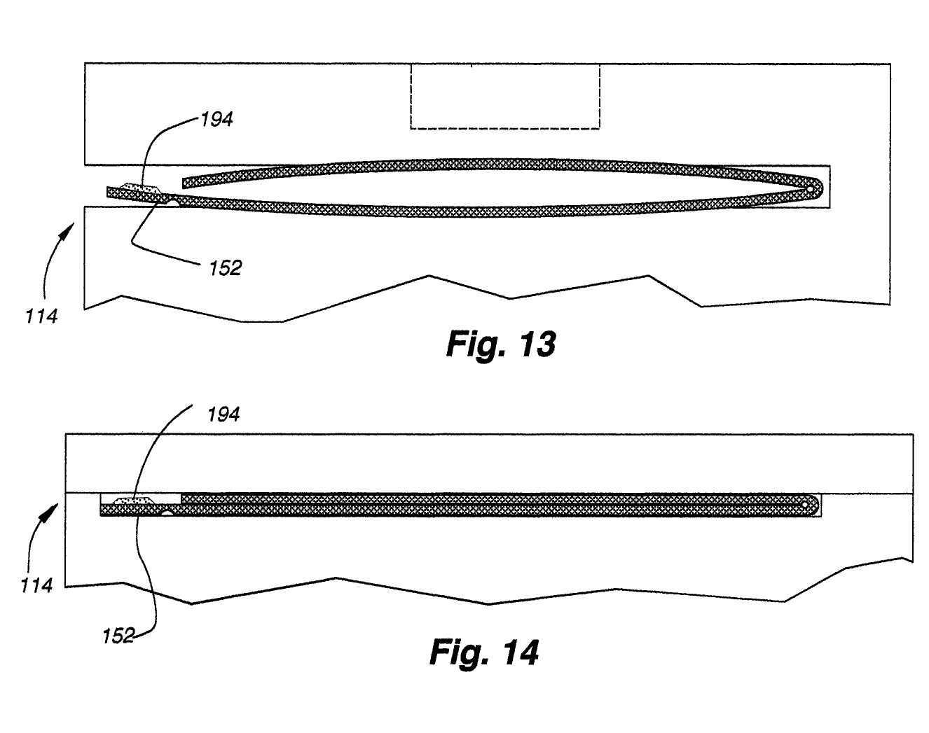

In FIG. 13, the vane strip material 90 is seen immediately before it enters the most downstream folding block 112 where it can be seen to be of generally flat tubular configuration folded along its longitudinal crease 92 and defining the flap 152 on the lower layer with the elongated inert adhesive bead 94 (FIGS. 13 and 14) thereon. FIG. 14 is a cross section immediately before the strip material enters the first folding and aligning housing 114 where it will be seen the top and bottom layers of the vane are compressed into a confronting face-to-face flat relationship again with the flap 152 protruding from one side edge in co-planar relationship with the lower layer of the folded material. With reference to FIG. 8, a horizontal section shows the apparatus through the first folding and aligning housing, the adjacent friction rollers 118, the cutter 116, and subsequently the conveyor belts 130 and 132 used to transfer the cut vane material downstream in the apparatus. FIG. 7 is a view similar to FIG. 8 with the vane strip material positioned in the apparatus.

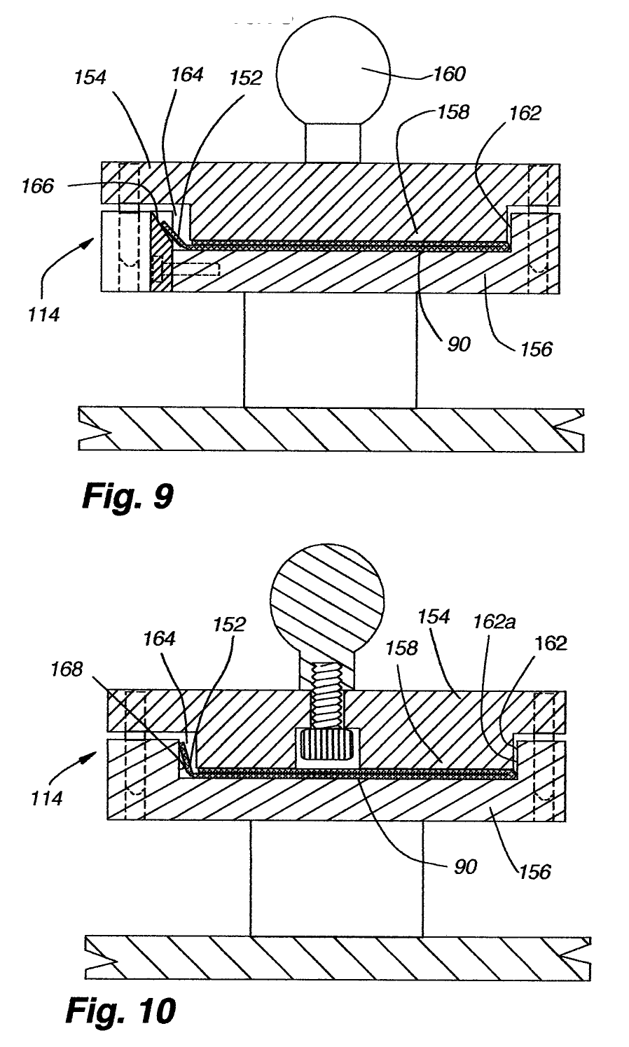

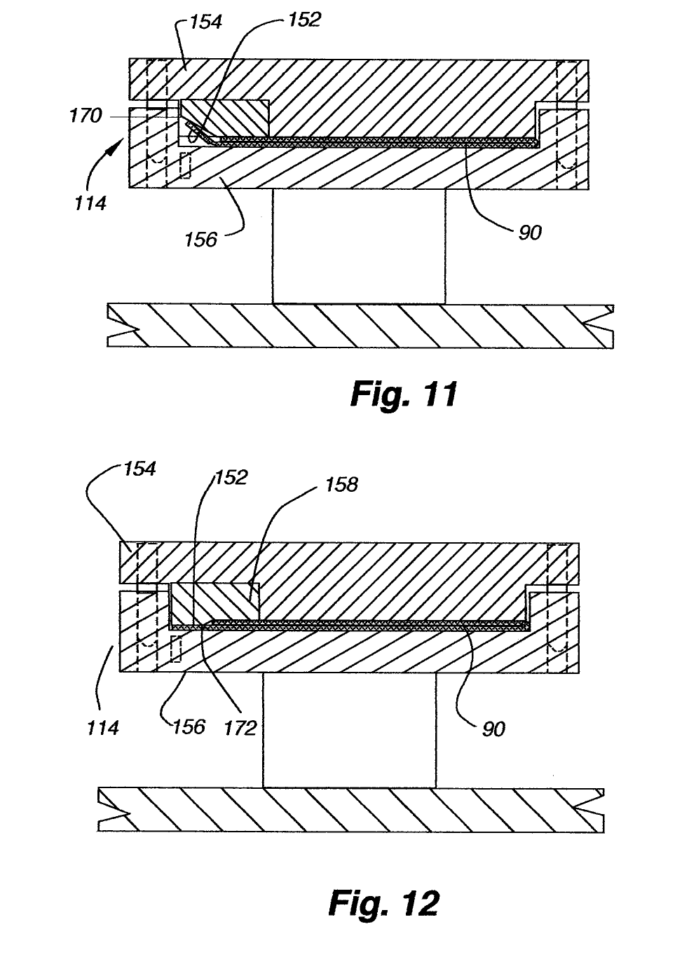

The first folding and aligning housing 114 seen in horizontal section in FIGS. 7 and 8 is shown in sequential vertical sections in FIGS. 9-12. The first folding and aligning housing can be seen to include a top component 154 and a complementary bottom component 156 that when mounted on each other define a space therebetween through which the folded vane strip material 90 can slidably pass. The top component as viewed in FIGS. 9 and 10 can be seen to be of generally T-shaped cross section with a centered downward abutment 158 and a handle 160 for gripping the upper component. The abutment projects downwardly into a generally U-shaped centered channel 162 having a back wall 162a in the lower component so as to define a relatively wide space 164 on the front side of the machine or the left side as viewed in FIGS. 9 and 10. At the upstream end of the lower component, an inclined ramp or cam surface 166 (FIG. 9) is formed in the lower component so that the flap 152 on the lower layer of the strip material can be urged or folded upwardly, forcing the vane material rearwardly into engaging alignment with the back wall 162a, until it assumes a somewhat vertical orientation against a vertical side wall 168 in the lower component as viewed in FIG. 10. The first folding housing in addition to forcing the strip material into a compressed configuration and aligning the material with the back wall 162a, also initially folds the flap upwardly so that it can be readily folded over the top layer in a downstream operation to be described later to complete the tubular formation of a vane. In FIG. 11, it will be seen that the upper component has a downwardly facing inclined ramp 170 which progressively engages the flap 152 to force it downwardly from its generally vertical orientation of FIG. 10 toward a flattened configuration assumed at the location in the first folding housing where the section of FIG. 12 is taken. At that location, the block or abutment 158 in the upper component of the first folding housing has a horizontal bottom wall 172 which has forced the flap downwardly again into a coplanar relationship with the remainder of the lower layer of the folded vane strip material. The vane strip material emanates from the downstream end of the first folding housing in the configuration illustrated in FIG. 12 and in that configuration it is desirably configured for cutting with the guillotine cutter 116 which operates in a vertical plane. With reference to FIG. 8, the cutter can be seen to be positioned between the friction rollers 118 and the downstream conveyor belts 130 and 132 in a gap where the vane is not supported by the friction rollers or the downstream conveyor belt but only by the cutter itself.

The cutter 116 is probably best seen in FIG. 16 where the vertically reciprocal guillotine cutting blade 126 is positioned vertically above a back-up plate 174 and the pneumatic cylinder 128 is provided for activating and deactivating the blade so that it can be advanced downwardly to cut the vane strip material and subsequently retracted in a very quick manner. The friction rollers 118 are seen immediately upstream from the cutter so that vane strip material can be pulled from the accumulator 110, through the folding blocks 112, and the first folding housing 114 to be fed into the cutter.

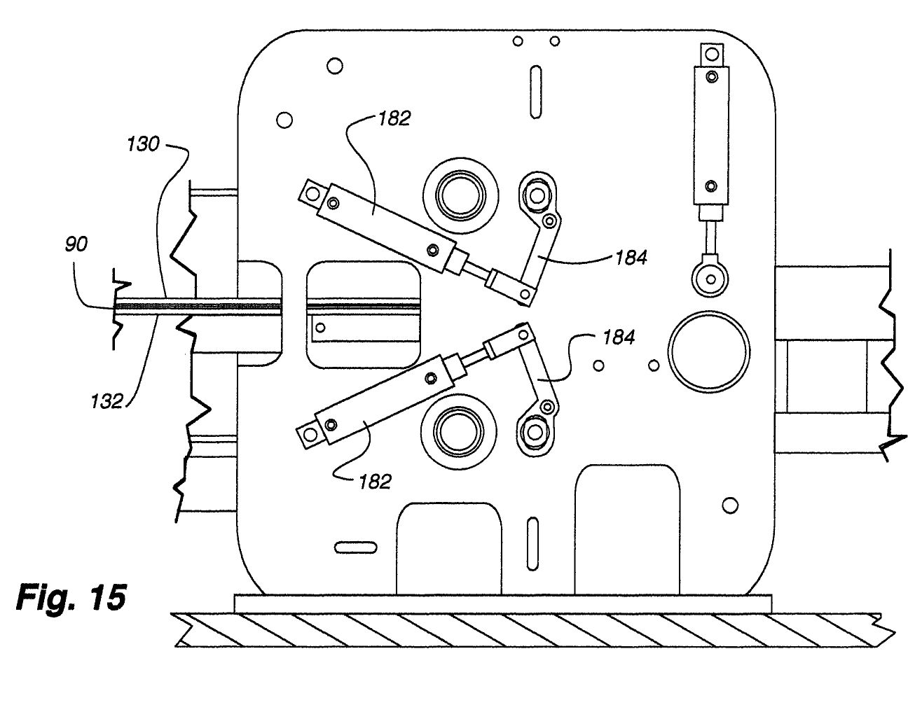

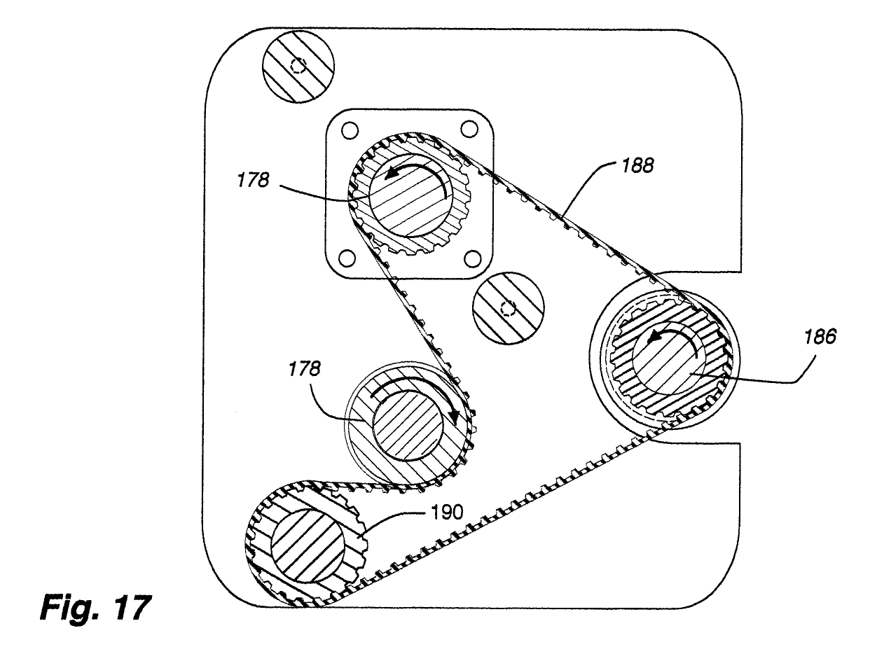

As also seen in FIG. 16, from the cutter 116, the cut lengths of vane strip material 90 are advanced downstream by the upper 130 and lower 132 endless belts with the upstream ends of each belt passing over three vertically aligned idler rollers 176 with the middle one of the three idler rollers being immediately adjacent to a driven roller 178. Immediately downstream from the driven roller is a low friction block 180 across which the upstream directed run of the associated belt 130 or 132 passes to provide more positive traction on the driven roller. Further, the middle one of the three idler rollers is biased toward the drive roller with pneumatic cylinders 182 shown best in FIG. 15 which are connected with lever arms 184 so that the middle idler is biased into engagement with the associated belt as it passes between the middle idler roller and the drive roller. In this manner, both the upper and lower endless belts are positively driven in a synchronous manner with a suitable pneumatic motor. As will be appreciated in FIG. 16, the downstream runs of the upper 130 and lower 132 endless belts are in facing relationship with the folded cut length of vane strip material 90 confined therebetween. When the belts are driven, the vane is therefore carried or advanced downstream toward the panel assembly system 86. In FIG. 17, the back side ends of the driven rollers 178 are seen joined to the drive shaft 186 of the pneumatic drive motor with a timing belt 188 and an idler gear 190 so that both the upper and lower endless belts are driven at the same speed.

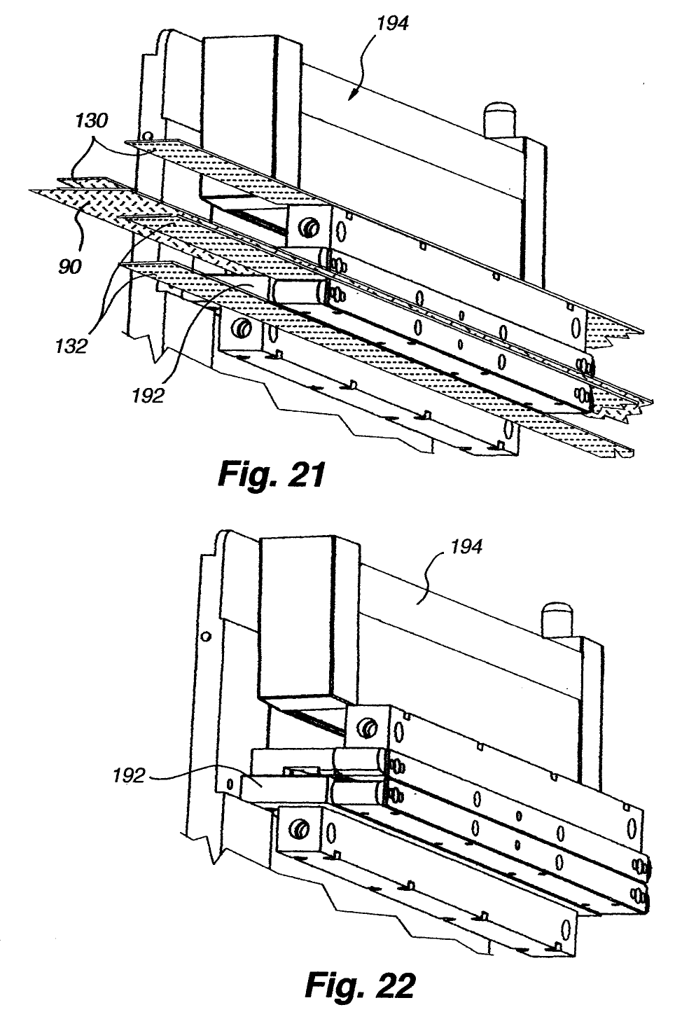

As seen best in FIGS. 2B, 3B and 20, as the folded cut length of vane strip material 90 is advanced downstream from the cutter 116, it passes through the adhesive activation station 134. The vane is not slowed down as it passes through the adhesive activation station inasmuch as infrared heat in the station is adequate to activate the otherwise inert adhesive 94 on the flap 152 of each length of vane strip material during the time period the length of vane strip material is exposed to the heat in the adhesive activation chamber. With reference to FIG. 20, the vane strip material protrudes laterally from the endless drive belts 130 and 132 and the adhesive activating chamber is disposed laterally on the forward side of the drive belts so that it can be aligned with the bead of adhesive on the flap of the strip of vane material. A support block 192 is provided for the laterally extending vane strip material and a heat radiating chamber 194 is mounted above the lateral extension of the vane strip material. The heat radiating chamber is an elongated chamber having a reflective panel 196 of generally parabolic transverse cross section which is focused at the location where the bead of adhesive passes through the chamber. An elongated infrared bulb 198 is positioned within the parabolic reflector so that the radiated heat waves therefrom are reflected off the parabolic reflector and downwardly onto the bead of adhesive to concentrate the heat and activate the otherwise inert adhesive. In this manner, when the length of vane strip material emanates from the adhesive activating station, the adhesive is tacky and in a condition where it will bond to another surface. The heat activating station can also be seen in FIGS. 21 and 22 with FIG. 21 being an isometric showing the chamber 194 in a laterally positioned offset location from the drive belts and in FIG. 21 the drive belts and vane strip material are shown within the chamber as illustrated in FIG. 22.

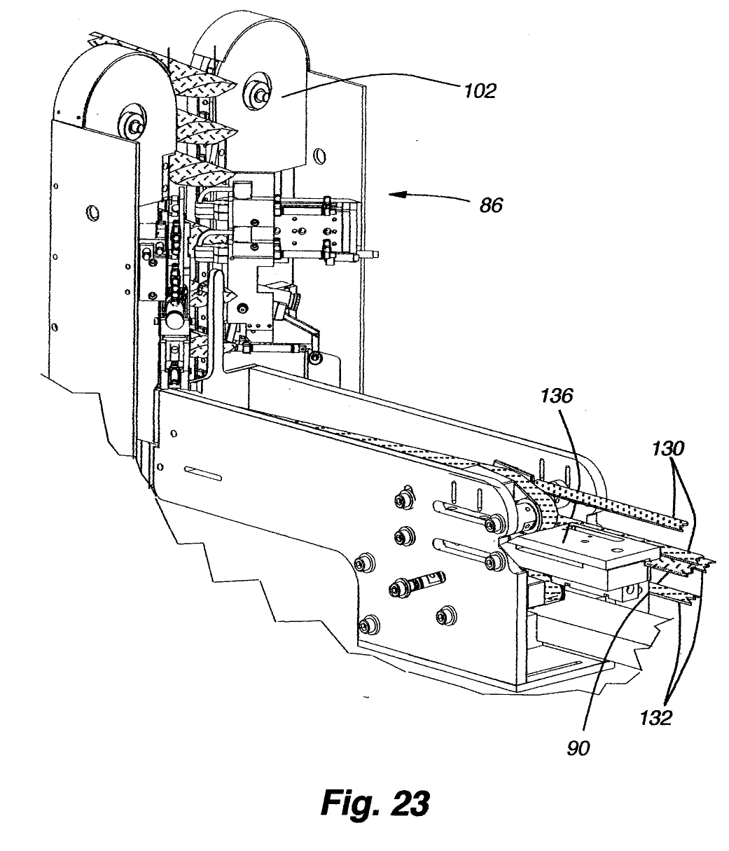

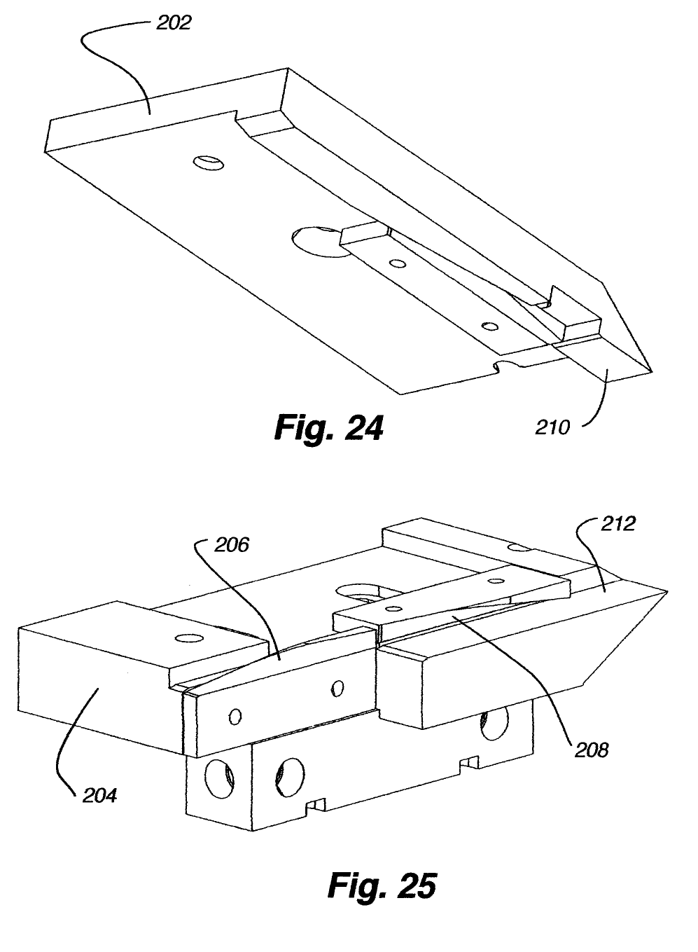

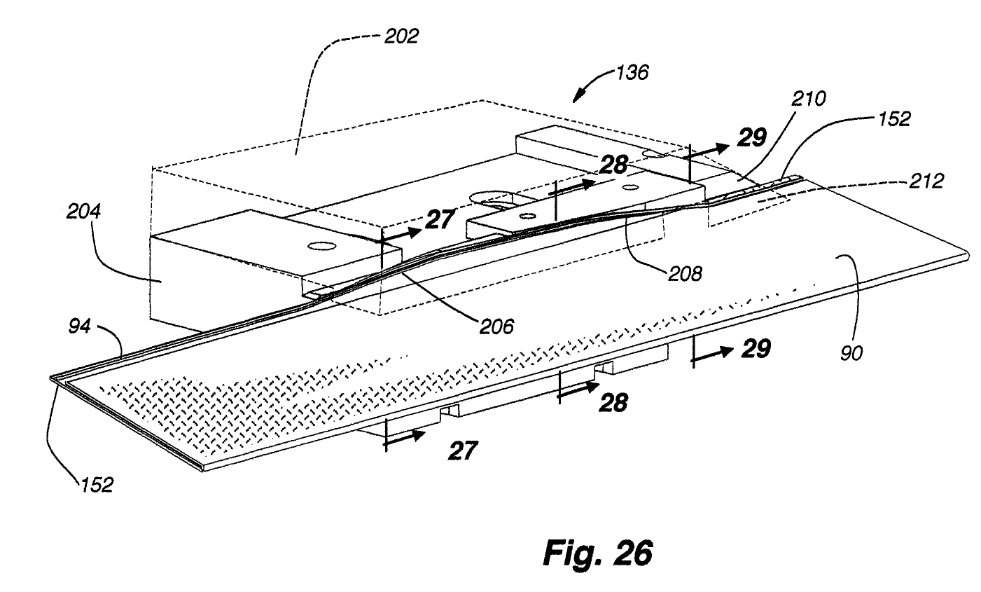

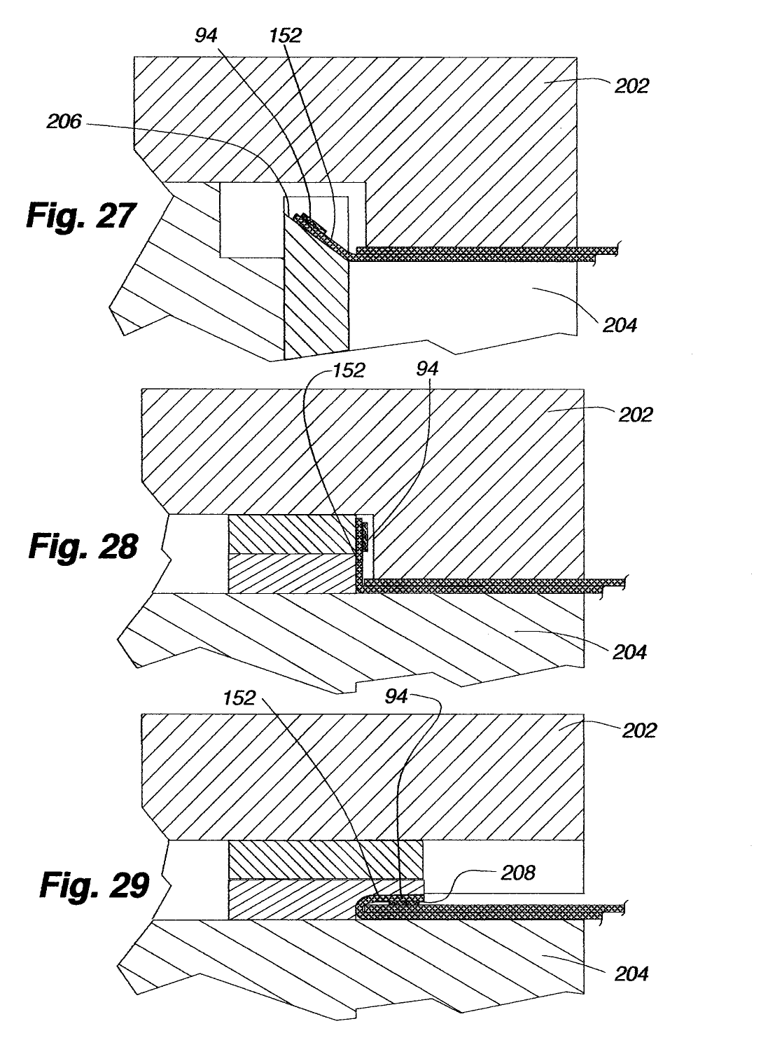

As probably best seen in FIGS. 23-30, upon leaving the adhesive activation station 134, the strip of material 90 is passed through the second folding housing 136 wherein the flap 152 with the adhesive 94 thereon is folded vertically upwardly and then horizontally over the adjacent edge of the top layer of the folded vane strip material and compressed against the top surface of the folded vane strip material to form a completed tubular vane. The second folding housing comprises a two-piece housing having an upper component 202 and a lower component 204. With reference to FIG. 25, the lower component is a block-like body having an upstream ramp 206 of longitudinally curved configuration which is aligned with the flap 152 of the vane strip material 90 so as to engage the flap and progressively vertically orient the flap as possibly best seen in FIGS. 26, 27, and 28. Immediately downstream from the curved ramp is a second curved downwardly directed ramp 208 which takes the vertically oriented flap and folds it further into a horizontal position overlying the adjacent edge of the upper surface of the vane strip material as probably best seen in FIGS. 26 and 29.

The upper component 202 of the second folding housing is somewhat complementary with the lower component 204 and allows space between the first curved ramp 206 to allow the flap to be folded and then assists the second curved ramp 208 in folding the flap on over the top surface of the vane strip material. After the flap has been folded over the top surface of the vane strip material so that the adhesive is bonding the flap to the top surface of the vane strip material, the vane strip material passes through spaced confronting faces 210 and 212 respectively of the upper and lower blocks which retain the compressed relationship of the flap with the top surface of the vane strip material.

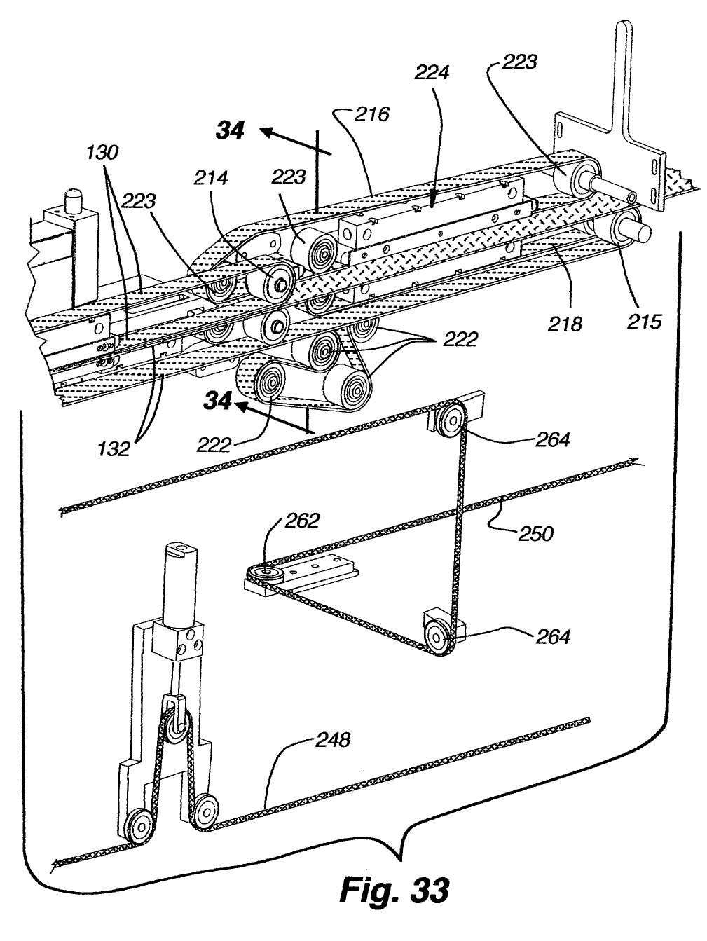

After emanating from the downstream end of the second folding housing 136, the upper endless belt 130 passes around an idler roller 214 (FIG. 33) and returns upstream so as to lose its engagement with the tubular vanes. The lower endless belt 132 extends further downstream and passes around an idler pulley 215 immediately adjacent and upstream from the panel assembly system 86. At the location where the idler roller 244 is located, a laterally adjacent pair of upper 216 and lower 218 belts engage the tubular vane at a laterally offset location from where the lower drive belt engages the vane strip material. As will be explained hereafter, the lower belt 218 is driven by a roller 219 on a drive shaft 221 carrying idler roller 215 but the upper belt 216 is simply an idler belt rotated by the lower belt 218 and the vane 124 carried between the belts 216 and 218. Accordingly, the tubular vane continues to move in a linear path in a downstream direction even though its driving force has at least partially been transferred from one set of endless belts 130 and 132 to a second set 216 and 218.

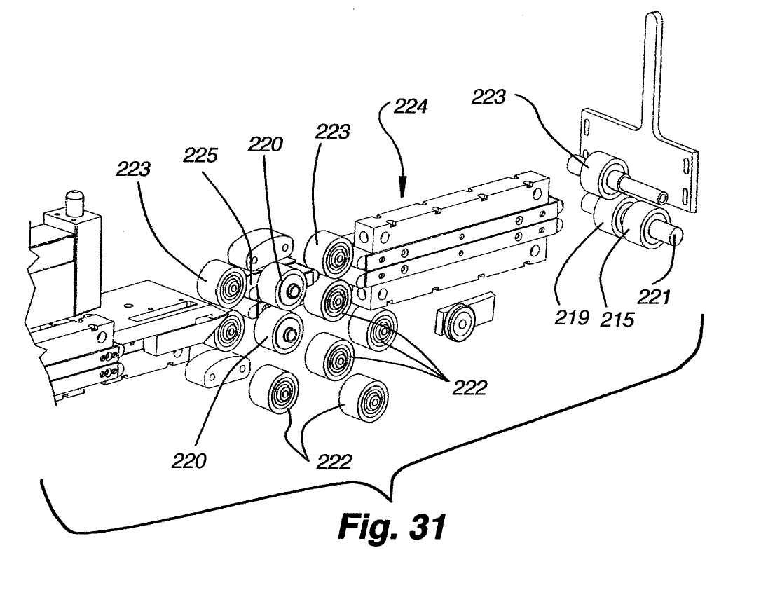

The second set of endless belts are possibly best seen in FIGS. 30, 31 and 34. The lower belt 218 at its downstream extent passes around the drive roller 219 and at its upstream extent tensioning rollers 222 (FIGS. 30-34) to provide a positive grip on the tubular vane 124 for moving it downstream. The upper belt 216 passes around the idler rollers 223 and as mentioned above is driven through its operative engagement with the lower belt 218 and vanes 124 carried therebetween. Immediately after being transferred to the second set of endless belts, the tubular vane 124 is passed through a compression block 225 which maintains compression of the flap 152 on the top surface of a vane 124 and a cooling station 224 where cooling blocks 226 are positioned above and below the endless vanes if necessary. Typically, the cooling occurs naturally but depending upon environmental elements, a cooling system in the blocks 226 may be utilized to make sure the adhesive cures before the vane is passed into the panel-assembly system 86.

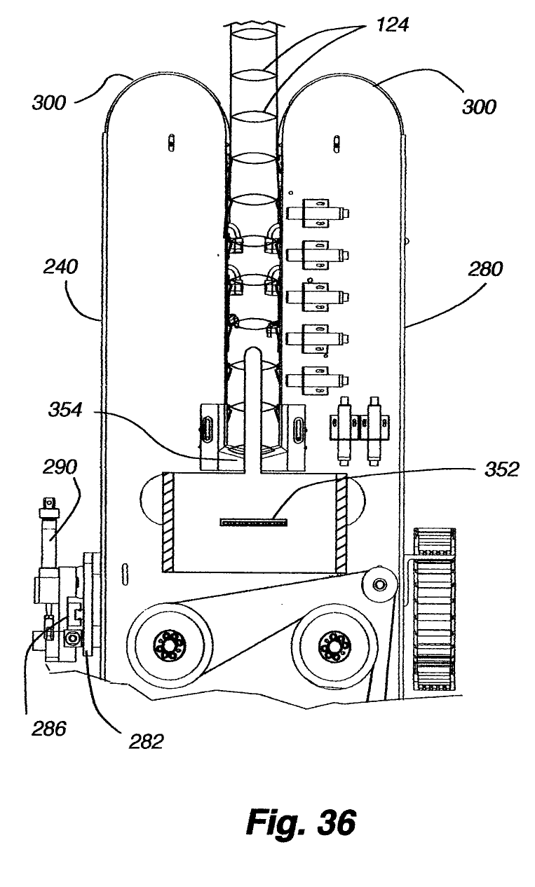

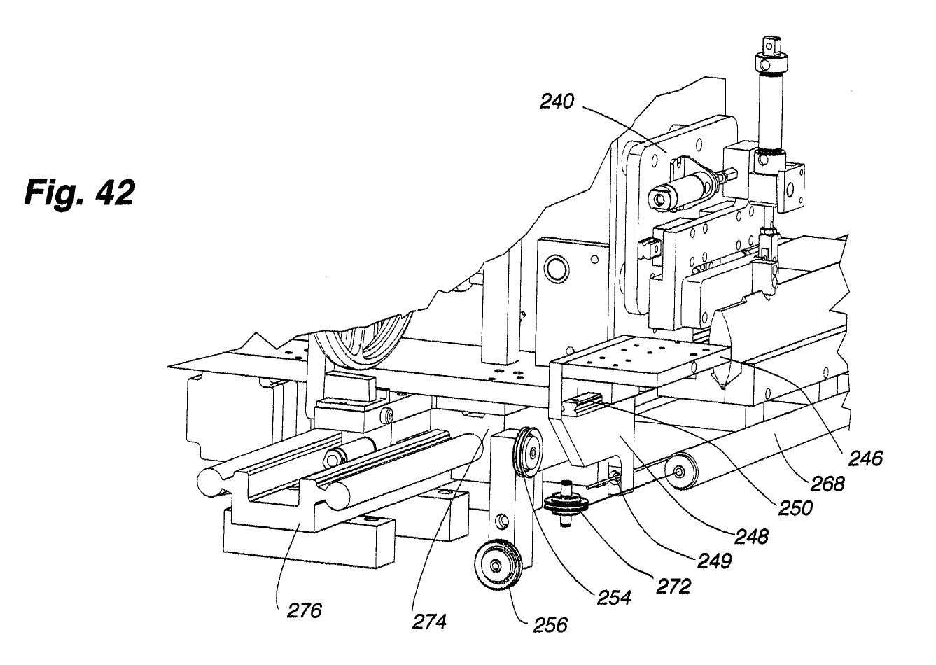

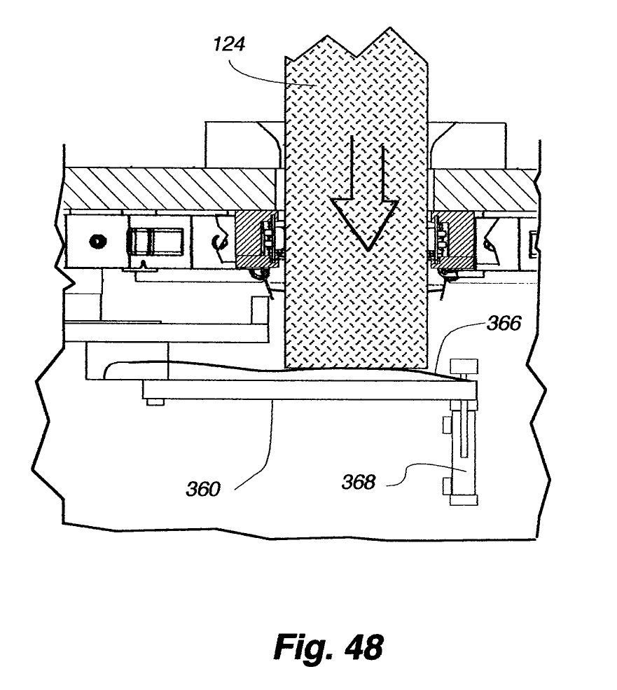

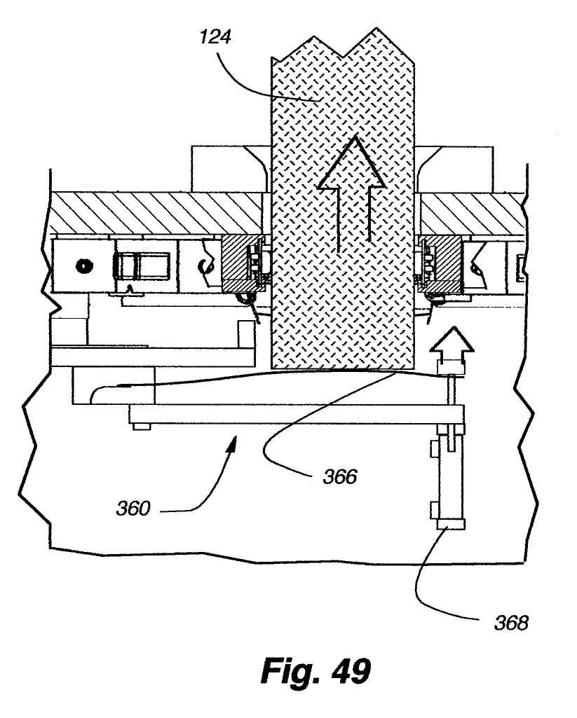

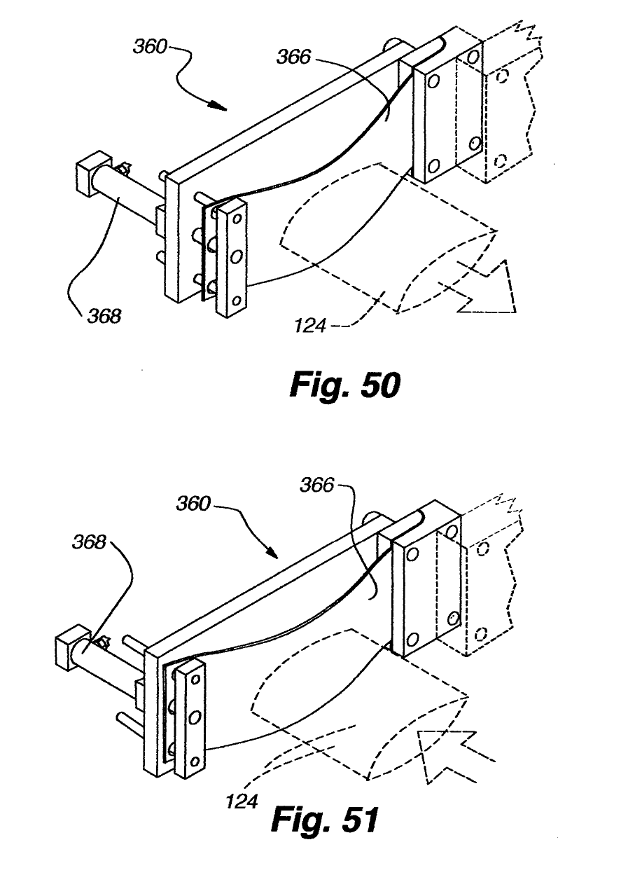

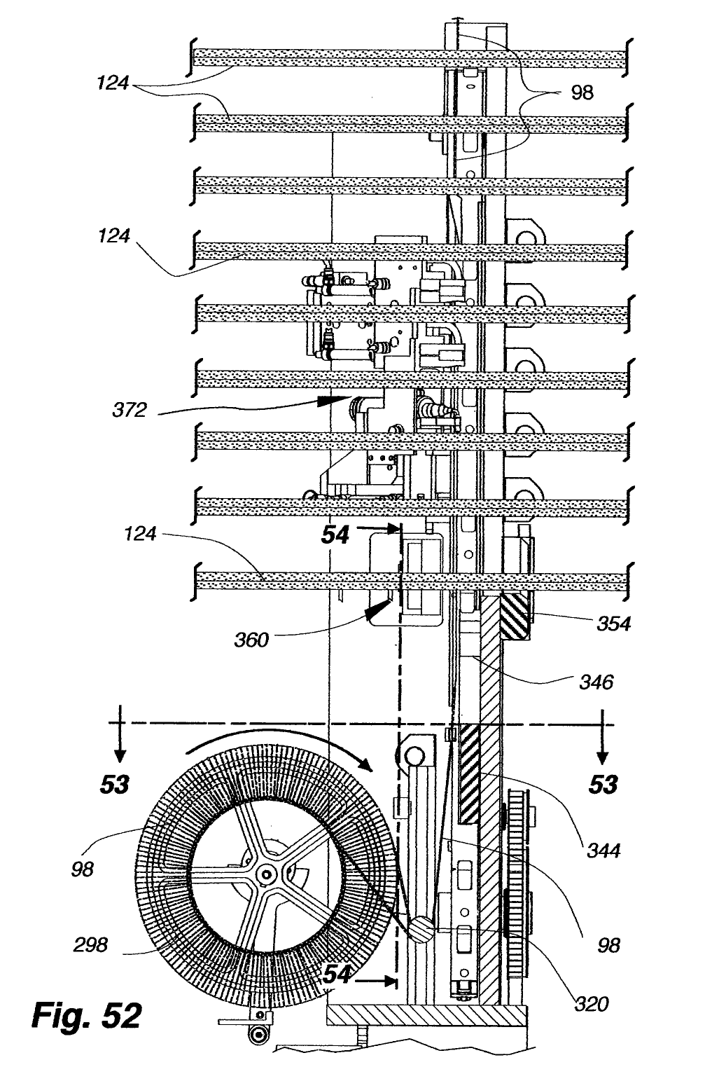

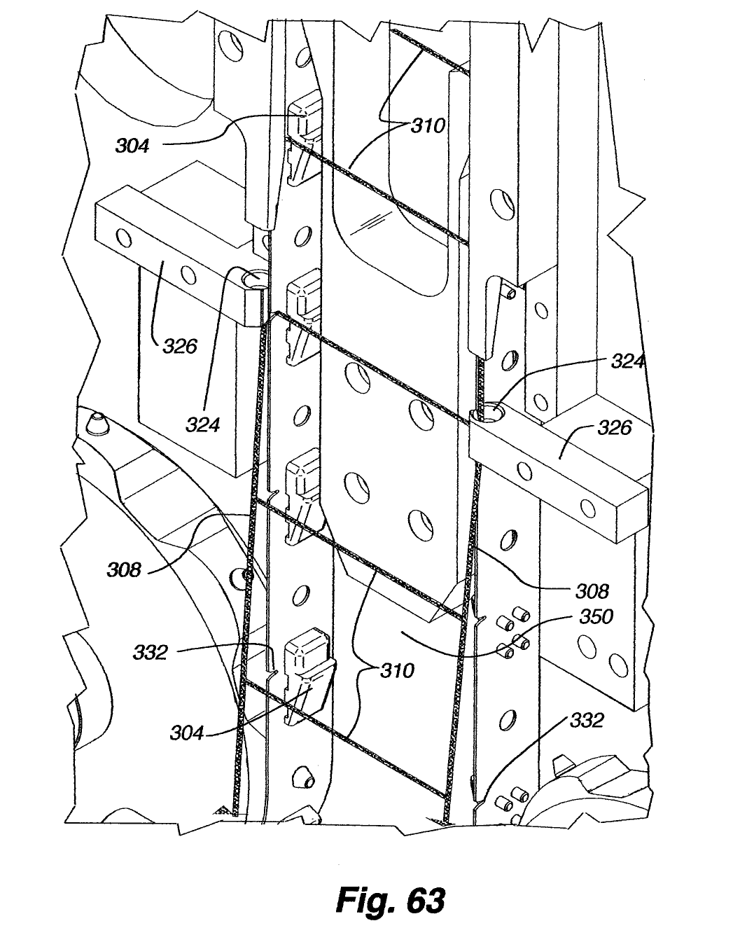

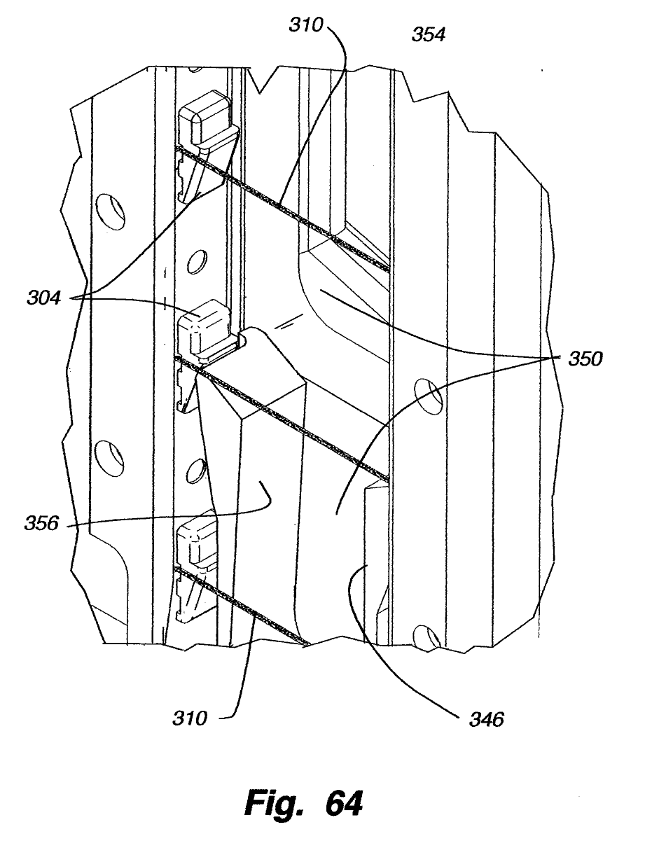

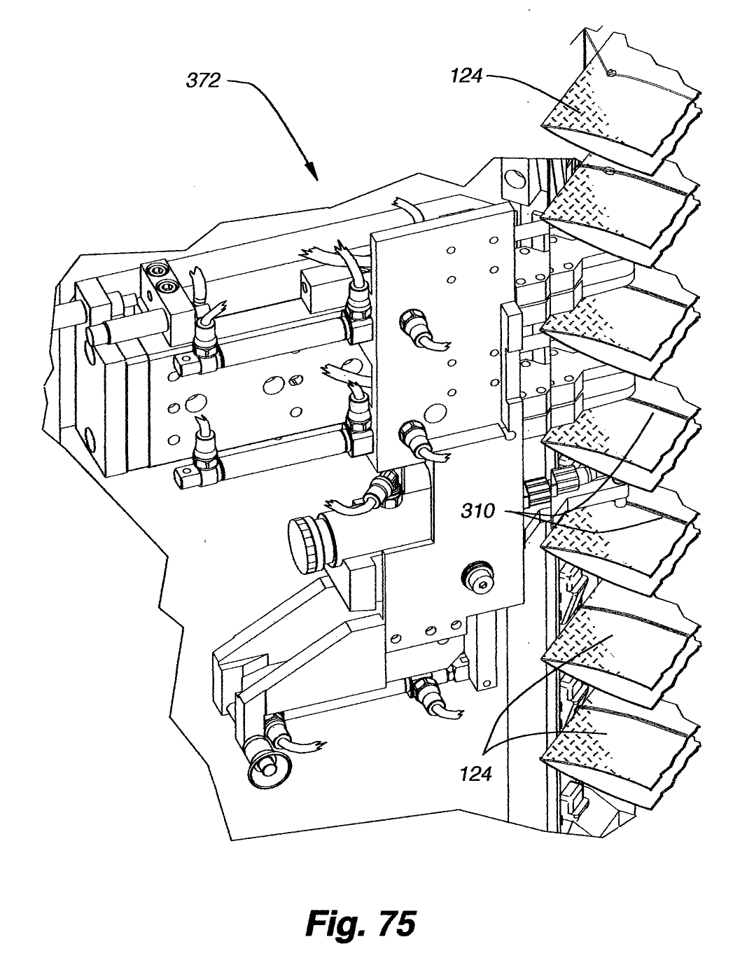

The panel-assembly system 86 is best seen in FIGS. 1, 2A, 3A, and 35-75. It will be appreciated the panel-assembly system is mounted on a framework 228 with various tracks to be described hereafter, a series of the cord ladder assemblies 102, the upstream most of which is fixed and the downstream four of which are slidably movable on tracks in upstream and downstream directions between fixed positions. A lift tower 230 is also provided with lift cords 232 associated with each cord ladder assembly 102 and a motor driven pulley system 234 for raising or lowering the lift cords 232 as will be described hereafter. The panel assembly system further houses a portion of the vane-sizing system 84 mentioned previously in connection with the cutting of the vane strip material to desired predetermined lengths.

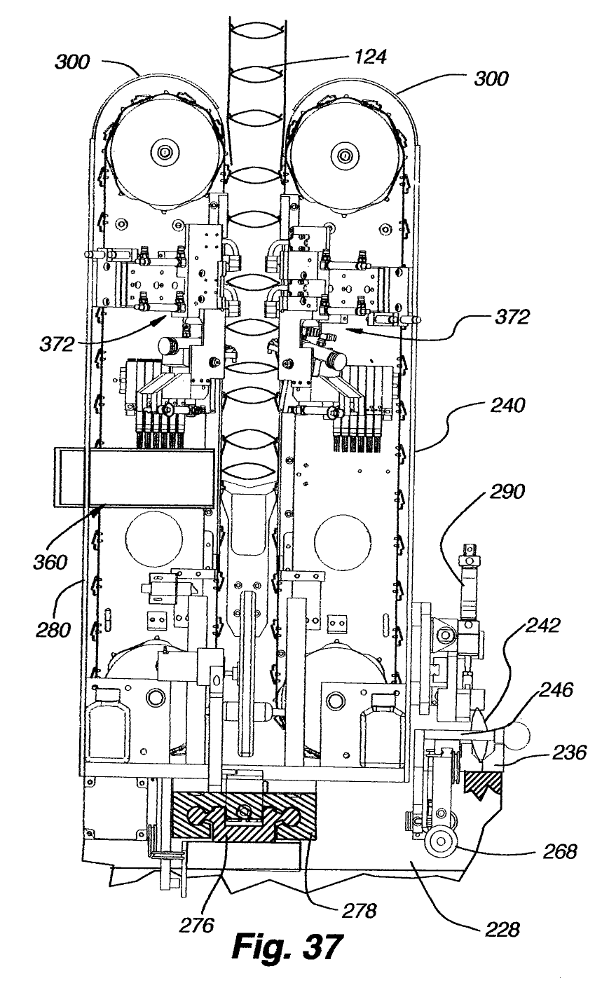

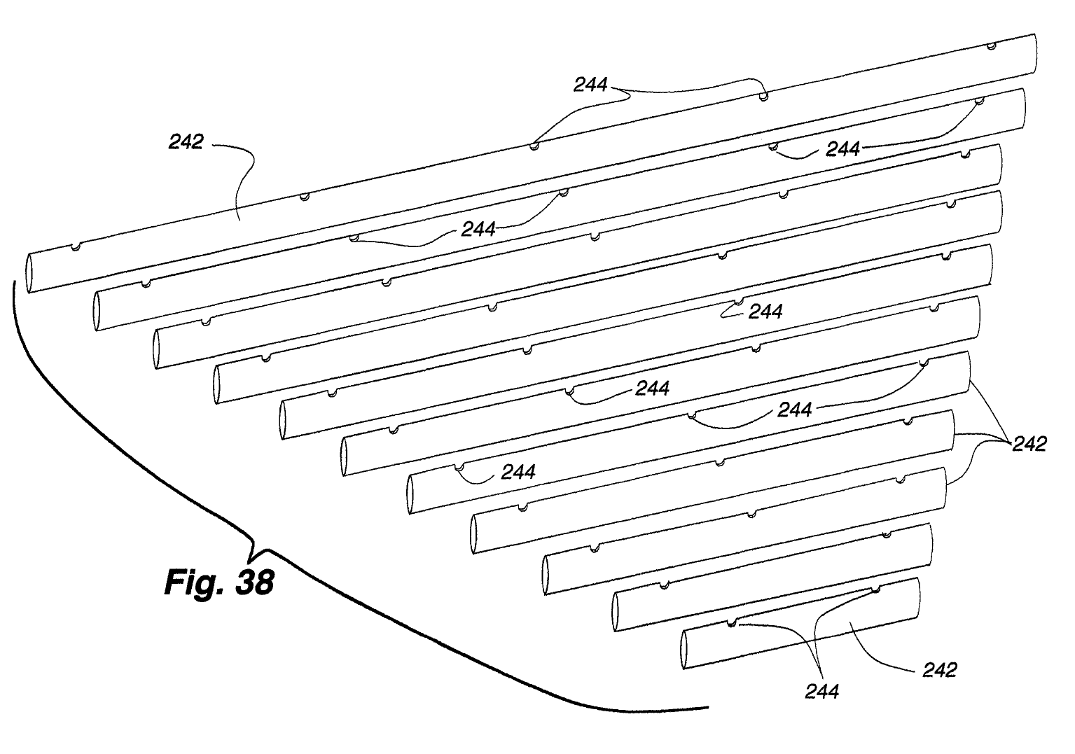

As possibly best seen in FIGS. 2A and 37, the front of the panel assembly system 86 has a generally V-shaped upwardly opening longitudinally extending horizontal channel or trough 236 supported on the framework 228 of the apparatus in a fixed position with a limit bracket 238 extending forwardly off a side panel 240 of the fixed cord ladder assembly 102 in alignment with the V-shaped channel to define an upstream end of the channel. The channel 236 is adapted to releasably receive a tubular template 242 of a configuration similar to that of the tubular vanes 124 and of a length corresponding to the predetermined length desired for the vanes being assembled in a particular panel 100. The tubular templates are illustrated in FIG. 38 as being of various lengths with the shortest template having a pair of notches 244 formed in its upper edge and as the length of the templates gets longer, the number of notches may increase. Each notch corresponds with the location on a vane 124 being used in a panel where a cord ladder 98 will be positioned as will be made more clear hereafter.

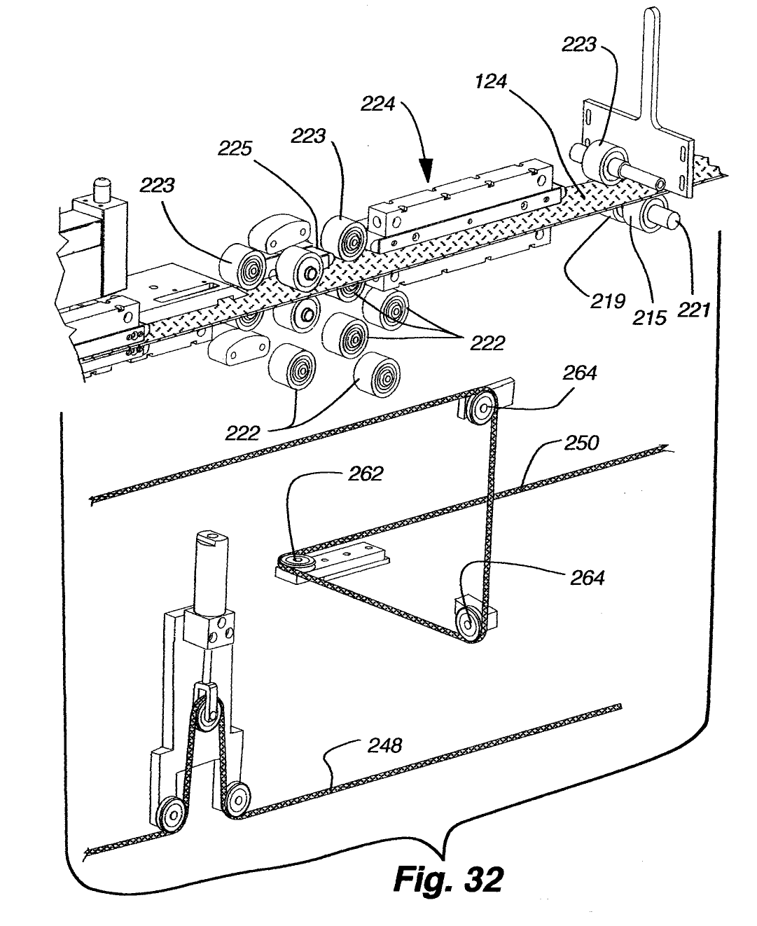

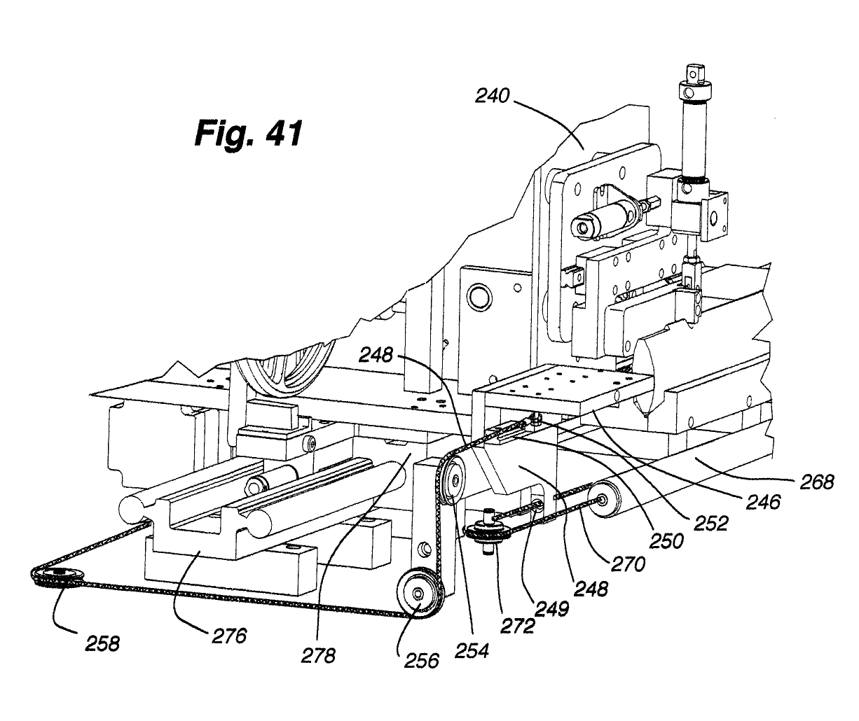

In order to cut the vane strip material 90 at the desired lengths for a panel 100 of a predetermined width, a template 242 as shown in FIG. 38 of the desired length or a length not less than the width of a panel being fabricated is placed in the V-shaped channel 236. A template positioning plate 246 possibly seen best in FIGS. 2A and 41 automatically engages the downstream end of the template and slides it forwardly in the V-shaped groove until it abuts the limit bracket 238 at the upstream end of the V-shaped groove. The positioning plate is horizontally disposed and mounted on a vertical base 245 with the base being mounted on a guide track 247 (FIG. 41) for sliding movement in an upstream or downstream direction. It should also be noted the positioning plate can be moved independently of the cord ladder assemblies 102 and along and past the assemblies if necessary without interference. The positioning plate 246 is connected to a pair of non-extensible but flexible cables 248 and 250 which in turn are connected to the block 122 on which the photosensors or detectors 120 are mounted so that sliding movement of the positioning plate causes a corresponding sliding movement of the block 122 on which the photosensors are mounted. The cable 248 passes through a cable tensioner 251 (FIGS. 4B and 32) to place a desired tension in cable 248 and consequently cable 250 as will be appreciated with the description that follows.

The routing of the cables 248 and 250 is probably best seen in FIG. 4B. The first cable 248 is anchored to a pin 252 on the positioning plate 246 and extends downstream around a first vertically oriented pulley 254, a second vertically oriented pulley 256 disposed at 90 degrees relative to the first pulley, a third horizontal pulley 258, and then upstream where it passes around a pair of vertically oriented pulleys 260 immediately downstream from the cutter 116 and from these vertically oriented pulleys it returns to and is secured to the block 122 on which the photosensors 120 are mounted so the cable is capable of pulling the block 122 in an upstream direction. The second cable 250 is also anchored to a pin 252 on the bottom of the positioning plate 246 and extends upstream therefrom, passes around a horizontally oriented pulley 262, and subsequently a pair of vertically oriented pulleys 264 that are 90 degrees relative to each other from which the cable 250 extends upstream and is anchored to the block 122 on which the photosensors 120 are mounted in a position to pull the block in a downstream direction. The block 122 of course is slidably mounted on a guide rail 266 (FIG. 18) on the frame for the machine and its positioning is therefore controlled by the cables. It will be appreciated that movement of the positioning plate in an upstream direction when pushing the template 242 in an upstream direction pulls on the cable 248 that extends downstream from the positioning plate thereby pulling the block 122 having the photodetectors 120 upstream. Of course, the cable 250 extending upstream from the positioning plate allows upstream movement of the block correspondingly. Movement of the positioning plate downstream, however, has a reverse effect on the block so that the block can be moved downstream. It will therefore be appreciated that as the positioning plate is moved upstream corresponding with shorter lengths of templates, the block 122 is also moved upstream and closer to the cutter 116 so that the length of vane strip material 90 being cut will be commensurate with the shorter length of template. Of course the opposite is true with longer templates used with panels of greater widths.

With reference to FIG. 41, a pneumatic cylinder 268 is provided with a cable 270 emanating from its upstream and downstream ends with the cable in combination with the cylinder forming an endless loop around horizontally oriented pulleys 272 spaced from opposite ends of the pneumatic cylinder. The cable 270 is anchored to the lower edge of the base 245 of the positioning plate 246 at 249 so that movement of the cable causes the plate to move correspondingly. The control system (not shown) for the apparatus is such that when a template is dropped into the V-shaped channel 236, the pneumatic cylinder 268 is energized to move the cable in a clockwise direction as viewed in FIG. 41 thereby moving the positioning plate upstream until the template has been advanced against the limit bracket 238 at which time the pneumatic cylinder is deactivated. In this manner, the positioning plate is automatically controlled to sense the length of a template which information is then transferred via the cables 248 and 250 to the block 122 carrying the photosensors 120 so that the vane strip material 90 is cut to the desired length.

With reference to FIG. 2A, the cord ladder assemblies 102 can be seen to be identical except that the fixed cord ladder assembly, which is the upstream-most assembly 102, does not have a template detector 274 on its front face 240 as do the movable assemblies 102. In other words, the fixed assembly always remains in the same position and is utilized regardless of the size of the panel to be fabricated in the apparatus and functions to properly position the most upstream cord ladder 98 used in the panel.

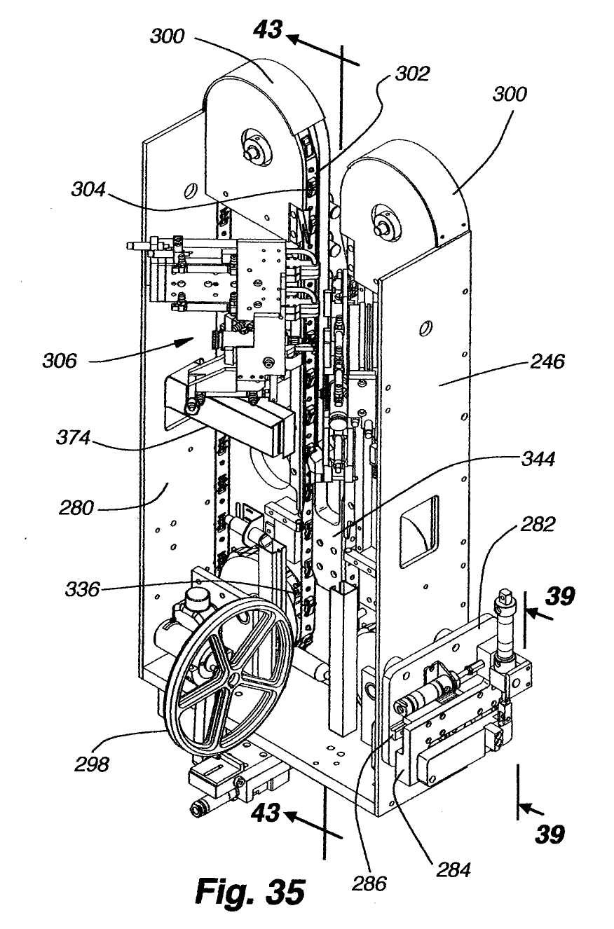

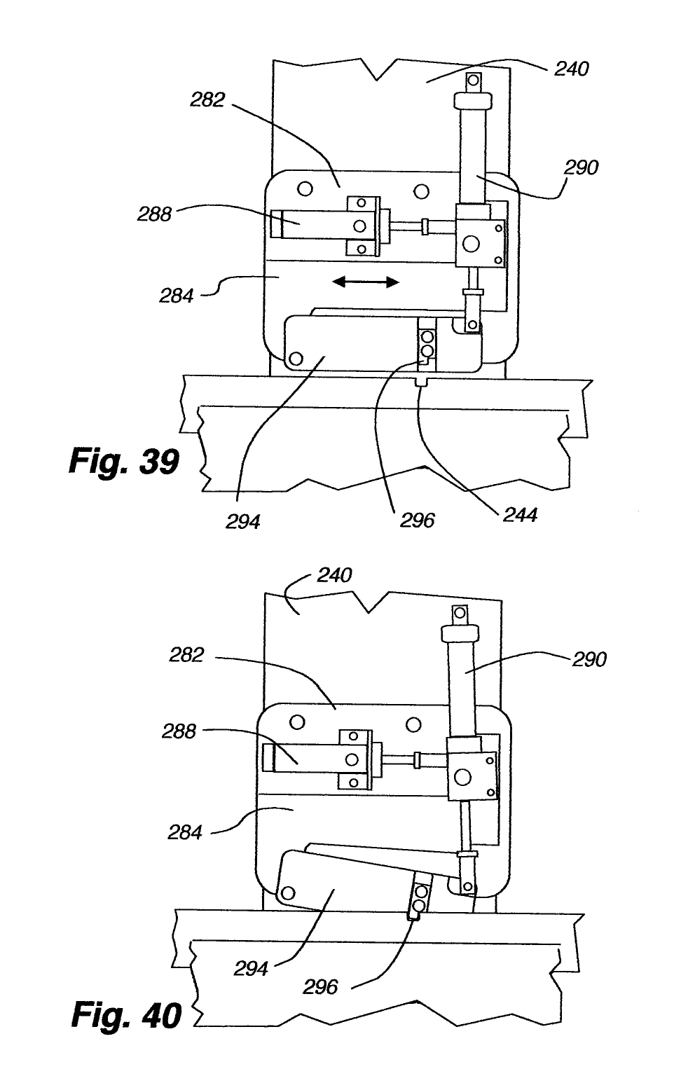

The movable cord ladder assemblies 102 are slidable along a track 276 as seen in FIGS. 37 and 41 which cooperates with slide blocks 278 on the frames of the assemblies 102 to facilitate their movement in upstream and downstream directions. Each movable assembly has a front 240 and rear 280 vertical plate with a template detector being mounted near the bottom of the front plate on each assembly. The template detectors are each identical and probably best seen in FIGS. 35, 39, and 40 to include a vertical mounting plate 282 on which a base plate 284 is slidably mounted on a track 286 for movement in upstream or downstream directions. With reference to FIGS. 39 and 40, each detector has a horizontal pneumatic cylinder 288 and a vertical pneumatic cylinder 290 with the horizontal cylinder being mounted on the mounting plate 282 and the vertical cylinder on the base plate 284 carried by the plunger of the horizontal cylinder 288. The vertical cylinder has its plunger connected to the free end of a pivot plate 294 having a catch finger 296 mounted thereon with the catch finger being adapted to be removably engaged in a notch 244 along the top edge of a template 242 as described previously.

The detector 274 is utilized to correlate and position a cord ladder assembly 102 relative to a template 242 by moving the assembly along its track 276 until the assembly is approximately aligned with a notch 244 in the template and the horizontal cylinder 288 can then move the block 292 carrying the vertical cylinder until the catch finger 296 is somewhat aligned with the associated notch 244 in the template. The vertical cylinder 290 can then be activated to extend its plunger causing the pivot plate 294 to pivot downwardly forcing the catch finger into the notch. If the alignment is not precise, the horizontal cylinder 288 is activated to move the vertical cylinder upstream or downstream until the lock finger aligns with and is driven into the associated notch by the vertical cylinder. In this manner, the associated lift cord assembly 102 is properly positioned relative to the template 242 and the template position correlates with the position of tubular vanes 124 being assembled in the panel formed by the apparatus. Each movable cord ladder assembly is positioned relative to the template in the same manner so they are distributed and separated from each other corresponding to the notches in the template. If the panel being formed is of a narrow width so that all five of the cord ladder assemblies are not necessary, the unused assemblies can be shifted downstream and out of the way such as seen in FIGS. 4C, 4E, 4F, and 4G.

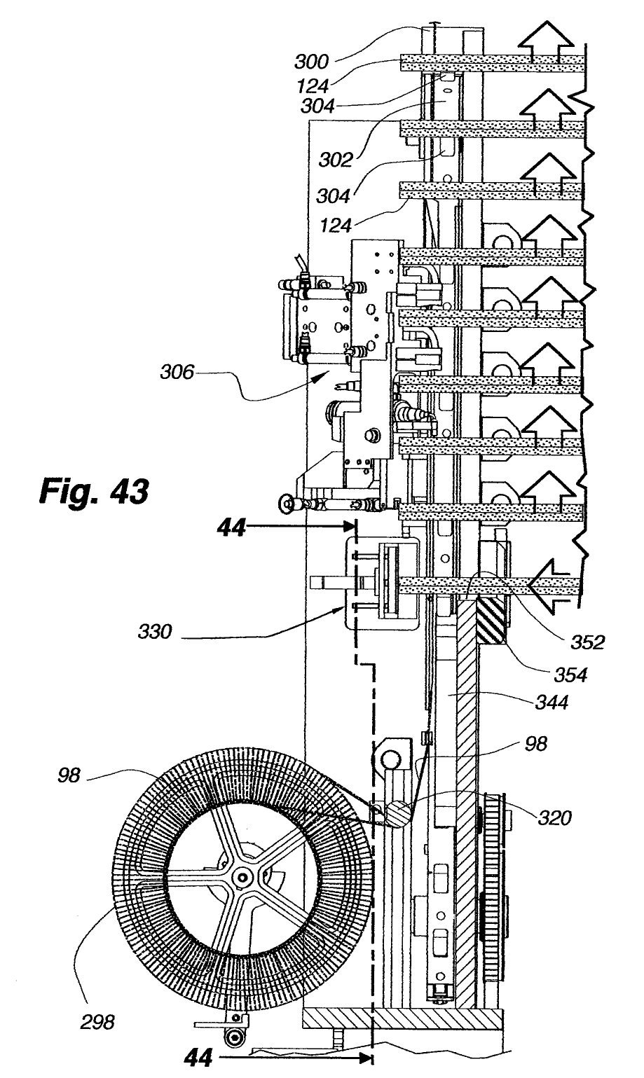

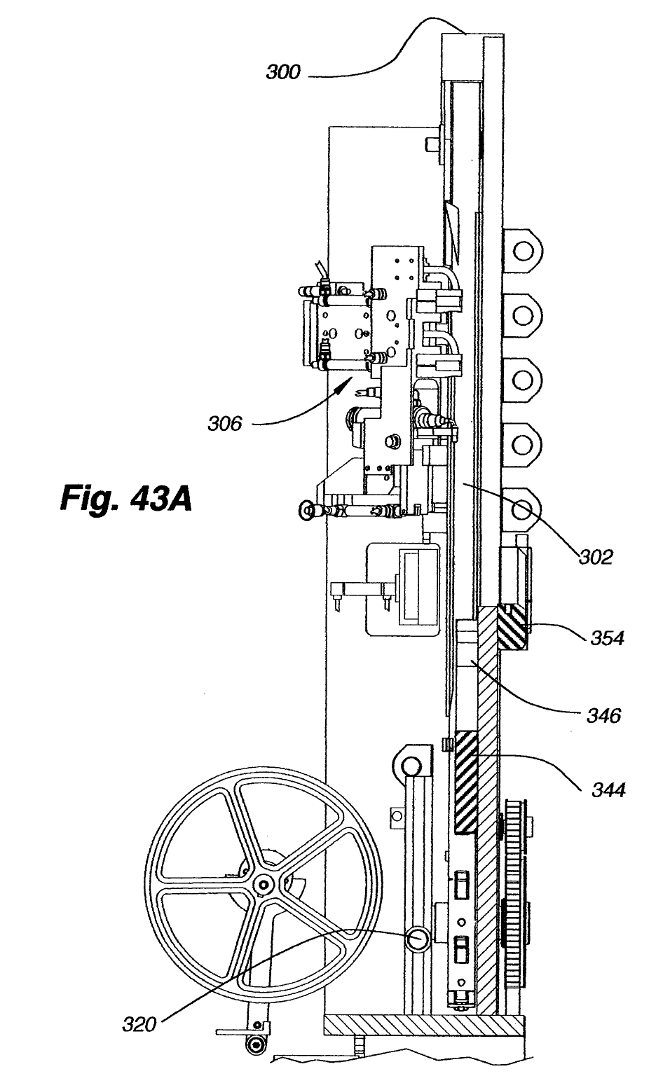

Looking at FIGS. 35 and 43, each fixed and movable cord ladder assembly 102 can be seen to include a step motor-driven wheel 298 on which a supply of cord ladder material 98 is wrapped, a pair of lift towers 300 each carrying an endless lift belt 302 having lift fingers 304 uniformly spaced along its outer circumference, a system for guiding cord ladder material 98 vertically between the endless lift belts, and a device 306 for applying adhesive and drying the adhesive securing each vane 124 to a cord ladder 98.

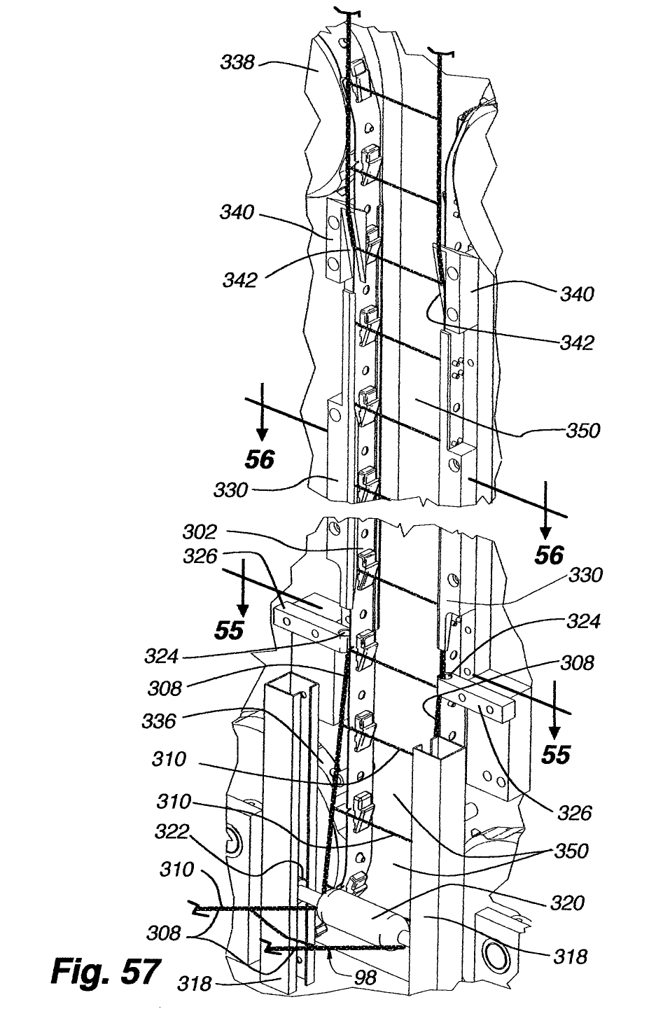

The cord ladder material 98, which might be best seen in FIG. 57, is conventional and made from flexible cord. The ladder material has a pair of vertical riser cords 308 with horizontal rungs 310 interconnecting the vertical cords at uniformly spaced locations. The rungs are utilized to support slats 124 associated therewith so that in the finished panel fabricated with the apparatus of the present invention, a plurality of cord ladders 98 are incorporated with tubular slats 124 associated with each rung 310 of each ladder.

The cord ladder material 98 is supplied by being wrapped around the wheel 298 and is fed upwardly between the lift belts 302 in a manner to be described in detail hereafter. The upper end of the cord ladder material associated with any panel 100 being assembled in the apparatus is connected to a lift hook 312 at the end of one of the lift cables or cords 232 shown best in FIG. 1. A lift cable is secured to the top end of each cord ladder 98 with five lift cords being provided even though they may not all be needed depending upon the width of the panel being assembled and the number of cord ladder assemblies being utilized. The opposite end of each lift cable is connected to a spool 314 which can be rotated in either direction by a reversible pneumatic motor 316. Rotation of the motor in one direction causes the lift cables to be wrapped around the spool at spaced locations along the length of the spool as the panel being assembled increases in size. When the panel is completed, the lift cables are removed from the cord ladders and the assembled panel is thereafter removed from the apparatus.

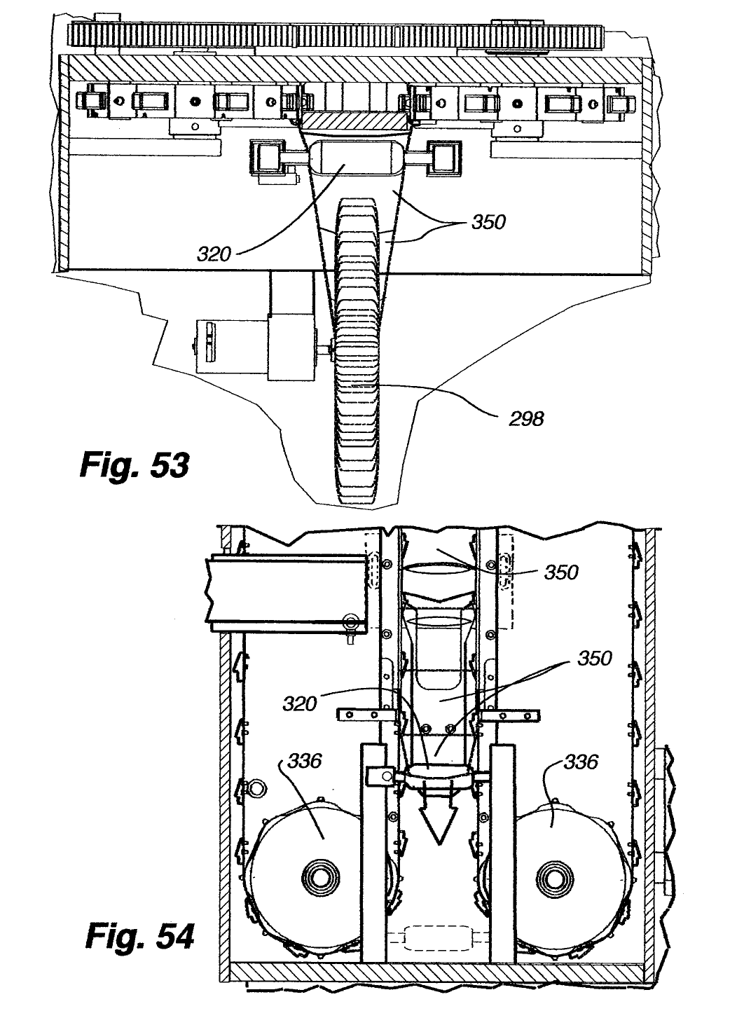

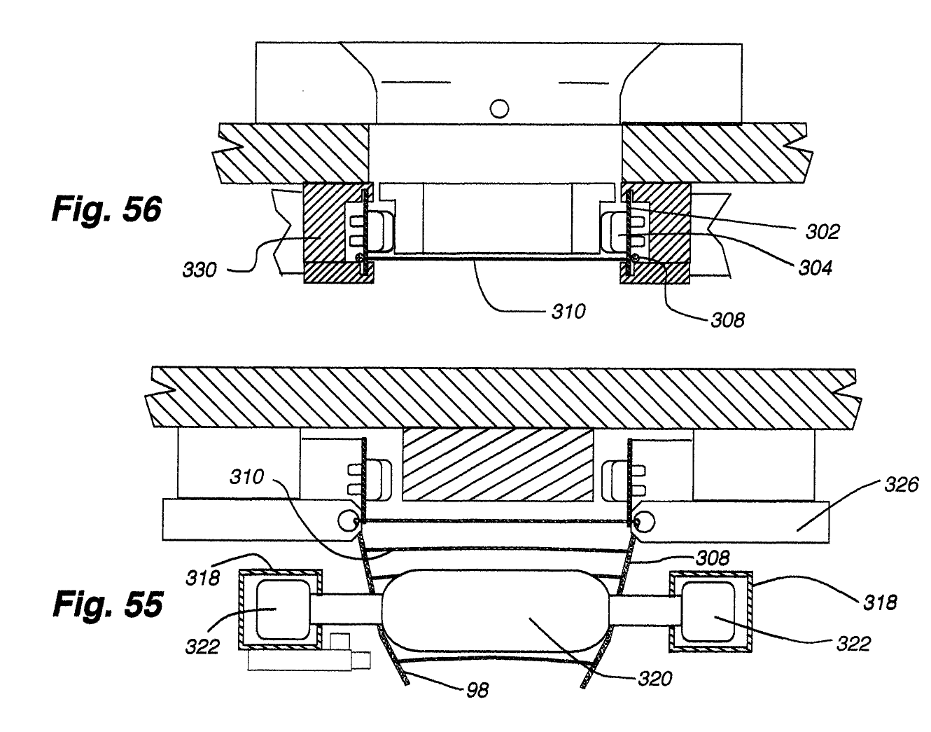

Before assembling a panel 100 in the panel-assembly system, the cord ladders 98 are threaded through the cord-ladder assembly 102 from bottom to top and subsequently connected to a lift hook 312 on an associated lift cable 232. The cord ladder material is wrapped around the wheel 298 so that the wheel rotates in a counterclockwise direction as viewed in FIG. 35 as the material is being removed therefrom. In other words, the material is fed off the bottom of the wheel toward a space between the lift belts 302. Immediately adjacent the wheel 298 and spaced from opposite sides thereof are a pair of vertical channels 318 (FIG. 57) slidably carrying a tensioning spreader spool 320 of generally cylindrical configuration having cylindrical ends 322 adapted to roll within the vertical channels. The tensioning spreader spool is therefore adapted to move vertically but is of a predetermined weight so as to stretch the cord ladder material to place a desired tension thereon as it is being processed through the assembly. The ends of the spool 320 are beveled so as to encourage the vertical runs of the cord ladder passing thereacross to be spread and spaced from each other as possibly best seen in FIGS. 53 and 55.

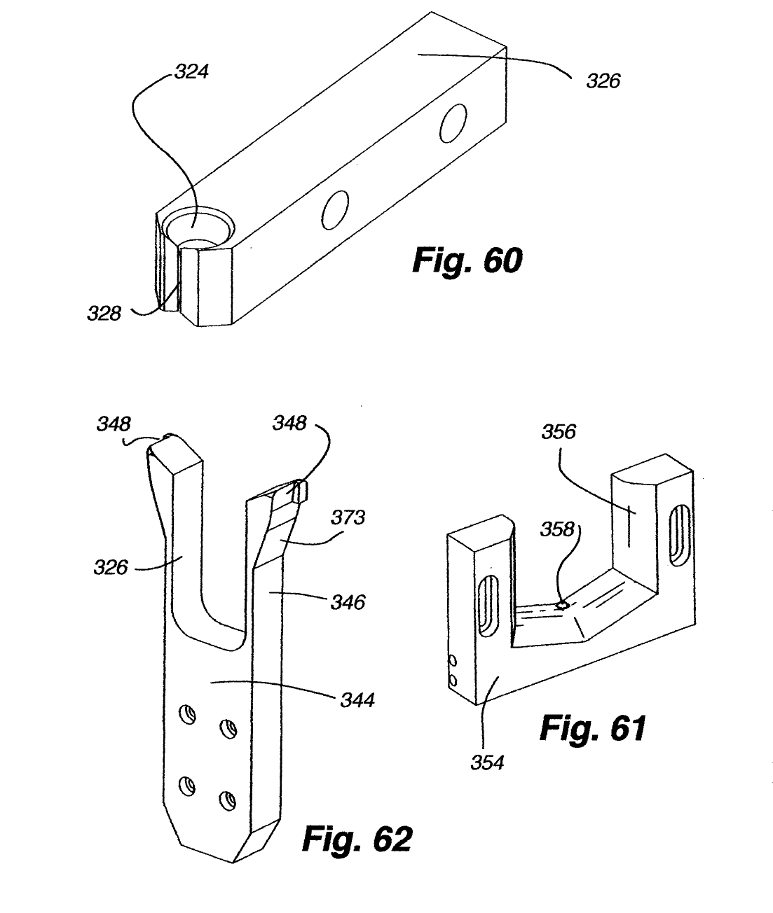

Each vertical riser cord 308 of a cord ladder 98 after passing around the spreader spool 320 is threaded through a circular passage 324 (FIGS. 57 and 60) in a riser guide 326 with the circular passage having a very narrow vertical access slot 328 which is slightly smaller than the diameter of the cord but such that the cord can be forced through the slot but will not easily come back out or escape through the slot. In other words, once the vertical cord is positioned within the circular passage, it will remain therein and slidably pass therethrough. The slot also allows the rungs 310, which are typically of a thinner diameter than the vertical riser cords, to slide therethrough as the lift cord is moved vertically upwardly through the assembly. The riser guides 326 serve to hold the vertical cords in a separated position at this location in the assembly as possibly best seen in FIG. 57. After passing through the riser guides, each vertical riser cord is fed into and behind a vertical guide plate 330 which confines the vertical cord behind an associated lift belt 302.

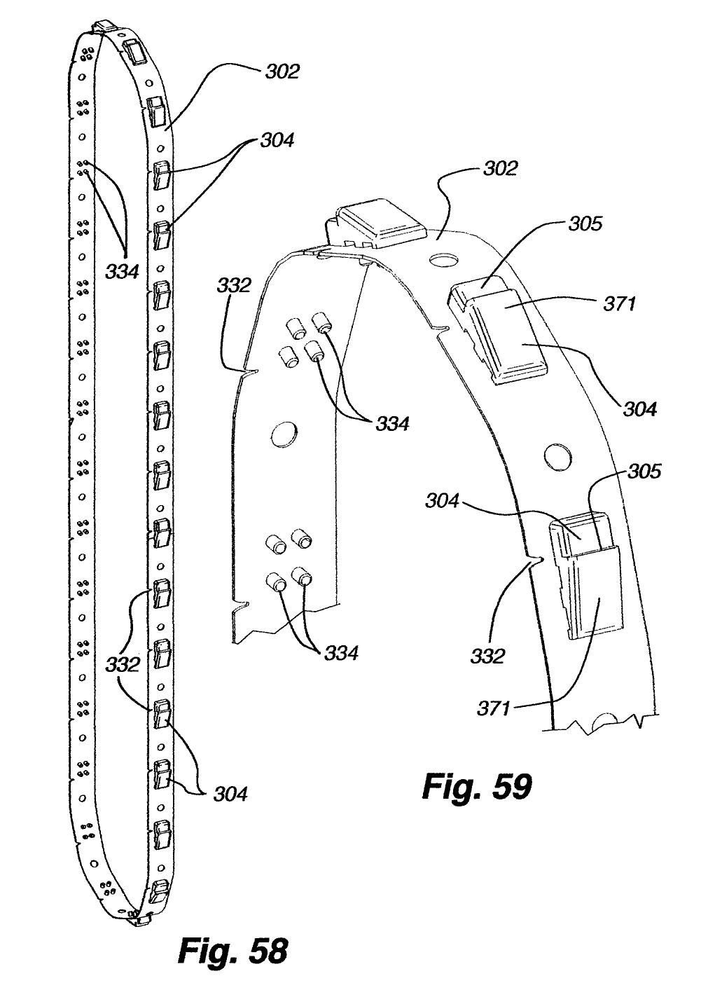

As can be appreciated by reference to FIGS. 58 and 59, each lift belt 302 has a notch 332 formed in its forward edge adapted to receive a rung 310 of the cord ladder 98 so that the vertical riser cords 308 can remain behind the belt with the rungs extending between the belts and passing through the notches in the lift belts. As will be described in more detail later, adjacent each notch in the lift belt is a lift finger 304 having a shelf 305 aligned with the notch 332 for supporting an edge of a tubular vane 124 during the assembly process. The inside surface of each belt has sets of engagement pins 334 adapted to cooperate with a driven pulley 336 (FIG. 57) at the bottom of each lift tower and an idler pulley 338 at the top of each lift tower. The driven pulley 336 is engaged with a reversible drive motor (not seen in FIG. 57) so the lift belts can be reversibly rotatably driven.

The relationship of the cord ladder 98 to the lift belts 302 is probably best appreciated by reference to FIGS. 55 and 56 wherein it will be seen the vertical riser cords 308 are positioned behind the lift belts and the rungs 310 extend through the notches 332 in the edges thereof so the cord ladder is retained in a spread condition with each rung in a taut horizontal orientation and spaced from adjacent rungs.

With reference to FIG. 57, near the top of a lift tower 300, the cord ladders 98 engage ramp blocks 340 having inclined surfaces 342 for forcing the vertical risers cords 308 of a cord ladder in a downstream direction so it is clear of the lift belts 302 as it moves upwardly toward its connection with the lift cables 232. As possibly best seen in FIGS. 35 and 62, a belt spreader 344 made of a rigid but somewhat resilient material is mounted on the framework of each lift cord assembly 102 with the spreader, as best seen in FIG. 62, being of generally U-shaped configuration and having a pair of upwardly directed arms 346 with channels 348 formed in their outer surfaces through which a lift belt 302 and its associated lift fingers 304 can pass. The belt spreader serves, amongst other purposes, as a means for keeping the lift belts in desirably spaced relationship with each other so the cord ladder is also retained in a fully spread position for receipt of tubular vanes 124 as will be described hereafter.

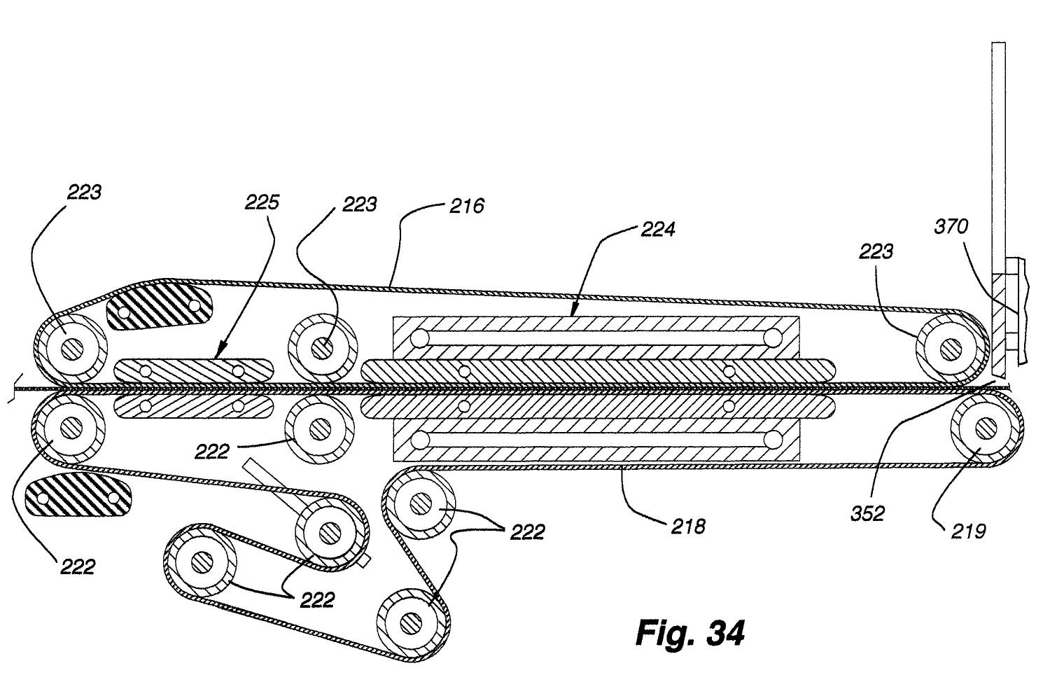

The vertical riser cords 308 in each cord ladder 98 are obviously spaced from each other in a lateral direction from the front of the machine to the rear of the machine so that openings 350 (FIGS. 53 and 54) defined between the vertical cords and adjacent rungs are alignable with a passage 352 (FIG. 34) in the framework of the apparatus in an upstream/downstream direction for receipt of previously formed tubular vanes 124.

As will be appreciated, a space is defined between the lift towers 300 and this space is aligned with incoming previously formed tubular vanes 124 at a location immediately above the belt spreader 344. This might be possibly best appreciated by reference to FIG. 43 and it will also be appreciated on the upstream side of a cord ladder assembly 102 immediately above the belt spreader, a vane detector 354 is mounted which is seen in detail in FIG. 61. The vane detector is of generally U-shaped configuration defining a U-shaped slot 356 therethrough through which a vane can be advanced into the associated cord ladder assembly 102. The vane detector has a photoelectric cell (not seen) that extends a beam through a passage 358 in the base of the slot so that the presence of a vane can be detected to tell the control computer that a vane has passed at this location.

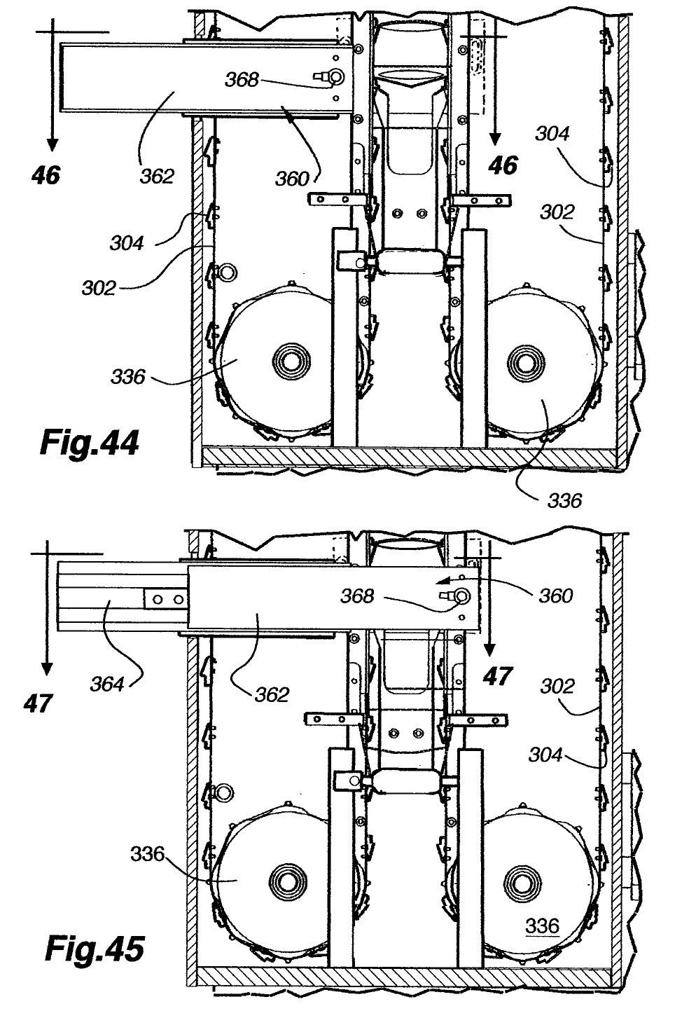

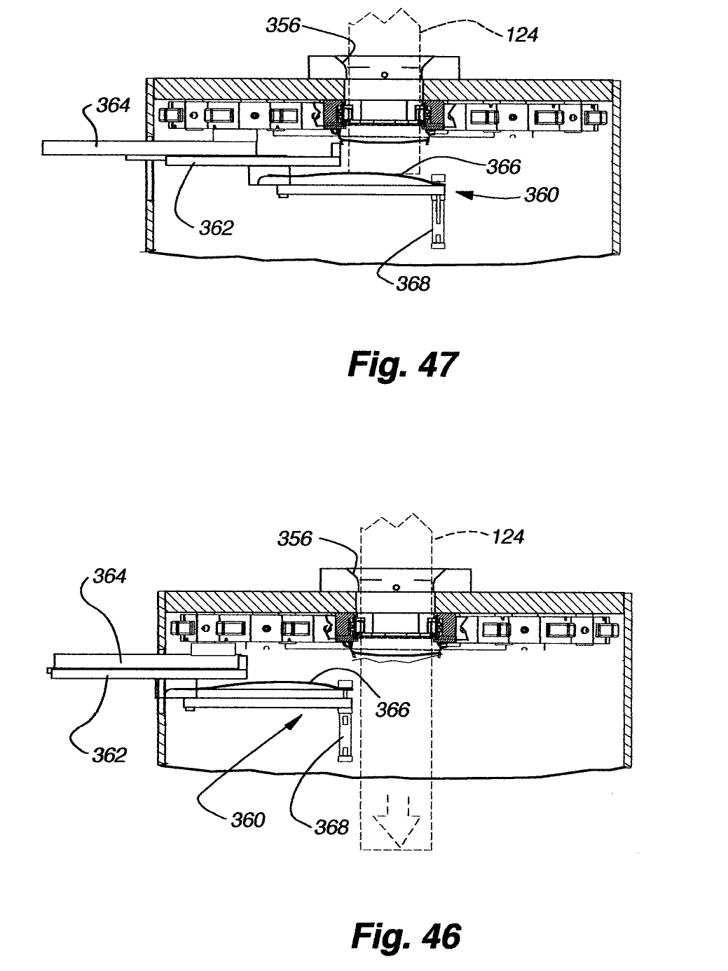

Vanes 124 being advanced by the second set of drive belts 216 and 218 can be fed through a cord ladder assembly 102 but can be stopped adjacent to the last cord ladder assembly being used in the formation of a panel. Of course, the last cord ladder assembly being utilized is determined by the length of the panel being fabricated and the template 242 associated therewith. Each cord ladder assembly has a stop bumper 360 possibly seen best in FIGS. 44-51 which is alignable with the slot 356 through the vane detector but on the downstream side of the cord ladder assembly. The bumper is mounted on a horizontally slidable plate 362 supported by a horizontal track 364 and movable with a pneumatic cylinder (not shown). With reference to FIG. 46, the bumper stop can be fully retracted out of the path of movement of a vane shown in dashed lines or extended into the path of movement of a vane to prevent any further movement in a downstream direction of a vane. Obviously, in the most downstream cord ladder assembly utilized in the assembly of a panel, the stop bumper is extended as shown in FIG. 47 to terminate any further downstream movement of the vane whereas in any cord ladder assembly upstream from this cord ladder assembly, the bumper stop is retracted so that the vane can pass uninhibited through that assembly.

The bumper stop 360 has a bowed spring steel plate 366 vertically oriented in a position to engage the lead end of a tubular vane 124 so that the vane engages the spring steel and is thrown back in an upstream direction after being resiliently absorbed by the spring steel and a pneumatic cylinder 368. The trailing end of the tubular vane is thereafter moved by the cylinder back into engagement with a spring steel gate 370 (FIG. 34) mounted on a wall of the framework in overlying relationship with the passage 352 through the framework through which the tubular vanes are advanced into the panel assembly system 86. The spring steel gate 370 is adapted to flex upwardly to allow a vane to pass in a downstream direction but as soon as it is passes the gate, the gate drops back down into a vertical position overlying the passage 352 so that when the vane is resiliently forced back upstream after hitting the spring steel on the bumper stop it will be blocked from any further upstream movement and positively positioned between the two sheets of spring steel. In this manner, the vane is properly positioned in an upstream/downstream location and with each cord ladder assembly 102 positioned along its length at a location where a cord ladder 98 is to be connected to the tubular vane 124.

The passage allowing the tubular slats to be passed into the panel-assembly system is positioned relative to a cord ladder so that as the slat enters the panel-assembly system, it is beneath corresponding rungs 310 of the various cord ladders being used in the panel 100.

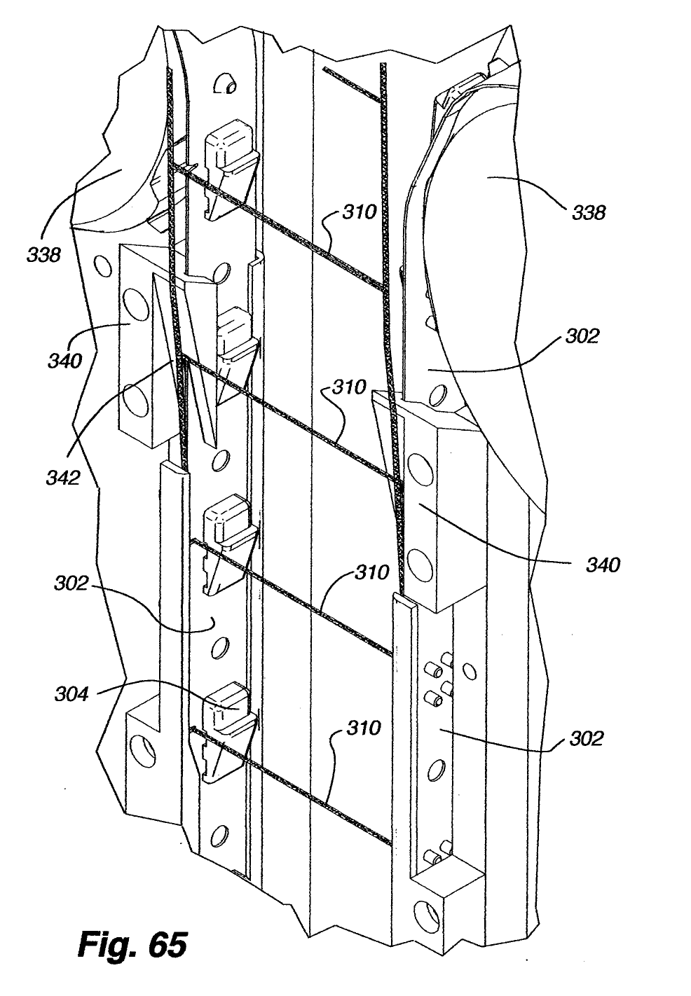

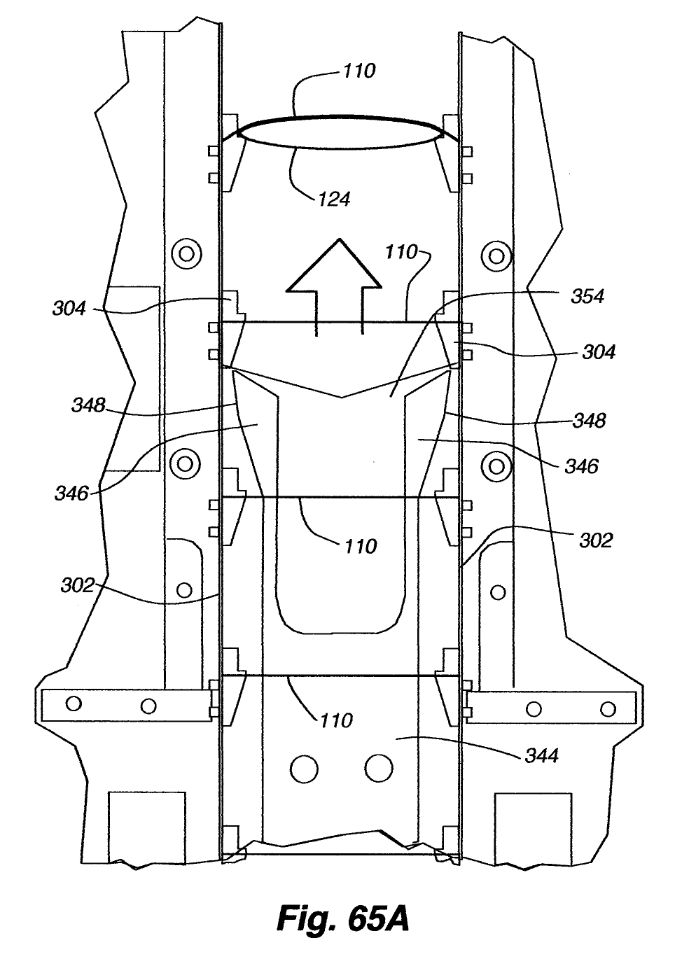

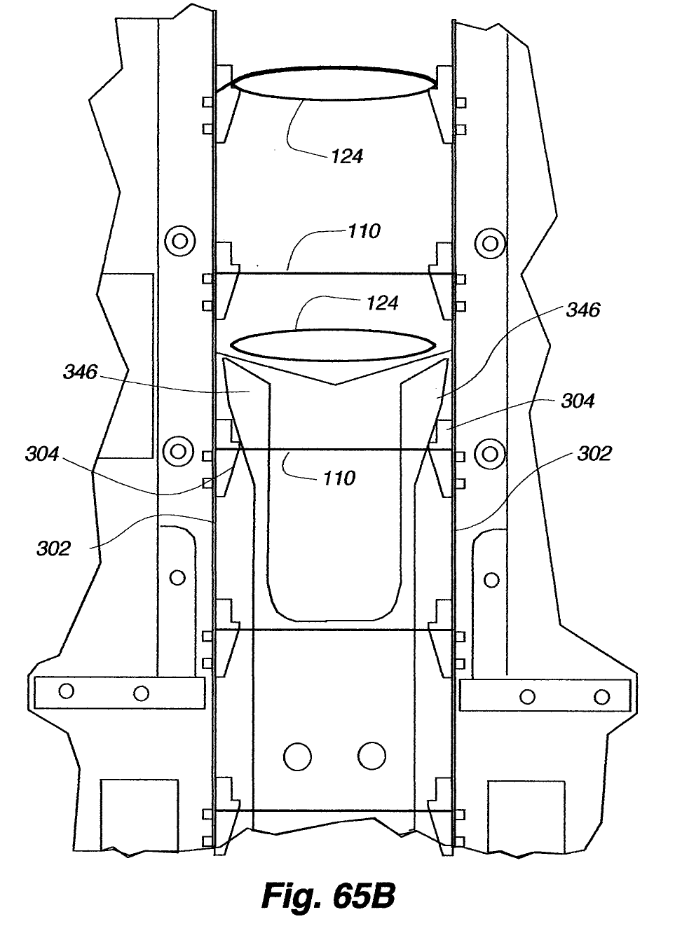

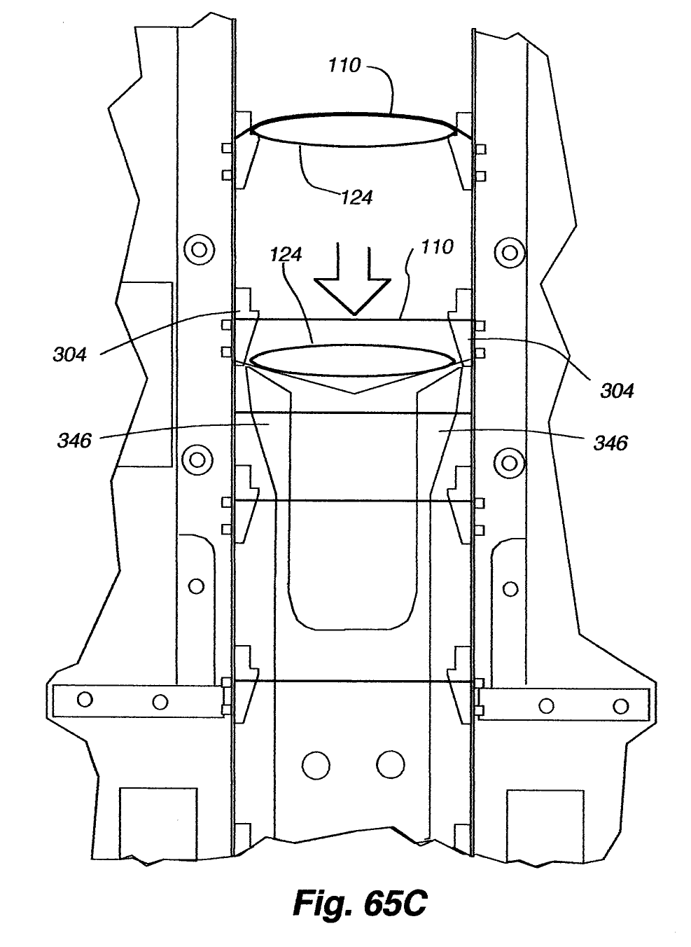

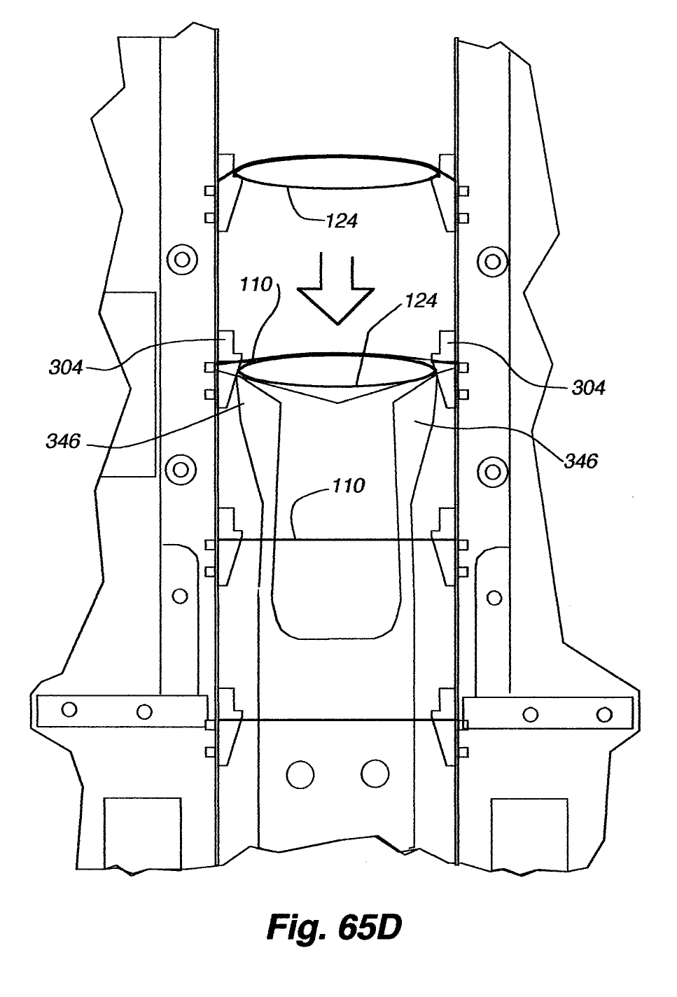

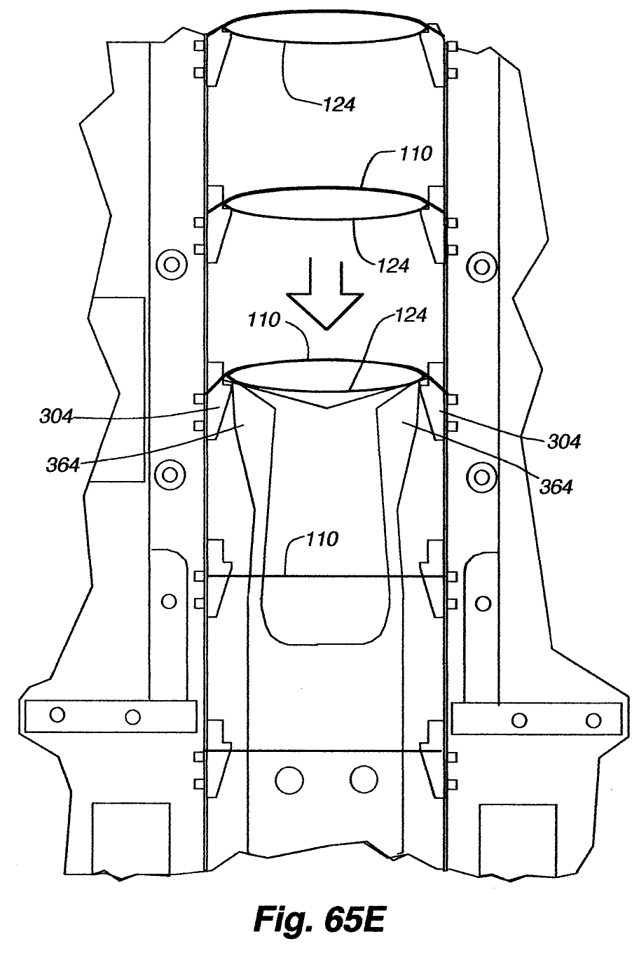

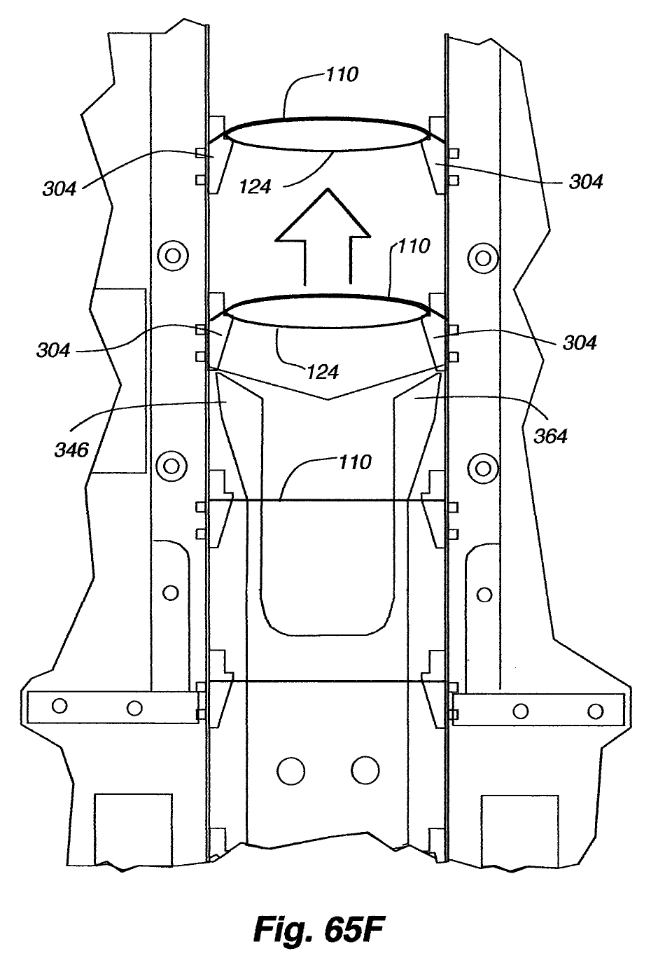

As can be appreciated by reference to FIGS. 65A-65F, which are diagrammatic fragmentary views looking in a downstream direction between the lift towers 300, the upper ends of the resilient legs 346 of the belt spreader are disposed immediately beneath a pair of aligned lift fingers 304 on the spaced lift belts 302. The lift fingers have beveled surfaces 371 beneath their shelves 305 with the beveled surfaces inclining upwardly and inwardly toward the opposite lift belt. The upper ends of the resilient arms 346 are seen in FIG. 65A to be positioned immediately beneath a pair of lift fingers and in a position so as to be engageable with the beveled surfaces of the lift fingers.

Looking at FIG. 65B, a vane has been shown inserted into the space between the lift belts 302 and in a space within the cord ladders so that a rung 310 of the cord ladder is spaced above and below the vane.

As will be clear with the description of the invention hereafter, it is important that the rung 310 above a vane 124 ultimately be positioned in contiguous relationship with the top surface of the vane. In order to desirably position the vane adjacent to its overlying rung, the motor driving the lift belts 302 is reversed so that the lift fingers 304 move downwardly toward the arms 346 of the belt spreader. As seen in FIG. 65C, as the lift fingers move downwardly with the associated lift belts, the rung above the vane is moved downwardly toward the top surface of the vane and the lift fingers are positioned to engage the upper ends of the arms 346 of the belt spreader. As viewed in FIG. 65D, further downward movement of the lift belts causes the beveled surface 371 of the associated lift fingers to engage and compress the arms 346 of the belt spreader causing them to pivot inwardly even though they continue to support the vane as the overlying rung is moved downwardly into closely spaced relationship with the top edges of the vane. As seen in FIG. 65E, when the lift belts have been lowered enough so that the top edges of the arms 346 are substantially coincident with the shelves 305 of the associated lift fingers, the vane supported by the belt spreader is forced into engagement with the overlying rung. It should also be appreciated the vane is positioned above the shelves of the associated lift fingers and will thereafter be supported by the shelves. The drive motor for the lift belts can then be reversed so as to move the belts in an upward direction so that the vane is lifted while engaged with its associated overlying rung and the belt spreader is allowed to resiliently rebound to its rest position with the arms 346 fully spread. The arms will remain fully spread until the next lower pair of lift fingers engage outer beveled surfaces 373 of the arms compressing them inwardly so as to allow the lift fingers to pass over the top of the belt spreader until the apparatus again reaches the position of FIG. 65A where it is desirably positioned for receiving the next lower vane. By following the above sequence, vanes 124 are inserted into the cord ladder and desirably positioned in underlying contiguous relationship with a rung of the cord ladder for later processing.

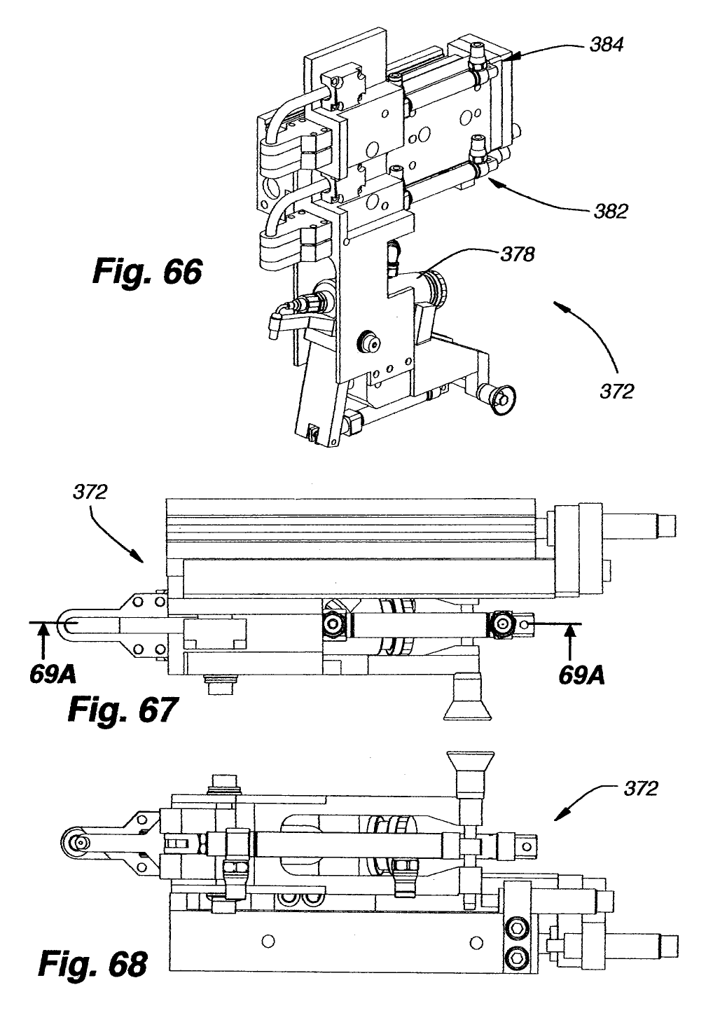

The rungs are secured to the top surface of a vane 124 in any suitable manner such as with adhesive, ultrasonic bonding, or the like, but in the disclosed embodiment, the connection is with adhesive. Two dots 371 of adhesive are utilized to secure each rung to the top surface of a vane with each dot being positioned closely adjacent to one edge of the tubular vane. A pair of adhesive application devices 372 as shown in FIG. 66 are secured to each cord ladder assembly 102 on each lift tower 300 adjacent to a vane positioned in the assembly. The devices 372 are mounted at an angle as seen in FIG. 35 so as not to interfere with other operative components of the cord ladder assembly.

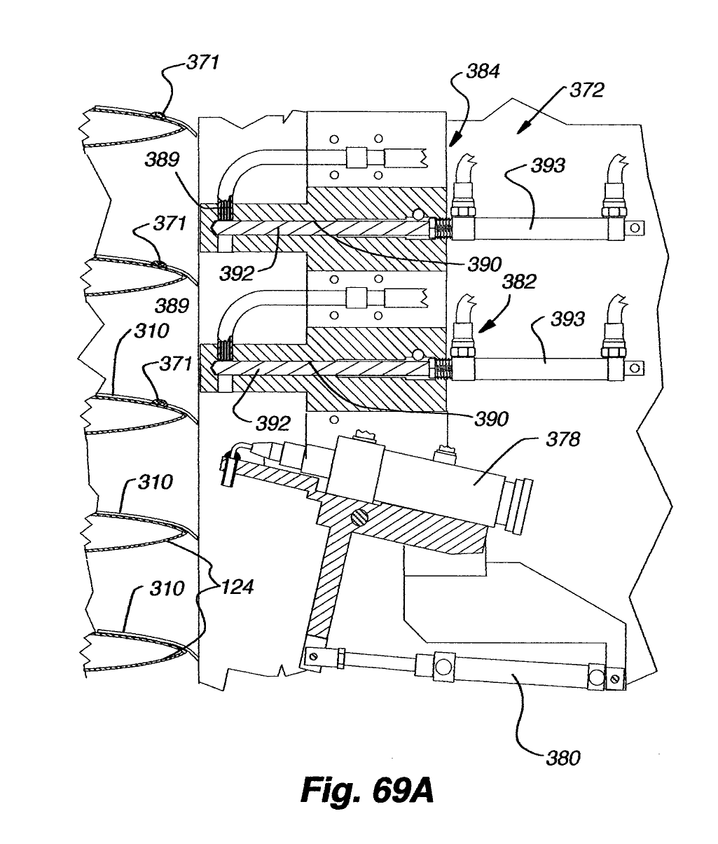

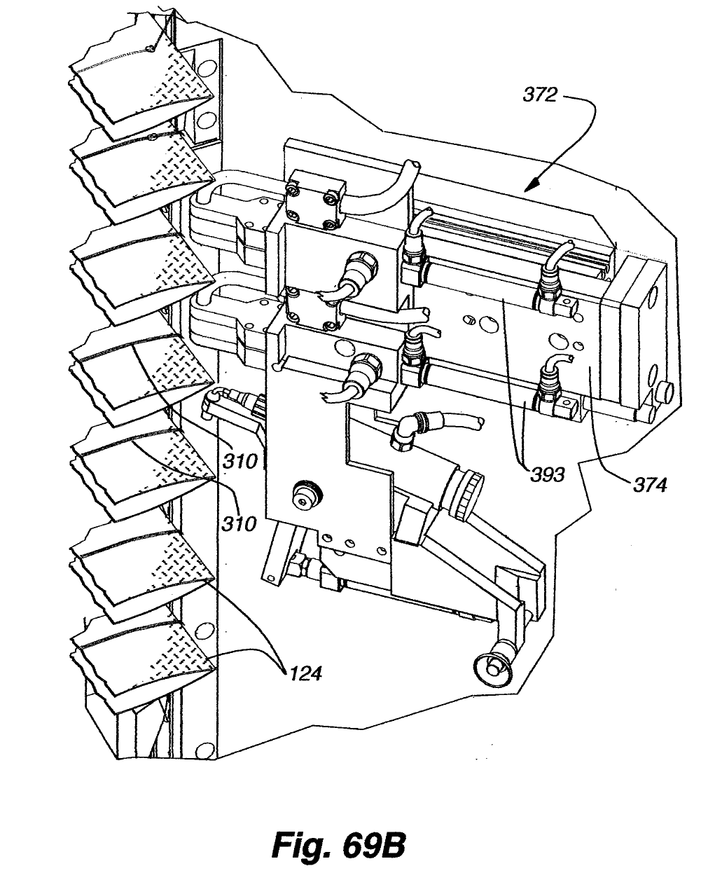

Each adhesive application device 372 is reciprocally mounted on a plate 374 (FIGS. 35 and 69B) and movable reciprocally in a horizontal plane by pneumatic cylinders so that the device can be moved into alignment with the vanes for application of adhesive and retracted to allow the vanes to move upwardly within the lift towers 300.

The adhesive application device 372 as seen in FIGS. 66 and 69A has a tubular adhesive applicator 378 at a low location thereon supported on framework for the device with the applicator being pivotally mounted and pivoted by a pneumatic cylinder 380 between the inclined position shown in FIG. 66 and a horizontal position to be described hereafter. Immediately above the adhesive applicator are a pair of superimposed gas and ultraviolet (UV) dryers 382 and 384 with each dryer being positioned so as to be associated with an adjacent vane in the panel formed with the apparatus of the invention.

As will be described in more detail hereafter, the adhesive applicator 378 during operation is adapted to be operative on the lowermost one of the lowest three vanes in an assembly 102 while the lower dryer 382 is operative on the next adjacent upper vane and the uppermost dryer 384 is operative on the uppermost one of the three lowest vanes.

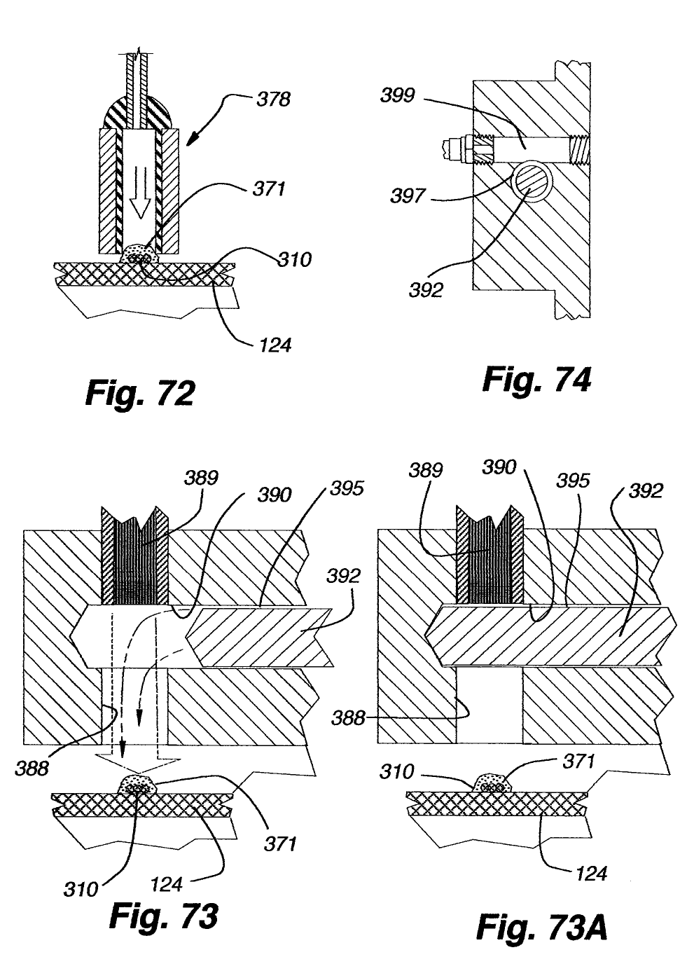

The operation of the adhesive application device 372 is possibly best illustrated by reference to FIGS. 69A, 70A, and 71A with their corresponding isometric views FIGS. 69B, 70B, and 71B, respectively. Before describing the operation, however, it is felt beneficial to refer to FIGS. 72-74 which illustrate the operation of each component of the adhesive application device on an associated vane. FIG. 72 shows a dot of adhesive 371 being applied through the adhesive applicator to the top surface of the vane 124 at a predetermined location so as to encompass the rung 310 of the cord ladder 98 and adhere it to the underlying tubular vane.

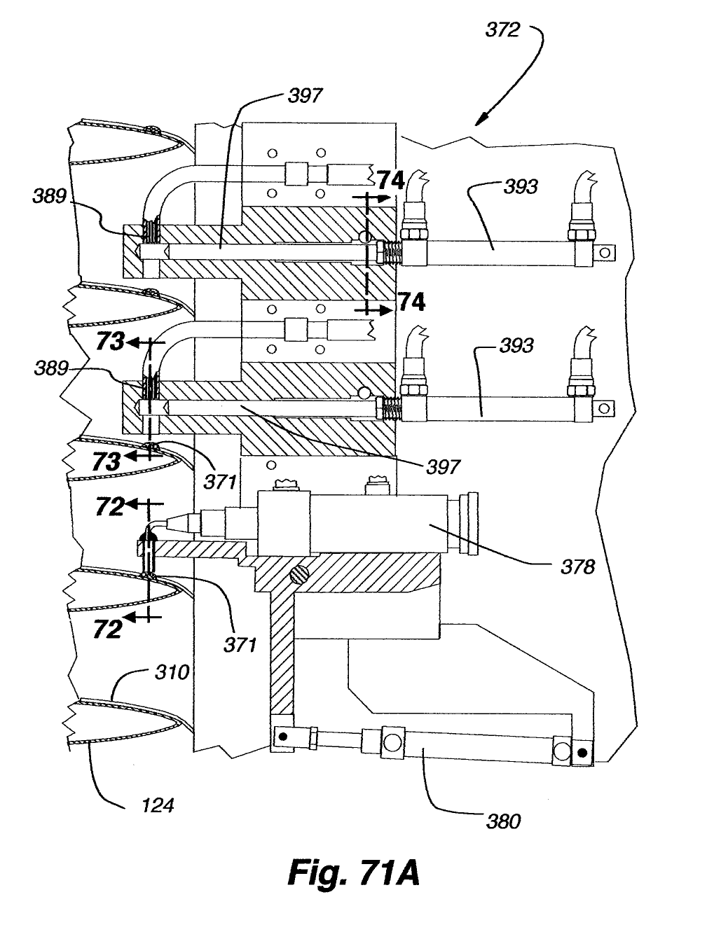

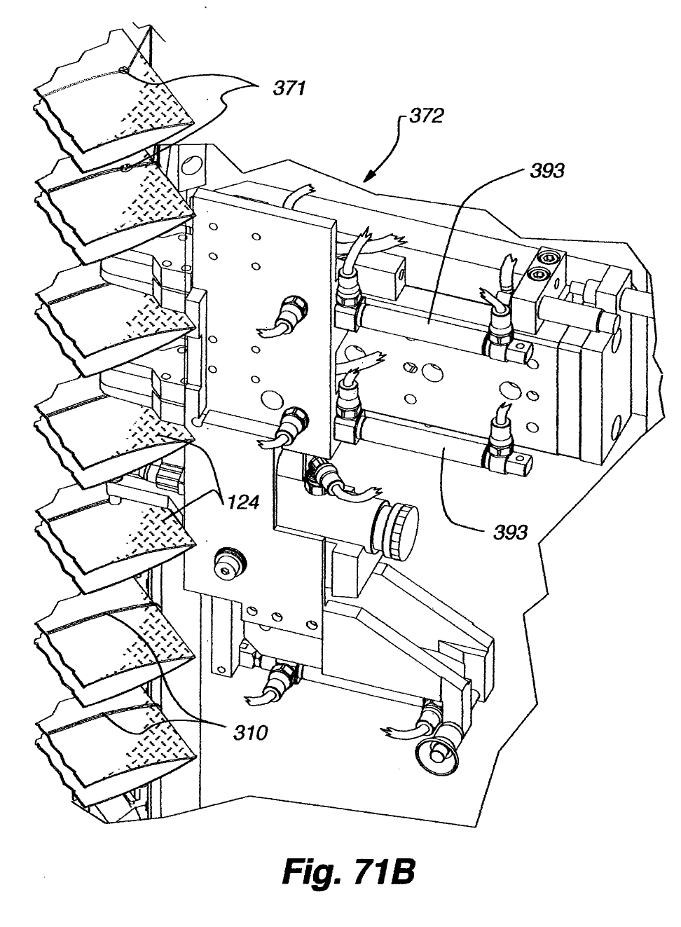

FIGS. 73, 73A and 74 show the operation of a gas and UV dryer 382 or 384 wherein it will be appreciated that within the dryer, a vertical passage 388 is positionable above and in alignment with the dot of adhesive 371 applied to a vane 124 with the applicator as mentioned above. A UV fiberoptic light guide or radiator 389 is positioned in an upper portion of the passage 388 directed at the dot of adhesive. The dryer also has a horizontal channel 390 communicating with the vertical passage immediately beneath the radiator 389 and a reciprocal plunger 392 in the horizontal channel. The plunger is reciprocated with a pneumatic cylinder 393 (FIGS. 71A and 71B). When the plunger is extended as shown in FIG. 73A, it blocks the UV radiation through the passage but when the plunger is retracted, as shown in FIG. 73, it allows the UV radiation on the dot of adhesive. The plunger 392 has a slightly smaller diameter than the channel 390 so as to provide a circumferential space 395 therearound. A rear portion 397 of the channel is of even slightly greater diameter and communicates with a transverse gas delivery conduit 399 (FIGS. 71A and 74) so that a drying gas can be delivered from the delivery conduit into the rear portion 397 of the channel. From the rear portion, the gas travels forwardly through the circumferential space 395 to the vertical passage 388 and from there to the dot of adhesive. A preferred gas utilized is nitrogen which under pressure forces the removal of oxygen from the vicinity of the dot of adhesive and encourages the dot of adhesive to dry in a very clear form so that it is not very visible on the surface of the tubular vane.

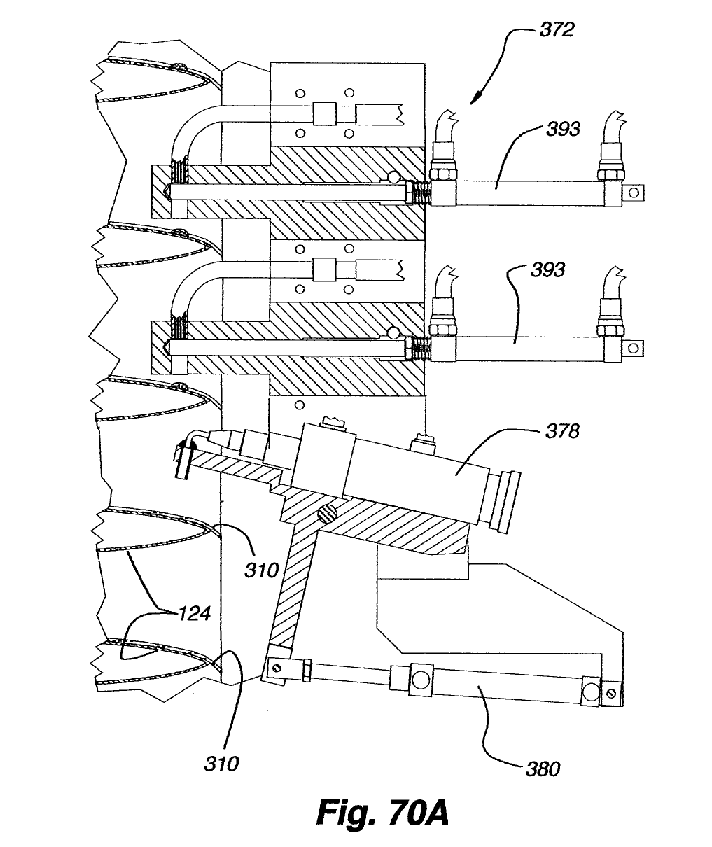

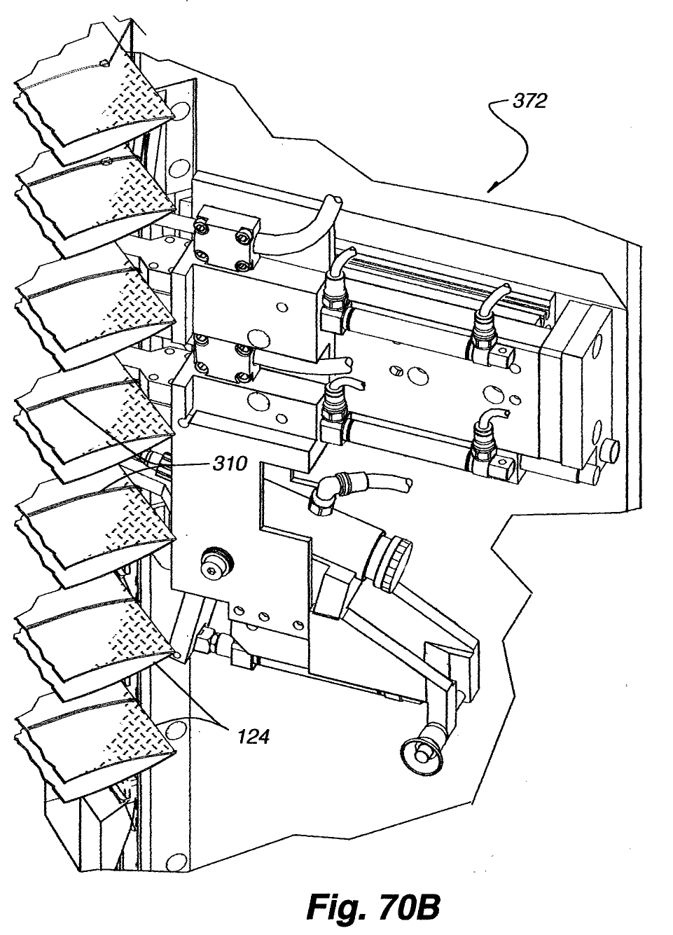

Again referencing FIGS. 69A, 70A and 71A, in FIG. 69A, the adhesive application device 372 is shown retracted so that the tubular vanes 124 can be lifted within the lift tower 300 in a step-by-step manner. In FIG. 69A, the lowermost vane illustrated is the vane most recently inserted into the panel-assembly system 86 and the next adjacent upper vane was the previously inserted vane. Once the lift tower has been indexed or stepped to lift the vanes to the position illustrated in FIG. 69A, the adhesive application device is advanced forwardly into the position of FIG. 70A so that the tip of the adhesive applicator 378 having the nozzle thereon overlies the associated edge of the desired vane and in alignment with a rung 310 of the cord ladder. Immediately after the extension of the adhesive application device, the applicator 378 is pivoted with the pneumatic cylinder into the horizontal orientation of FIG. 71A wherein the nozzle of the applicator is immediately adjacent to the surface of the vane adjacent the edge thereof and with the rung of the cord ladder therebeneath so that a dot of adhesive 386 can be applied to the top surface of the vane encapsulating the rung. Immediately after the dot of adhesive has been applied, the applicator is pivoted back to the position of FIG. 70A and the application device is retracted to the position of FIG. 69A so that the cord ladders can be indexed or stepped upwardly one more notch. As will be appreciated by reference to FIG. 70A, when the application device is extended, the dryers 382 and 384 are positioned in an overlying relationship with the location where a spot of adhesive was previously applied and is utilized to dry the adhesive. It is found that by drying the adhesive twice during two-stepped intervals of the lifting of the panel 100 in the panel-assembly system, the adhesive can be totally dried while maintaining a desired speed of fabrication. In other words, the lower dryer 382 is the first to dry a dot of adhesive and after the next indexing of the system, the upper dryer 384 completes the drying of the same spot of adhesive so the stepped process can be continued without a long delay at one step for complete drying. As mentioned previously, there are two adhesive application devices 372 in each cord ladder assembly 102 so that two dots of adhesive secure each rung to the top surface of the vane as the panel is being fabricated.

After the predetermined number of vanes have been incorporated into the predetermined number of cord ladders as illustrated in FIG. 3A, the machine is automatically stopped indicating that a panel 100 of a predetermined height and predetermined width has been completed. The cord ladders 98 are then removed from the cable 232 and the entire assembled panel removed from the apparatus and inverted before being connected to a headrail and bottom rail as mentioned previously. If the panel is slightly wider than desired due to the use of templates of predetermined lengths, the ends of the slats can be trimmed to any desirable length in a conventional manner.

According to the above description, it will be appreciated a panel 100 of interconnected tubular slats or vane 124 and cord ladders 98 can be assembled in a totally automated in-line system with the apparatus of the present invention and with the panel then being appropriate, after inversion, for incorporation into a Venetian blind by connecting the top of the cord ladders to a control system in a headrail and the bottom to a bottom rail. As previously noted, the various motors utilized in operating the apparatus as described are driven with a pneumatic computer-controlled system, the design and operation of which is believed to be within the skill of those in the art and accordingly a detailed description of the operating system is not deemed necessary.

Although the present invention has been described with a certain degree of particularity, it is understood the present disclosure has been made by way of example, and changes in detail or structure may be made without departing from the spirit of the invention as defined in the appended claims.

1. An apparatus for forming a tubular vane from a strip of somewhat flexible material having a line of adhesive along one edge and one face thereof comprising in combination:
a support for said strip of material,
a box adjacent to said support in which a loop of said material can be formed, said box including a vacuum source for creating a low pressure zone in said box to draw said material from said support into said box,
at least one folding block adjacent to said box through which said material can be advanced, and
a compressor for compressing the line of adhesive against another surface of said material to form the material into a tubular vane.

2. The apparatus of claim 1 further including driving means for pulling said material from said box and through said at least one folding block and said compressor.

3. The apparatus of claim 2 further including a cutter for cutting said material into predetermined lengths.

4. The apparatus of claim 1 further including at least one vent in said box for affecting the degree of low pressure within said box.

5. The apparatus of claim 4 wherein there is a vent that is selectively closable.

6. The apparatus of claim 1 wherein said adhesive on said material is inert and further including a heater for activating said adhesive before it is compressed in said compressor.

7. An apparatus for forming a tubular vane from a generally flat strip of somewhat flexible material having a line of adhesive along one edge and one face thereof comprising in combination:
a support for a supply of said material, said support holding said material in a vertical orientation,
at least one folding block for receiving said material in said vertical orientation and folding said material so that it overlaps itself, and
a compressor for compressing the line of adhesive against another surface of said material to form the material into a tubular vane.

8. The apparatus of claim 7 wherein said support includes a support tray and a vertical spindle and further wherein said flexible material is in a cylindrical roll having said spindle along its longitudinal axis.

9. The apparatus of claim 7 further including driving means for pulling said material through said at least one folding block and said compressor.

10. An apparatus for cutting a continuous strip of material into a plurality of relatively short strips of predetermined length, comprising in combination,
a support for a supply of said continuous strip of material having a leading edge,
drive means for selectively advancing said strip of material in a downstream direction,
a cutter for cutting said strip of material into said short strips,
a movable sensor for sensing said leading edge of said continuous strip of material and terminating said drive means to stop movement of said strip of material, said sensor being downstream from said cutter,
a template simulating the length of said short strips, and
a sizing system for sensing the length of said template and moving said sensor relative to said cutter so that said sensor is spaced from said cutter a distance commensurate with the length of said template.

11. The apparatus of claim 10 wherein said sizing system includes a support for said template wherein one end of said template is fixed, and a movable positioning member for engagement with an opposite end of said template and wherein movement of said positioning member is translated into corresponding movement of said sensor.

12. The apparatus of claim 11 wherein said movement is translated with a cable system.

13. The apparatus of claim 1 or 7 further including a heater for heating said adhesive before said compressor compresses the line of adhesive against another surface of said material.

14. An apparatus for forming a panel of material for use in a Venetian blind having a plurality of cord ladders suspending a plurality of elongated vanes, comprising in combination:
a plurality of ladder assemblies linearly movable relative to each other between releasably fixed positions, each assembly including a supply of cord ladder material and a system for moving said ladder material upwardly in steps, and
a system for individually advancing said elongated vanes into an operative relationship with said ladders as said ladders are moved upwardly in steps.

15. The apparatus of claim 14 wherein said ladders include rungs and further including a device for securing said vanes to rungs of said ladders as said ladders are moved upwardly in steps.

16. The apparatus of claim 15 wherein said device includes an adhesive applicator for applying a dot of adhesive to said vanes along a rung.

17. The apparatus of claim 16 wherein said device further includes a dryer for drying said dot of adhesive.

18. The apparatus of claim 17 wherein said dryer is operable on a dot on a vane separate from a vane simultaneously receiving a dot of adhesive.

19. The apparatus of claim 18 wherein said device further includes a second dryer and said second dryer is simultaneously operable on a dot of adhesive on a vane separate from a vane receiving a dot of adhesive and a vane having a dot of adhesive being dried by said first mentioned dryer.

20. The apparatus of claim 16, 17, 18 or 19 wherein said device is reciprocally mounted to move into and out of a path of movement of said ladders as said ladders are moved upwardly in steps.

21. The apparatus of claim 16, 17, 18 or 19 wherein there are two of said devices associated with each ladder.

22. The apparatus of claim 14 wherein said system for moving said ladder material upwardly also moves said ladder material downwardly between upward movements.

23. An apparatus for forming a panel of material for use in a Venetian blind having a plurality of cord ladders for suspending a plurality of elongated vanes, said ladders being elongated with spaced rungs along their length and passages through the ladders between adjacent rungs, comprising in combination:
a plurality of spaced ladder assemblies, each assembly including a supply of cord ladder material and a system for moving said ladder material vertically in steps, said ladder in each assembly having said passages horizontally aligned, and
a system for individually advancing said elongated vanes in a downstream direction through a fixed wall in said apparatus and subsequently through a set of horizontally aligned passages in said ladders, one of said assemblies including a reciprocally mounted bumper including a sheet of spring steel with the bumper being movable into and out of the path of movement of said vanes so as to engage a vane as it is moving downstream to interrupt the downstream movement and move said vane in an opposite upstream direction until it engages said fixed wall so the upstream end of each vane is aligned with said fixed wall.

24. The apparatus of claim 23 wherein said bumper includes a reciprocal cylinder for advancing a vane in an upstream direction.

25. An apparatus for forming a panel of material for use in a Venetian blind having a plurality of cord ladders suspending a plurality of elongated vanes, comprising in combination:
a plurality of ladder assemblies mounted for linear movement between releasably fixed positions, each assembly including a supply of a cord ladder material and a system for moving said ladder material vertically between stepped positions, a system for individually advancing said vanes into operative relationship with said ladders as said ladders are stepped vertically, a removable template positioned on said apparatus having information thereon indicative of a desired position for at least one of said assemblies, and
a system for moving said at least one assembly to said desired position.

26. The apparatus of claim 25 wherein there are a plurality of removable templates one of which is incorporated into said apparatus at a time and each of said templates having information thereon different from the other templates.

27. The apparatus of claim 25 wherein said template is elongated, said information is disposed along the length of said template and wherein each of said assemblies is linearly movable along said template and includes a system for being releasably locked in position adjacent said information.

28. The apparatus of claim 25 wherein said information is in the form of mechanical stops.

29. The apparatus of claim 28 wherein said mechanical stops are notches formed along the length of said template.

30. The apparatus of claim 29 wherein said system for being releasably locked includes retractable catch fingers for releasable engagement in said notches so that each of said at least one assembly can be releasably but positively positioned at a predetermined location along the length of said template.
